(19) United States
(12) Patent Application Publication
(10) Pub. No.: US 2013/0345882 A1
(43) Pub. Date: Dec. 26, 2013

(54) PROGRAMMABLE ENVIRONMENTAL COMFORT CONTROLLER

(71) Applicants: Steven David Dushane, Granada Hills, CA (US); Mustafa Oransel, West Hills, CA (US); Alvin Rendell Lumowa, Woodland Hills, CA (US); Adrian Sanchez del Campo, Encino, CA (US)

(72) Inventors: Steven David Dushane, Granada Hills, CA (US); Mustafa Oransel, West Hills, CA (US); Alvin Rendell Lumowa, Woodland Hills, CA (US); Adrian Sanchez del Campo, Encino, CA (US)

(21) Appl. No.: 13/709,045

(22) Filed: Dec. 9, 2012

Related U.S. Application Data
(60) Provisional application No. 61/579,612, filed on Dec. 22, 2011.

(51) Int. Cl. G05B 19/02

(52) U.S. Cl. CPC G05B 19/02
USPC 700/276

(57) ABSTRACT

The programmable environmental comfort controller of the invention takes the form of a multi-functional, simple-to-use, programmable touch screen thermostat. This programmable touch screen thermostat simulates the image of a digital picture frame and may have customizable backgrounds, including the users' selected photos, and various preset themes. The controller, which is powered by a power source, will have a face plate, a touch screen, an interface, a home screen, a menu, one or more subscreens, and two or more set points. The controller may also have settings and preferences which a user may program to fit their desired settings as well as a programmable schedule. The controller will also have buttons which may be virtual buttons on a touch screen as well as virtual bars. The controller will blend aesthetically pleasing images, preferences, and settings with functionality and simplicity in use of a complex controller for HVAC systems.

### CROSS REFERENCE TO RELATED APPLICATIONS

This application claims the benefit of Provisional Patent Application No. 61/579,612, entitled Color Touch Thermostat Embodiments filed Dec. 22, 2011, the disclosure of which is hereby incorporated herein by reference.

### TECHNICAL FIELD

The invention relates to apparatus and methods for the control of mechanical systems such as heating, ventilation and air-conditioning in the home or at a commercial facility, for example in the context of a touchscreen thermostat.

### STATEMENT REGARDING FEDERALLY SPONSORED RESEARCH OR DEVELOPMENT

(Not applicable)

### BACKGROUND OF THE INVENTION

Programmable electronic environmental comfort controllers are well known in the art. Such devices typically comprise a microprocessor operating under a control program. The microprocessor is connected by an input/output interface to a user interface, environmental condition sensors, and environmental control equipment, such as heating, ventilation and air-conditioning systems. Environmental control equipment is operated at the direction of the programmable environmental comfort controller, which compares a pre-determined setpoint to a sensed environmental condition and determines if the difference is sufficient to operate one or more units of the environmental control equipment. A typical residential programmable environmental comfort controller will sense a room temperature, compare it to a locally displayed setpoint for heating or cooling, and respectively turn on, off or make no change to the state of heating, ventilation or cooling equipment.

Prior art user interfaces typically have a display that indicates various aspects of the operational modes and setpoints of the programmable environmental comfort controller, as well as information from environmental sensors and operational states of environmental control equipment. A user views and evaluates the displayed information and arrives at a decision concerning changes to modes and setpoints for the programmable environmental comfort controller. Because a user will not typically need to change every aspect of the environmental control system that is accessible for viewing on a user interface display, such displays typically contain information that is unnecessary to a user at a specific time when the user wishes to make a change. Alternately, a display with fewer features requires a user to recall stored information previously shown on another screen of the user interface to effect a desired change to the environmental control system.

Multiple pressure sensitive or touch sensitive buttons may be provided in prior art user interfaces to allow a user to make changes in the operational modes or setpoints that control operation of HVAC equipment or other environmental control equipment. The changes input by the user at the user interface are implemented by a control program resident in the programmable environmental comfort controller and the changes in the environmental control system are subsequently shown in text or iconic forms on a display visible to a user.

With the availability of low cost microprocessors, computer memory and displays, sophisticated programmable environmental comfort controllers are currently available for operation of environmental control equipment in residences and commercial buildings. The trend in commercially available user interfaces has been toward increasing complexity and the time required make changes to operational modes or setpoints. In fact, a user presented with the advanced control features and information displays of a moderately sophisticated programmable environmental comfort controller will often spend substantial time trying to remember the meaning of displayed information in text and icons just to make relatively simple desired changes to the operation of the environmental control system.

The situation has been made more complex due to ongoing efforts to improve efficiency and environmental comfort, and the resulting proliferation of equipment for environmental control systems. Such equipment can include multiple fans, heating stages, cooling stages, duct air flow controllers, and remote sensors providing information for their control. In response, the user interface has become a barrier of sorts to acceptance of advanced features of a programmable environmental comfort controller, regardless of their benefits.

### SUMMARY OF THE INVENTION

The programmable environmental comfort controller constructed in accordance with the present invention is a multi-functional, simple-to-use, programmable touch screen programmable environmental comfort controller that simulates the image of a digital picture frame.

In accordance with the invention, an HVAC controller system, comprises a controller providing control signals to one or more HVAC components, the controller operating in accordance with an algorithm. A memory stores one or more set points, each of the set points being associated with a time and a temperature. A touch screen dot matrix interface device displays information received from the controller and presents virtual buttons. The virtual buttons are responsive to touch inputs to generate programming inputs. The programming inputs are coupled to the controller. The controller is configured to cause the dot matrix interface device to display a first screen with a first plurality of virtual buttons and a first plurality of information items, and, in response to a touch input from one of the virtual buttons to present a second screen with a second plurality of virtual buttons and a second plurality of information items, and/or to adjust one or more of the set points; and an interface circuit board controlling the operation of the HVAC components in accordance with the set points.

Longevity of the screen may be improved by i) dimming the display brightness after a period of time after the controller system has been programmed, adjusted or otherwise been actuated, adjusted or otherwise interacted with by the user, and/or ii) shutting off the display after a period of time, such as sixty seconds after the controller system has been programmed, adjusted or otherwise been actuated or adjusted by the user.

Information about current conditions and operations may be displayed at the left of the display and information and virtual buttons for changing setpoints and other controller features be positioned at the right of the display.

The right side of the display may be divided, with setpoint(s) displayed at a leftmost area of the right side and virtual button(s) for changing setpoints(s) in a rightmost area of the right side.

The system make are comprised a card slot, the card slot being coupled to the controller to receive program update information from a card located in the card slot.

The controller may be connected to a router and programmed to display text messages, pictures or text in response to an input from a smartphone communicated over a network such as the Internet.

Optionally, a screensaver mode maybe entered into in accordance with an algorithm responsive to the cessation of user input.

The controller may be configured as a thermostat, the thermostat being of relatively thin configuration.

The thermostat may have a thickness less than 20% of the sum of its length and width.

A user may program the controller system to have available thermostat informational and control display elements removed.

In accordance with the invention, the algorithm may enable the controller to operate under parameters only within limits set by the owner, thus preventing the air conditioning system from running at too low a temperature and the heating system from running at too high a temperature.

Optionally, the algorithm may incorporate picture editing software.

In accordance with a preferred embodiment of the invention, the touch screen dot matrix interface device is separate from a thermostat housing housing controller. The touch screen dot matrix interface device may be a smart phone coupled to the controller via a network.

Setpoints maybe stored in a memory hardwired to the controller, whereby setpoints are locally available and not dependent upon network functionality for operation of the HVAC controller system.

In the case where the touchscreen display is a separate device, such as a smart phone, a second interface device located on the housing may be provided to allow programming of setpoints and displays of information. In order to keep costs low, such second interface is of relatively low-cost, for example one which is not a dot matrix display. Nonetheless, a high degree of functionality may be provided by making the second interface a segmented display with touch actuatable elements for programming the thermostat.

The inventive programmable environmental comfort controller has customizable backgrounds, which may be made to display the users' own photos, and a plurality, for example more than a dozen preset themes, including such things as seasonal, hobby, sport, resort and holiday themes. Users can customize the appearance of their programmable environmental comfort controllers by using their own photos for screen savers and background wallpaper.

Importing photos into the programmable environmental comfort controller is simple using software and an SD memory card. Such software may be designed to be run on Mac, PC desktop or laptop computers, and on portable devices such as Android, Blackberry, Apple, and other portable platforms. Such software may be stored in memory in the programmable environmental comfort controller. Alternatively, it can be made to be downloaded from the website of the thermostat manufacturer or other provider. The thermostat may incorporate software which users can use to customize their photos, or such software may be provided by way of download to provide the thermostat with built-in editing features, including zoom, rotate, color, and brightness, or reset to put the photo back to its original format.

Using the “preview” feature, users can see how the photo will look as background wallpaper once the programmable environmental comfort controller info is placed over the photo. Preview allows them to make sure their photo selections are acceptable before uploading them to the programmable environmental comfort controller.

Users may install, for example, as many as 100 or more photographs for use in the programmable environmental comfort controller. One may be selected for display as a screensaver or as wallpaper for the control screens, or a plurality can be selected, for example, to rotate as a slideshow when the programmable environmental comfort controller is in screen saver mode.

In accordance with the invention, it is contemplated that screensaver mode would be entered into in accordance with an algorithm programmed into the controller. For example, if the controller touchscreen has not been touched for eight period of time, for example one minute, it may revert to the home screen showing environmental conditions and/or settings and/or other information. If the touchscreen is not touched for an additional, for example, five minutes, the touchscreen may go into screensaver mode where it becomes an unobtrusive part of the decor.

More particularly, in accordance with the present invention, it is contemplated that the thermostat may be of very thin configuration, for example, having, for example, a length and width twenty-five cm and a thickness of a half centimeter, and may be mounted on a wall as a conventional framed paper photograph. Alternatively, the inventive thermostat may have a thickness less than 20% of the sum of its length and width, preferably less than 10% of the sum of its length and width and most preferably less than 5% of the sum of its length and width. It is further contemplated that decorative appearance of the thermostat may be enhanced by adding a conventional frame, such a wood and goldleaf frame, a plastic frame, sterling silver frame and so forth.

If desired, any of user selected, downloaded or other photos may be selected as the background wallpaper for the programmable environmental comfort controller or as a screensaver.

The programmable environmental comfort controller may also come with, for example, a dozen built-in nature and holiday themed photos that can be used as background wallpaper for the programmable environmental comfort controller. Holiday themes may include Christmas, Hanukkah, Thanksgiving, Halloween and Cinco de Mayo. Each theme has separate photos displaying daytime and nighttime shots, along with time of day indicator icons, for example showing the sun for day and the moon for night.

In accordance with a preferred embodiment of the invention, the inventive software may include five menu items make programming fast and easy for users. Users can easily find and upload their own photos to a picture gallery if they choose. Editing tools allow for photo placement, color and brightness adjustments. These five menu tools are: picture gallery, dealer information, schedule, thermostat settings, and firmware.

The inventive thermostat may also be programmed to store service information and output the same, when needed. Such service information may be provided by and programmed into the inventive thermostat by the contractor installing the thermostat, and thus allows the contractor to select the service contact information which the contractor wishes to provide. This can also be done directly on the programmable environmental comfort controller.

An additional feature of the president mentioned is that, using a schedule feature in software loaded onto a personal computer, users can see an “overview” of the time period schedule for heating and cooling and can edit the schedule from any Mac or PC desktop or laptop computer by plugging an SD card into a suitable slot on a computer and then placing it into the thermostat. Changes can also be made on any computer running the control software known as ColorTouch™ Assistant or compatible software. The user can also view and change the schedule directly from the programmable environmental comfort controller.

Programmable environmental comfort controller settings allow users to adjust preferences, alerts, daylight savings, vacation, security, and overall system settings. The user can also make setting changes directly on the programmable environmental comfort controller.

Automatic updates to the software in the thermostat and firmware (the operating system and feature set) or the compatible software and firmware may be made available to users for download from the manufacturer's server. When the user opens the software application for programming the thermostat using the SD card or a compatible application, it automatically connects to the manufacturer's website in the background and updates the software in the thermostat by downloading to the SD card which is then inserted in the thermostat, enabling users to update programmable environmental comfort controller firmware to the latest revisions. As alluded to above, the software updates the firmware to the SD memory card to be uploaded to the programmable environmental comfort controller, which then updates the programmable environmental comfort controller. Updating the firmware ensures that the user always has the most current system software, including new features and performance enhancements.

A user may use an SD memory card in a variety of circumstances to upload updates and perform other tasks. Users can also, for example, import, for example, schedules, wallpapers, and so forth between programmable environmental comfort controllers. Users may also upload images for the programmable environmental comfort controller screensaver and background wallpaper, and save settings from an existing programmable environmental comfort controller that can be exported to other programmable environmental comfort controllers (so the user doesn't have to program each individual programmable environmental comfort controller).

Slideshows from the users' photos or built-in photo gallery may be employed. Home Screen information can be included in the slideshow rotation after a specified number of photos, if so chosen by the user.

The programmable environmental comfort controller may present multiple options for a clock to be displayed on said controller. For the digital clock, the programmable environmental comfort controller also shows the room temperature, displaying heating status with a red ring around the temperature number, or cooling with a blue ring around the number. The user can include the digital or analog clock in the slideshow rotation (for example, every five photos).

The thermostat may optionally include a “Simple As You Want” operation which lets users customize programmable environmental comfort controller information on display. “Simple As You Want” operation allows the user to remove the cooling references for homes without air conditioning. “Simple As You Want” operation allows the environmental comfort controller to be installed as a programmable or non-programmable programmable environmental comfort controller. “Simple Stat” operation mode provides enlarged display numbers and fewer display items making it ideal for users who only would like to use the basic functions of the thermostat.

A schedule is available with various options which keeps the home temperature comfortable, display easy to read, and a time period scheduler which automatically changes the temperature and mode for up to four periods per day, allowing for comfortable temperatures for sleeping, waking, and daytime, plus an energy savings mode which may be implemented when no one is home.

An at a glance screen lets users see temperature and heating/cooling status. The “At a Glance” screen clearly shows the user heating and cooling status, as well as the room temperature. Heat and cool Indicators give “at a glance” information on heating and cooling, so users can easily see if air conditioning or heating equipment is on (optionally, the temperature number is in blue if air conditioning is on; in red if heating is on).

A user may choose to utilize an optional outdoor temperature sensor. The programmable environmental comfort controller can be wired to an outdoor sensor so that the outside temperature can be displayed right on the screen. The user has the option to display the high and low temperatures for the day.

Comfort features for a nighttime dimmer may be implemented on the inventive thermostat by a user. Nighttime dimmer for bedroom programmable environmental comfort controllers gives the user the ability to adjust the time the dimmer is on. Users can also adjust the active brightness (when it is being touched) and the idle brightness, from 0 to 100 percent brightness with complete darkness being an option when the dimmer is idle.

Energy usage information is available on a screen to the user of the inventive thermostat. Easy access to energy usage information lets users easily see how much energy has been used to heat and cool for the past, for example seven, days. This helps users evaluate energy conservation options, giving them the option to decrease energy costs. Vacation settings to save energy when the house is unoccupied for extended periods may also be used by a user.

The programmable environmental comfort controller may also utilize security locking mechanisms. The user is presented with an option to engage an automatic screen lock that can lock the screen a number of minutes after it has been touched and requires a pass code to enable access. This feature eliminates the ability of children or guests to change programmable environmental comfort controller settings.

The inventive programmable environmental comfort controller also presents the user with the ability to enforce temperature set point limits which allows the system to run within set temperature parameters only. This ensures that no user can enable a controller to operate under parameters outside limits set by the owner, thus preventing the air conditioning system from running at too low a temperature and the heating system from running at too high.

Users may also choose their own customizable faceplate to match their home décor. Options may include but are not limited to white, black, silver, and wood grain. A wall plate may also be available, if needed, to conceal the wall area where a larger programmable environmental comfort controller previously existed.

The inventive programmable environmental comfort controller includes a Daylight Savings mode which automatically adjusts for daylight savings time. Various language choices may also be available such as English, Spanish or French. Other options include reminder alerts which remind the user to change the filter and who to call for service.

To add to the ease of identification of the inventive controller for various programming or other needs, a user is provided with the option to name the programmable environmental comfort controller. Thus, each programmable environmental comfort controller can have its own name, such as “Upstairs Thermostat” or even more friendly names, such as “The Smith Home,” or “Sally's room.”

The inventive programmable environmental comfort controller may be made compatible with most heating and air conditioning equipment and may be used to control gas/electric or heat pump equipment, for example with up to four heating and two cooling stages.

### BRIEF DESCRIPTION THE DRAWINGS

The operation of the invention will become apparent from the following description taken in conjunction with the drawings, in which:

FIG. 1 is block diagram of a programmable environmental comfort controller and devices external to it.

FIG. 2 provides a block diagram of the inventive system in an exemplary embodiment of the present invention.

FIG. 3a is a front view of one embodiment of the inventive programmable environmental comfort controller showing a home screen.

FIGS. 3b and 3c are front views of two embodiments of the inventive programmable environmental comfort controller showing screen elements.

FIG. 4 shows thermostat mode options displayed on a pullout menu of the programmable environmental comfort controller.

FIG. 5 shows fan mode options displayed on a pullout menu of the programmable environmental comfort controller.

FIG. 6 shows a flowchart illustrating the programming of home screen options in the programmable environmental comfort controller.

FIG. 7a shows a flowchart illustrating the programming of menu options of the programmable environmental comfort controller.

FIG. 7b is an image of menu options on a menu page in accordance with the method of the inventive programmable environmental comfort controller.

FIG. 7c is an image of menu options on another menu page in accordance with the method of the inventive programmable environmental comfort controller.

FIG. 8 is a flowchart illustrating display options for control screens in accordance with the inventive method for programming a programmable environmental comfort controller and relating to schedule options;

FIGS. 9a, 9b, 9c, 9d, 9e, 9f, 9g, 9h, and 9i are display screens illustrating display options in accordance with the inventive method for programming a programmable environmental comfort controller and relating to schedule options.

FIG. 10 is a flow chart illustrating the operation of the inventive smart fan control features;

FIGS. 11a, 11b, 11c, 11d, 11e, and 11f are display screens illustrating display options in accordance with the inventive method for programming a programmable environmental comfort controller and relating to smart fan options.

FIG. 12 is a flow chart illustrating the operation of the inventive screensaver control feature;

FIGS. 13a, 13b, 13c, 13d, 13e, 13f, 13g, 13h, and 13i are display screens illustrating display options in accordance with the inventive method for programming a programmable environmental comfort controller and relating to screensaver options.

FIG. 14 is a flow chart illustrating the operation of the inventive alerts feature;

FIGS. 15a, 15b, 15c, 15d, 15e, 15f, 15g, 15h, 15i, 15j, 15k, 15l, and 15m are display screens illustrating display options in accordance with the inventive method for programming a programmable environmental comfort controller and relating to alerts options.

FIG. 16 is a flow chart illustrating the operation of the inventive display feature;

FIGS. 17a, 17b, 17c, 17d, 17e, 17f, 17g, 17h, 17i, 17j, 17k and 17l are display screens illustrating display options in accordance with the inventive method for programming a programmable environmental comfort controller and relating to display options.

FIG. 18 is a flow chart illustrating the operation of the inventive preferences feature;

FIGS. 19a, 19b, 19c, 19d, 19e, 19f, 19g, 19h, 19i, 19j, 19k, and 19l are display screens illustrating display options in accordance with the inventive method for programming a programmable environmental comfort controller and relating to preferences options.

FIG. 20 is a flow chart illustrating the operation of the inventive set time & date feature;

FIGS. 21a, 21b, 21c, and 21d are display screens illustrating display options in accordance with the inventive method for programming a programmable environmental comfort controller and relating to set time & date options.

FIG. 22 is a flow chart illustrating the operation of the inventive vacation feature;

FIGS. 23a, 23b, 23c, 23d, 23e, 23f, 23g, 23h, 23i, 23j, 23k, 23l, 23m, 23n, 23o, and 23p are display screens illustrating display options in accordance with the inventive method for programming a programmable environmental comfort controller and relating to vacation options.

FIG. 24 is a flow chart illustrating the operation of the inventive security feature;

FIGS. 25a, 25b, 25c, 25d, 25e, 25f, 25g, 25h, 25i, 25j, 25k, and 25l are display screens illustrating display options in accordance with the inventive method for programming a programmable environmental comfort controller and relating to security options.

FIG. 26 is a flow chart illustrating the operation of the inventive information feature;

FIGS. 27a, 27b, 27c, 27d, 27e, 27f, 27g, 27h, 27i, 27j, 27k, 27l, 27m, and 27n are display screens illustrating display options in accordance with the inventive method for programming a programmable environmental comfort controller and relating to information options.

FIG. 28 is a flow chart illustrating the operation of the inventive settings feature;

FIGS. 29a, 29b, 29c, 29d, 29e, 29f, 29g, 29h, 29i, 29j, 29k, 29l, 29m, 29n, 29o, 29p, 29q, 29r, 29s, 29t, 29u, 29v, and 29w are display screens illustrating display options in accordance with the inventive method for programming a programmable environmental comfort controller and relating to settings options.

FIG. 30 is a chart including a screen display for activating emergency heat options in accordance with the inventive thermostat and method.

FIG. 31 is a chart including a screen display for assisting the user to download software (referred to as ColorTouch™ Assistant) for amending the operation of the inventive thermostat in accordance with the method.

### DETAILED DESCRIPTION OF THE PREFERRED EMBODIMENTS

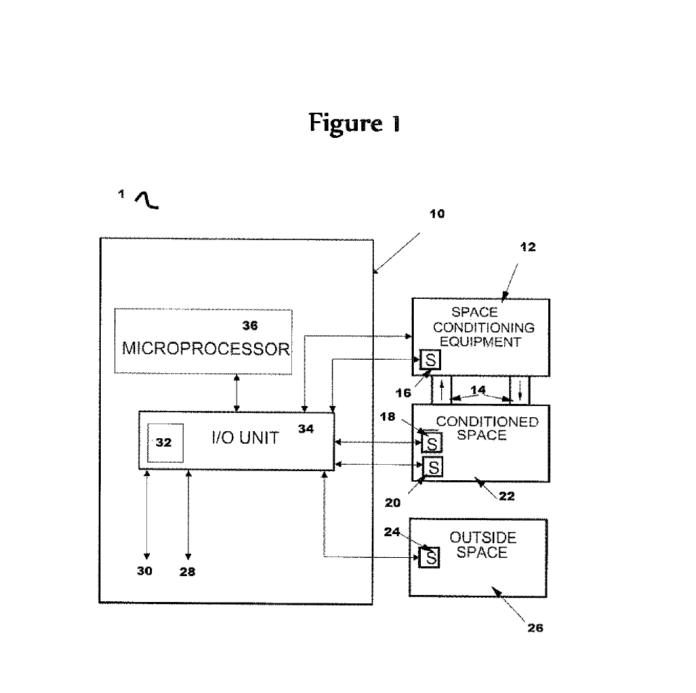

Referring to FIG. 1, a block diagram of a facility 1 incorporating a programmable environmental comfort controller 10 constructed in accordance with the present invention is illustrated. The inventive thermostat 10 controls environmental control equipment 12. Environmental control equipment 12, in turn, provides its output to a network of conventional ductwork 14. The inventive comfort controller 10 is responsive to sensors 16 (which may sense the condition of the equipment with respect to overheating or the like), 18 (which may be a temperature sensor) and 20 (which may be a humidity detector used to control the operation of a humidifier). Space conditioning equipment 12 connects to a space 22 through ducts 14. Sensor 24, which may be a temperature sensor, is thermally-coupled to or located in the outside ambient space 26. For example, sensor 24 may be a temperature detector mounted on the side of a house being heated and air-conditioned by the space conditioning equipment which in turn is controlled by the inventive comfort controller 10. While the controller 10 may be made in a wide range of sizes, it is contemplated that the device will typically have a length of approximately 5.25 inches and a width of 3.75 inches.

The inventive comfort controller 10 is controlled using a touch sensitive liquid crystal display (LCD) 28, which may have a height, for example, of 2.2 inches and a width of 3.75 inches. One or more touch sensitive control buttons 30 may be presented on display 28 by the system. Comfort controller 10 may be coupled by external communication interface circuit 34 to sensors, for example sensors 18 and 20 within the space to be conditioned, and sensor 24 which is in the ambient environment surrounding the building being heated or cooled. Likewise, equipment 12 to be controlled by comfort controller 10 may also be coupled by interface circuit 34.

Microprocessor 36 comprises digital processing means for data storage and recovery, as well as memory for storing and operating a thermostat control program. Microprocessor 36 is connected with an input/output unit or interface 34, which in turn is connected with wired and/or wireless external communication means 32 for exchange of data, digital files, and operational software programs and program revisions capable of being stored by and/or operated in cooperation with a control program stored in the programmable environmental comfort controller 1010. A part of a local user interface (among other features of such a local user interface) comprises one or more pressure sensitive buttons 30, which may be physically present as spring loaded buttons or, in accordance with the preferred embodiment of the invention, as virtual buttons as represented upon liquid crystal touchscreen display (LCD) 28. The local user interface thus comprises liquid crystal display 28, upon which are displayed outputs of microprocessor 36, including areas of a touch screen predetermined to be activatable by touch of a human finger or by other means. Local equipment status information, temperature, and humidity may respectively be transmitted from the sensors 16, 18 and 20, respectively, to the microprocessor 36 through the input/output unit 34 for display on LCD 28. Microprocessor 36 transmits, through input/output unit 34, control outputs to environmental control equipment 12, for control of ambient heating, cooling, humidification or de-humidification. Environmental control equipment 12 operates in most instances to circulate room air from conditioned space 22 through ductwork formed by ducts 14 to change ambient conditions in space 22. Sensor 24 can sense environmental conditions of outside space 26 and transmit signals indicative of those conditions to the microprocessor 36.

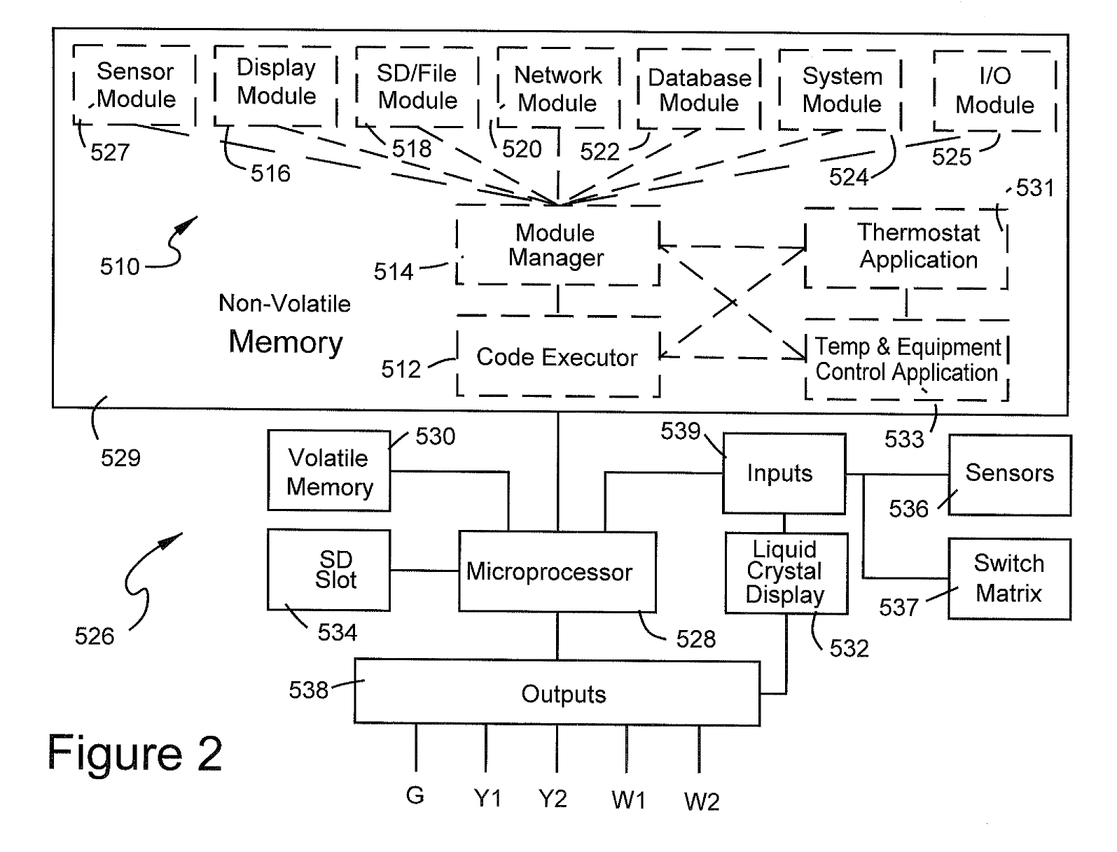

FIG. 2 is a schematic representation of an exemplary embodiment of the present invention. Software 510, which may be stored on SD card 534, comprises a code executor 512, which, acting through a module manager 514 coordinates execution of the software code associated with the various functions of the comfort controller of the present invention. The module manager 514 interfaces with a number of modules each of which is associated with a specific function. These include a display module 516 which generates the digital signals needed to control the LCD display on the inventive comfort controller. An SD/File module 518 performs the function of storing information on SD card 534. A network module 520 controls the operation of connections to external devices, which may be such things as a modem or a wireless hub for connecting to the Internet or the like. A database module 522 controls the storage of such information as temperature setpoints, time set points, user preferences, wallpaper, and so forth in SD card 534. System module 524 controls the generation of signals associated with turning mechanical systems on and off. Software 510 controls the operation of hardware 526, which includes a central processing unit (CPU) 528 which executes software 510. Memory 530 constitutes random access memory and is used in a conventional manner during code execution. LCD 532 is of conventional design and is driven, together with SD 534, and sensors 536 (such as temperature sensors), by input/output interface circuits 538. Hardware 526 is a bare-metal electronics board that interfaces with the air conditioning or related equipment.

Software 510 is a generic multitasking real-time operating system, and may come in different versions compatible with various operating systems, such as Apple iOS, Android, etc. Software 510 abstracts the operating system calls and hardware 526 from thermostat related applications.

In accordance with the preferred embodiment, code executor 512 is swappable and is not programming language dependent. Module manager 514 is the interface between the software code and the operating system. Each module in software 510 performs the translation necessary for the platform so that the higher level application(s) do not need to be aware of the hardware that they are running on, as is conventionally done in the art. Software 510 can communicate with each other with an internal event bus which allows the main code to be separated out from the control code. The control code or any other algorithm can be reused in different applications without modification. This makes thermostat development very agile and opens up the possibilities for creating new devices for many purposes form a single source code.

The above design options may present the skilled designer with considerable and wide ranges from which to choose appropriate apparatus and method, with and without modifications of the above examples.

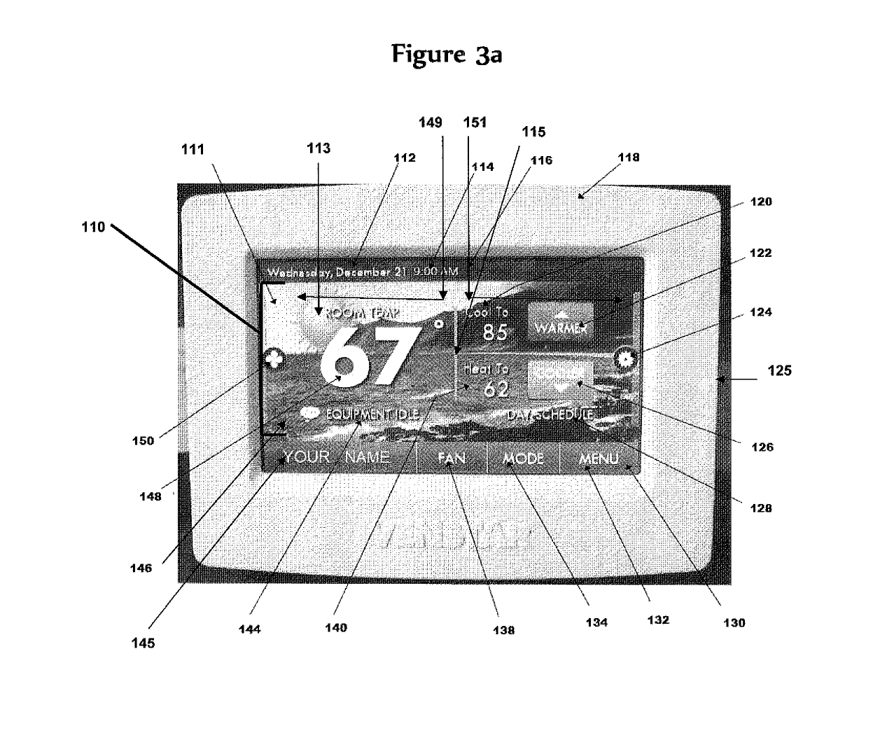

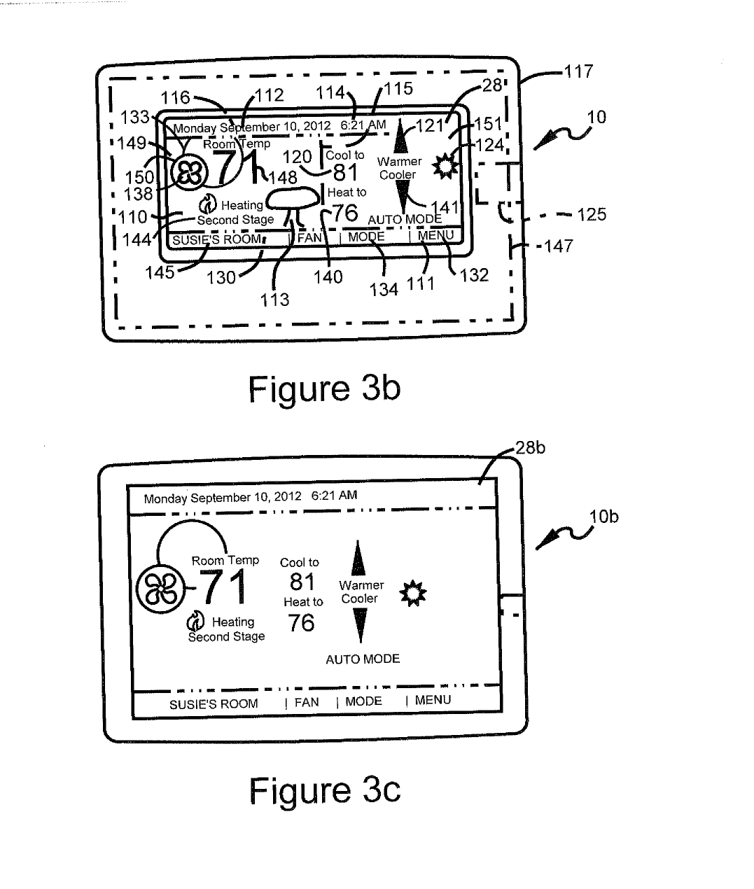

FIG. 3a is a front view of one embodiment of the inventive programmable environmental comfort controller showing a home screen which is further explained in FIG. 3b.

FIG. 3b shows a front view of a programmable environmental comfort controller 10. The present invention is directed to a programmable environmental comfort controller 10 which includes a support housing 117 which supports a touch screen liquid crystal display 28, which is in turn secured to a circuit board 147, also secured to support housing 117. Touchscreen 28 is driven by microprocessor 36 through interface circuit 34. An interface program creates touch sensitive areas on touchscreen 28 during operation of comfort controller 10, thereby allowing user to program the programmable environmental comfort controller 10. Support housing 117 may be fixed to a wall and connected by wire to mechanical systems in the home or other facility.

Alternatively, comfort controller 10 may be capable of being carried or moved from one place to another, communicating with fixed communication means and/or equipment by way of wireless communications. Finally, override or programming facilities may be accessed by a handheld device, such as an Android or Apple device by providing comfort controller 10 with wireless connectivity to a router connected to the Internet.

Support housing 117 provides a picture frame effect for the touch screen 28, which is enabled to display color graphics and to be adaptable so that all or any part of the visible part of touch screen 28 may be touched, as defined within screen coordinates by the control program, and said control program shall respond to said touch as a user interface input from the user. Optionally, customizable faceplates to match home décor may be used by a user. Users can choose their own customizable faceplate to match their home décor. Options may include white, black, silver, and wood grain. Additionally, a wallplate may be used in with support housing 117 if needed to conceal the wall area where a larger thermostat previously existed.

Alternatively, as shown in FIG. 3c, a comfort controller 10b with may be made relatively large in size, for example eight inches by ten inches and have a display 28b seven inches by time inches in size. This presents the appearance of a conventional picture frame and makes the comfort controller 10b into an attractive home accent when, in accordance with the invention, screensaver images are displayed on display 28b, a predetermined number of seconds after programming input has ceased. However, comfort controller home screen may be caused to be displayed by the user simply touching screen 28b at any location on the screen.

Returning to FIG. 3a, optionally programmable environmental comfort controller 10 may include an SD card slot 125 in support housing 117 for reading a conventional SD card. In accordance with a preferred embodiment of the invention, the SD card slot allows the downloading of information over the Internet onto the SD card which in turn is then inserted into slot 125. One may then import images and programs to the environmental comfort controller 10 as well as export programs and images to a computer.

Virtual representations of buttons or activating-indication icons, text, or graphics, may appear on touch screen 28 which a user will understand, from their context, to be of the type that that may be activated by touching touch screen 28 in those defined areas, with the result of causing the control program to respond to touchscreen 28 as a user interface input from the user.

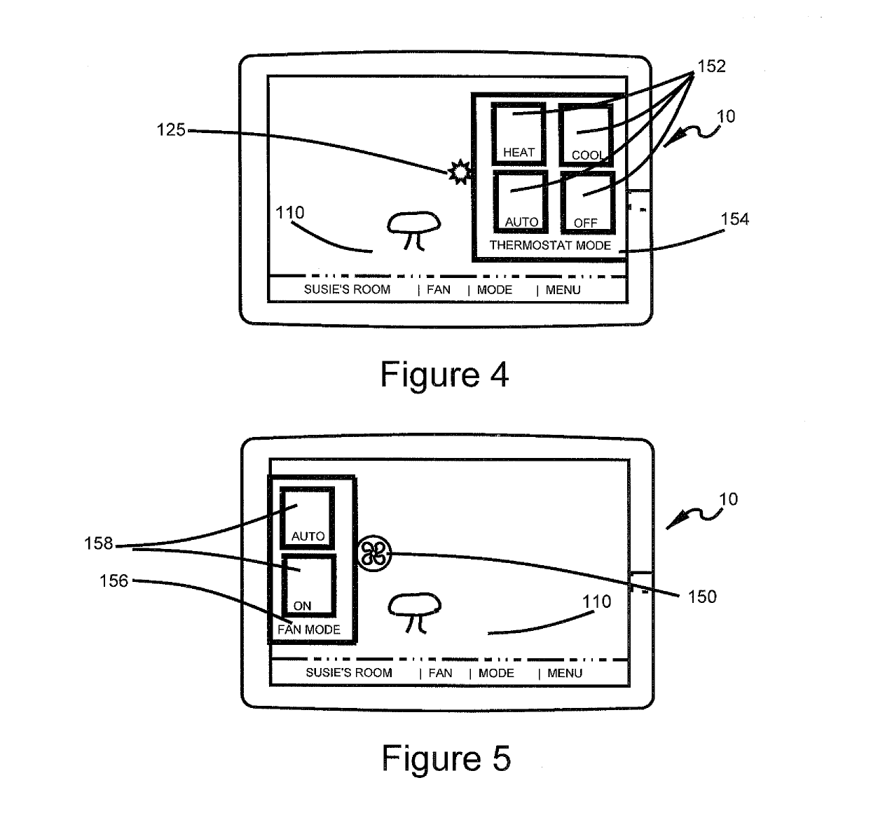

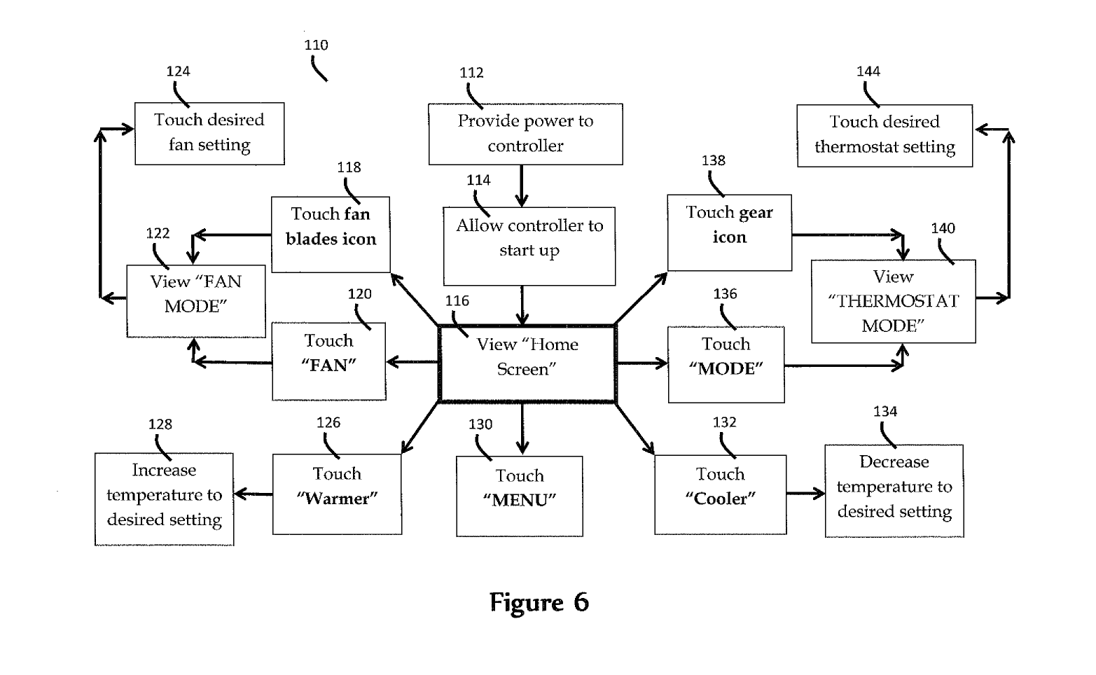

Generally, a home screen 111 may be understood from viewing FIGS. 3a-6. FIG. 3a shows a home screen 111. FIGS. 4 and 5 show submenu screens which may be navigated to directly from home screen 111 as explained below. FIG. 6 is a flow chart of navigation starting from, for example, home screen 111, and illustrating the steps for operation of programmable environmental comfort controller 10.

At step 212, power is provided to programmable environmental comfort controller 10. This causes programmable environmental comfort controller 10 to start up at step 214 by going through its boot sequence. After booting, home screen 111 (FIG. 3a) is displayed on the touch screen 28 of the programmable environmental comfort controller 10 at step 216. Home screen 111 serves as the user's primary screen to view, access, and/or change various sensor readings, set points, and settings. Additionally, home screen 111 may display one or more buttons such as a menu touch region 132, mode touch region 134, and/or fan icon 138 which may lead to one or more sub-screens (not shown) displaying prompts to a user corresponding to the interface program of the virtual button pressed on home screen 111 or a sub-screen.

In a preferred embodiment, home screen 111 includes a combination of virtual buttons 122, 124, 126, 132-138, and 150, virtual bars 116 and 130, user programmed set points 120 and 140, and sensor point 148. These touch sensitive buttons are all likely be often used by a user. Accordingly, they are displayed in a manner that is aesthetically pleasing, as well as easy to discern and use as described below. Such use may be explained by using references, in a user's manual and charts, to font size, position of information and virtual buttons, and perhaps color. Home screen 111 is also adapted for displaying a selectable background visual display, which can constitute imported photographs, stock photographs, or other sources or other decorative backgrounds.

Home screen 111 further includes touch sensitive areas to cause the system to navigate to at least one submenu information displaying panel, such as that illustrated in FIG. 4, or the panel illustrated in FIG. 5.

In preferred embodiments, the touch screen has a visual appearance with touch sensitive buttons or areas clearly discernible from the background visual, much like icons on a PC desktop. Typically, the informational displays (which appear together with touch sensitive buttons) on various panels constitute a display for displaying information constituting a plurality of physical parameters, such as time, date, temperature, fan status, etc.

As alluded to above, home screen 111 includes a plurality of buttons which caused touchscreen 28 to display selectable subpanels for performing various control functions, preferably each of which has a visual appearance distinct from that of the background and is superimposed upon the equivalent of a desktop background. The buttons on each of these touchscreen subpanels contain visual indicia for controlling different sets of HVAC parameters and/or other aspects of system operation.

In further preferred embodiments, the programmable thermostat of the present invention may also include a plurality of touch screen subpanels which do not have a desktop background visual display, but are limited to a display of buttons for controlling the details of the physical operation of an HVAC system and the setting of a parameter or parameters for the system. Such touch screen subpanels of the programmable comfort controller or thermostat may do away with the desktop background visual display in favor of a display for controlling the details of a physical operation of an HVAC parameter with the objective of illustrating interrelationships and programming sequences with greater clarity.

Subpanels screens may be selected from the group that includes, inter alia, submenu panel screens for a heat/cooling mode (FIG. 4) (which may also include a background picture), a fan mode (FIG. 5) (which may include a background picture), and a menu mode with a plurality of icons showing navigation options (which may include a number of options without showing a background picture).

In the present invention, the various panels preferably present different appearances to the observer/user in order to facilitate ease of their use. Such touch screen subpanels may preferably further include visual indicia different and substantially visually distinguishable from the background visual display. These information displaying panels in preferred embodiments may, for example, be formed of a different color from that of the background visual display. Also, the touch screen controlling subpanels may be a different color from those of the background visual display, and the touch screen controlling subpanels may likewise be each a different color. However, background visual displays provided by the end-user may not provide ideal contrast, and user discretion, substantially identical to that used in the case of PC desktop backgrounds, can easily make the display one that is easy to use.

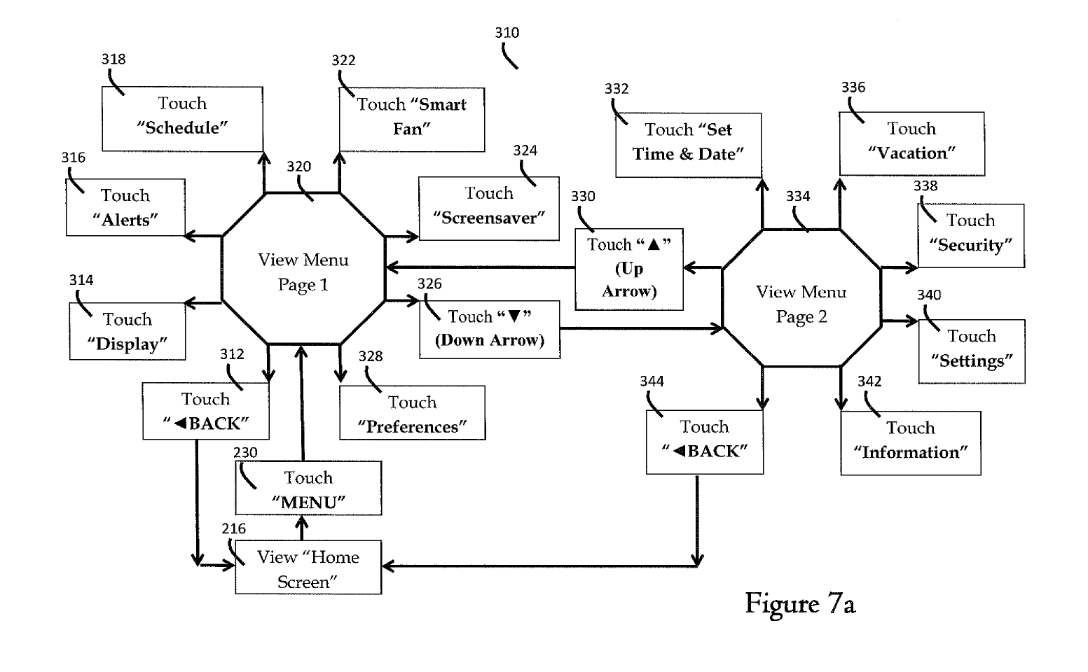

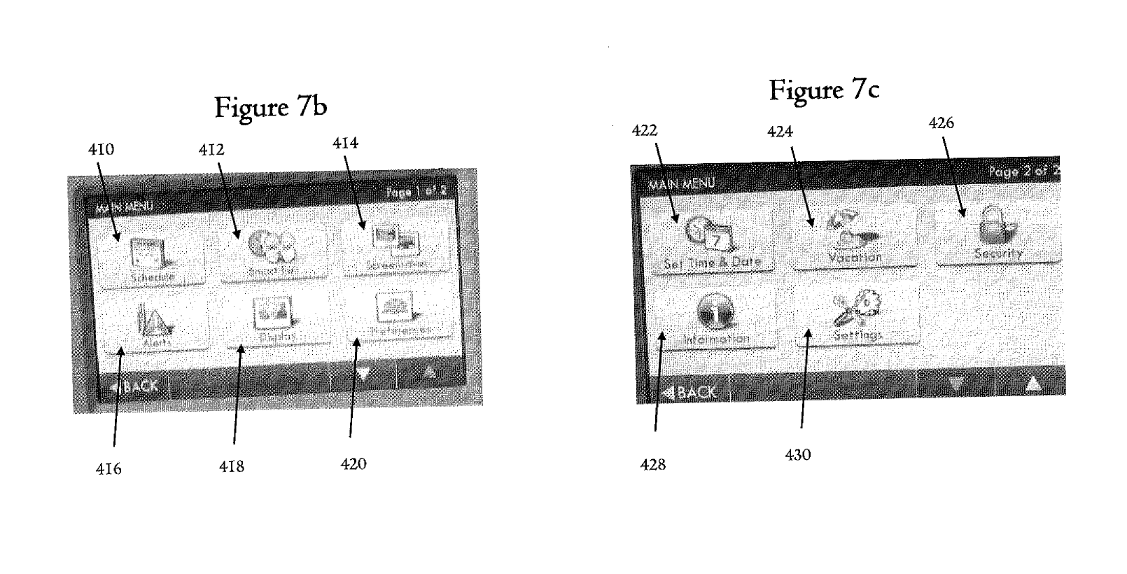

The touch screen of the programmable thermostat of the invention may further include a date display section 116 comprising distinctly different visual indicia from that of said background visual display. In other preferred embodiments of the programmable thermostat, the touch screen further include at least one panel comprising an icon or icons. The icons may be selected from, inter alia, fan (FIG. 5), heating/cooling (FIG. 4), and menu icons (FIGS. 7b-7c).

The subpanels for controlling an HVAC parameter may comprise controls for increasing and decreasing temperature. The touch screen panel may include elements for selecting one from among a plurality of physical zones.

In such preferred embodiments of the programmable thermostat of the present invention, at least one programmable touch screen panel controls a customizable theme, background or screensaver, and may thus include users' photos, and/or provided pictures. At least one of the programmable touch screen panels may preferably control the importing of photos into said programmable thermostat via software and an SD memory card, or via software and an SD memory card.

At least one such programmable touch screen panel may control a setpoint schedule which automatically changes the temperature and modes for a selected number of time periods per day, thereby allowing for comfortable temperatures for sleeping, waking, and daytime, plus, for example, an energy savings mode for when no one is home. The programmable touch screen panel(s) may also show the user heating and cooling status and the room temperature, and may further include an energy usage screen.

The system may also include a programmable dimmer which reduces the brightness of the touchscreen display. In this respect, the longevity of the screen is improved because of the limited number of hours that a display will maintain a desired degree of brightness and the usual situation of use where the display on the controller is always on. In accordance with the invention, display longevity is promoted by 1) dimming the display brightness after a period of time, such as sixty seconds after the environmental comfort controller has been programmed, adjusted or otherwise been actuated, adjusted or otherwise interacted with by the user, 2) shutting off the display after a period of time, such as sixty seconds after the controller has been programmed, adjusted or otherwise been actuated or adjusted by the user, or 3) combinations of shutting off or dimming of the display.

Further specific embodiments may include structures for controlling access to energy usage information, which lets users see how much energy has been used to heat and cool for a past time period, such as for example, the past seven days. This helps the user evaluate energy conservation options, giving the option to decrease energy costs. Vacation settings to save energy when the HVAC condition structure, such as a house, is unoccupied for extended periods.

The programmable touch screen panel may also control a screen-locking security function, thereby allowing a user to lock the thermostat. In such embodiments the security of locking thermostat option functions to engage an automatic screen lock that can lock the screen within a selected time interval, such as, for example, two minutes after it has been touched. After that the inventive thermostat requires a pass code to enable access, thereby eliminating the unauthorized changing of thermostat settings.

Referring to FIG. 3, in preferred embodiments, a virtual bar 116 is displayed at the top of home screen 111 which displays the date 112 and/or time 114 as set by the user. Text in virtual bar 116 may be static, crawling, flashing and/or changing at a predetermined interval(s) according to the objects of the invention. Text in virtual bar 116 may change to display information about weather, equipment failure or maintenance, or other conditions about environmental equipment, or programmable environmental controller programming features which may require or be desirable for modification.

A virtual bar 130 may also be displayed at the bottom of home screen 111 containing one or more of the following: a user selectable title 145 (e.g. room name, bedroom occupant, etc.) for the programmable environmental comfort controller 10, a fan virtual button 138 (which may be touched to present a screen presenting user-selectable touch actuated fan options), a mode virtual button 134 which may be touched to present a screen presenting user-selectable thermostat mode options, and a menu virtual button 132 which may be touched to present a screen presenting user-selectable menu options.

Between the two virtual bars 116 and 130 is the desktop portion 110 of home screen 111 which takes up 50% or more of home screen 111. Desktop portion 110 includes a background 113. Optionally, background 113 theme comprises a wallpaper selected from one or more of a photograph, graphic and/or text presentation. Such pictures are selected with a color or colors or other such visual device which will enable visualization of various virtual buttons and touch zones located on desktop portion 110. Background 113 ideally would also set desktop portion 110 of the home screen 111 apart visually from the virtual bars 116 and 130 which are desirably of a different color or image. Similarly, background 113 would be of a color or theme which easily visually distinguishes virtual buttons from background 113. Desktop portion 110 is shown having a background formed from a single, continuous photograph, with text, graphics, and touch zones imposed upon it. In a form of this embodiment, a conceptually unified background graphic (such as a photograph, a graphic pattern, color(s), an advertisement, a selection of text, or the like) forms between 25 to 95 percent of desktop portion 110 without obstruction of other graphic, design, or text elements to preserve a desired aesthetic effect of said background graphic. Alternatively, said background graphic comprises 40 to 80 percent or 60 to 98 percent of desktop portion 110 without obstruction of other graphic, design, or text elements to maximize a desired aesthetic effect of said background graphic.

Additionally, desktop portion 110 may be visually divided either conceptually by the position of the content displayed on desktop portion 110 or by a visible divider 115 which may divide the screen into two or more portions, ideally creating a left lateral portion 149 and right lateral portion 151 of desktop portion 110. The format of desktop portion 110 as described below has been found to be consistent with Western reading skills in moving from right to left, i.e., information about current conditions and operations at the left and information and virtual buttons for changing setpoints and other thermostat features to the right. A right side of right lateral portion 151 is further divided in two, with setpoint(s) displayed at a leftmost area and virtual button(s) for changing setpoints(s) in a rightmost area, further reinforcing the left to right reading motion with a left to right information to action steps completion.

On left lateral portion 149 of desktop portion 110, the room temperature 148 as read by a sensor is displayed in a size larger than all other text on the screen making it easy for a user to read. Ideally, room temperature 148 would occupy a major portion of desktop portion 110 and be in clear contrast of color from the background of desktop portion 110. Desktop portion 110 in FIG. 3a comprises text “ROOM TEMP” indicating that the displayed temperature is of the room in which the programmable thermostat is located, but an exterior temperature or other sensed temperature may be displayed with explanatory text for a user to review. The current active mode 144 such as heating or cooling of the programmable environmental comfort control system is displayed in text and/or graphics under room temperature 148, in a font size ⅓ or less than room temperature 148 size font. Current active mode 144 allows a user to instantly understand the environmental control equipment which is currently being operated by programmable environmental comfort controller 10. If no active mode 144 is engaged, the system may display this by indicating the active mode 144 as text reading “equipment idle” as shown in FIG. 3 and/or a “sleep cloud” graphic with sleep representing “ZZZ” within it. Furthermore, on the far left edge of left lateral portion 149 of the desktop portion 110, a small circular icon of spinning fan blades icon 150 is displayed representing a virtual button.

As shown in FIG. 5, when fan blades icon 150 button is touched at step 218, a fan mode menu 156 is pulled out from the left side of desktop portion 110 providing various fan options 158 for the user to view at step 222 such as on or auto. It is valuable intuitively that touching a left edge button results in extension from that left edge of a small selection of displayed options which then retracts so that it does not obscure the displayed home screen 111. The same options can be viewed by a user touching fan virtual button 138 at step 220 in virtual bar 130 at the bottom of home screen 111. At step 224, a user may then set the fan to their desired setting.

Fan blades icon 150 continuously rotates only when ventilation equipment operates to cause flow of air to a conditioned space with or without cooperation with heating or cooling equipment. When programmable environmental comfort control system 1 is not operating, fan blades icon 150 is stationary. A fan icon which is animated to rotate when programmable environmental comfort control system 1 is in use subtly induces a user to consider it when approaching the programmable environmental comfort controller 10 to obtain information or make changes. Alternatively, the fan blades icon 150 may rotate indicating only that ventilation equipment is operating without cooperating operation of heating or cooling equipment, i.e., the continuous rotation at such a location is preferably the sole animation or motion on home screen 111. An animated fan blade icon 150 for activating a menu of fan operation options is an aspect of the invention.

On the right lateral portion 151 of desktop portion 110, virtual buttons 122 and 126 are displayed. This allows the user to change the set point of the temperature without having to leave home screen 111. Ideally, virtual buttons 122 and 126 would be intuitive to a user by either displaying an arrow or being in the shape of an “up” arrow corresponding to a temperature increase or a “down” arrow corresponding to a temperature decrease. Virtual buttons 122 and 126 may also be displayed in different colors such as red and blue where virtual button 122 corresponding to a temperature increase when touched is red indicating warming or heat and virtual button 126 corresponding to a temperature decrease when touched is blue indicating cooling or cold. The user may touch heat virtual button 122 at step 226 to raise the temperature and repeatedly touch heat virtual button 122 at step 228 until the desired warmer temperature is reached. The user may touch cool virtual button 126 at step 232 to lower the temperature and repeatedly touch cool virtual button 126 at step 234 until the desired cooler temperature is reached. On one side of each virtual button, the latest programmed set point is displayed for the “heat to” temperature set point 140 and for the “cool to” temperature set point 120 allowing the user to view the set point and determine whether to increase the temperature, decrease the temperature, or do neither. By touching either heat virtual button 122 or cool virtual button 126, “heat to” temperature set point 140 and “cool to” temperature set point 120 are each simultaneously increased or decreased together by one degree when touches. Simultaneous changes of each setpoint eliminates the need to separately change each set point.

On the far right edge of desktop portion 110, a small circular gear icon 124 is displayed representing a virtual button. As shown in FIG. 4, when gear icon 124 is touched at step 238, a thermostat menu 154 is pulled out from the right side of home screen 10 providing various thermostat mode options 152 for the user to view at step 240 such as heat, cool, auto, or off. It is valuable intuitively that touching a right edge button results in extension from that right edge of a small selection of displayed options which then retracts so that it does not obscure the displayed home screen 111. The same options can be viewed at step 236 by a user touching mode virtual button 134 in the virtual bar 130 at the bottom of the home screen 10. The user may then touch the desired setting at step 244 to change the thermostat setting. Mode virtual button 134 is located adjacent and closely coupled visually with warmer virtual button 122 and cooler virtual button 126 as well as gear virtual button 124 so that thermostat modes are displayed for a user to select an environmental control mode for programmable environmental comfort controller 10, such as heating, cooling, automatic, or turning off all environmental control modes for environmental comfort controller 10.

A time of day graphic display may be superimposed upon desktop portion 110, which, for a specific example is shown as an oversized sun for daytime operation algorithms of the control program, which is also optionally indicated with a time of day operation display 124, shown consistent with desktop portion 110 with the text “DAY SCHEDULE.” An oversized moon may replace a sun at desktop portion 110 for nighttime operation algorithms, with time of day display text changed to “NIGHT SCHEDULE.”

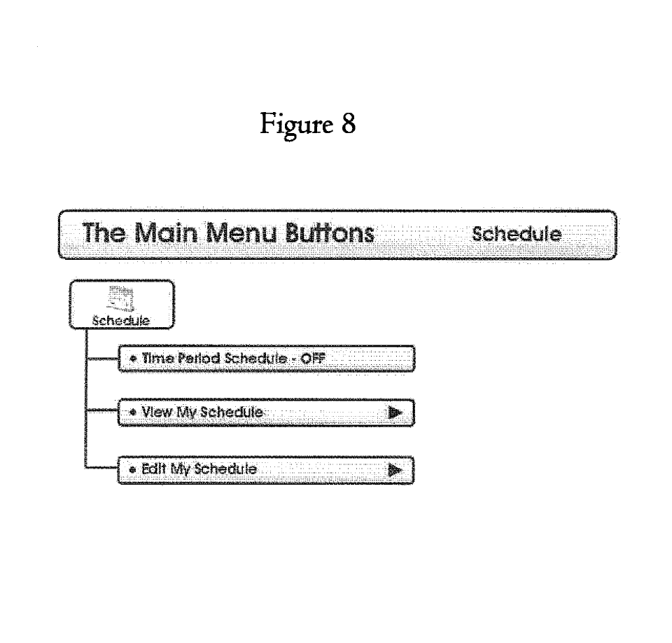

The menu functions and options may be understood from viewing FIGS. 7a, 7b, and 7c with further illustration of options and flow methodology in FIGS. 8-31 FIG. 7a shows a flow chart of a menu 310 of programmable environmental comfort controller 10. FIG. 7b shows an image of menu 310 on screen one in a preferred embodiment and FIG. 7c shows an image of menu 310 screen two. In a preferred embodiment, for ease and quick access to the programmable environmental comfort control system 1, when the gear icon 124, fan blades icon 150, mode button 134, or fan button 138 virtual buttons are pressed, all adjustable features, set points, and sensor points are displayed on one sub-screen. The virtual menu button 132 representing menu 310, however, presents the user with many options for programmable environmental comfort controller 10 such as visual preferences and/or a programmable schedule displayed across one or more sub-screens. The user views each sub-screen in turn as it is displayed to the user through various interactions and prompts with the interface of programmable environmental comfort controller 10 as explained below.

A user may view the home screen 111 at step 216 and, by touching menu virtual button 132 at step 230, a user may view a menu page at step 320 comprised of one or more subpanels of different touch screen zones representing virtual buttons for functions such as, but not limited to: Schedule 410, Smart Fan 412, Screensaver 414, Alerts 416, Display 418, Preferences 420, Set Time & Date 422, Vacation 424, Security 426, Information 428, and Settings 430 as illustrated in FIGS. 7b and 7c. In a preferred embodiment, the number of subpanels would be such that the size and spacing of the virtual button subpanels allows the buttons to be easily read, touched, and interacted with by the user, as well as practical and easy to understand, and if the buttons could not be displayed in such a manner, multiple pages or a scroll option may be used. Inn preferred embodiments where multiple pages may be necessary, the most often used subpanels would appear first and the less used subpanels would appear on the second or third pages. Furthermore, as viewed in FIGS. 7b and 7c, in addition to a short description of the function of the button such as “Set Time & Date” or “Vacation,” an image may be used such as a clock and calendar representing “Set Time & Date” or an umbrella and beach image for “Vacation” to provide easier or quicker recognition of the function for the user 10 particularly, a user familiar with programmable environmental comfort controller 210 after a number of uses.

In a preferred embodiment, the virtual buttons displayed after touching menu button 132 at step 230 and viewing said menu at step 320 may include Schedule 410, Smart Fan 412, Screensaver 414, Alerts 416, Display 418, Preferences 420, Set Time & Date 422, Vacation 424, Security 426, Information 428, and Settings 430. A user, by touching Schedule button 410 at step 318, may be brought to a screen of options relating to the scheduling functions of the heating and cooling equipment controlled by the programmable environmental comfort controller 10 such as, the ability to display various scheduling options which provide the user with the options to view and/or change whether the time period schedule programmed into the programmable environmental comfort controller 10 is turned “On” or “Off,” the ability to view their schedule, and the ability to edit their schedule.

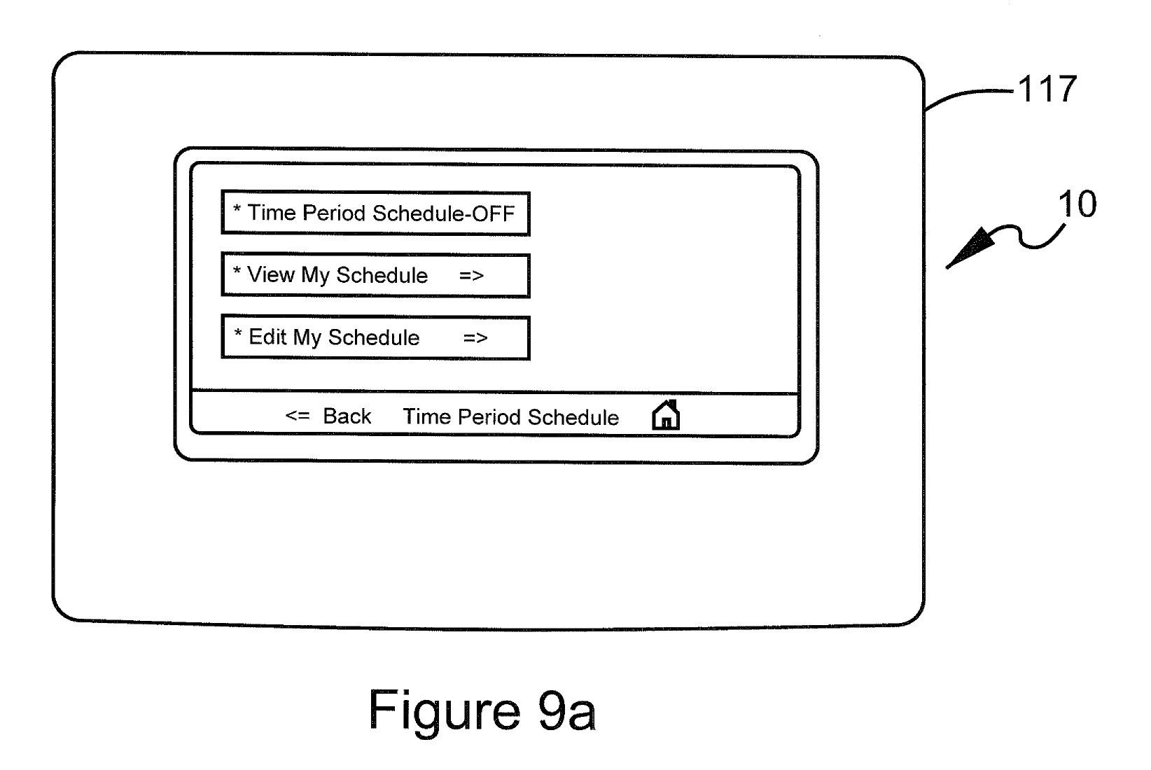

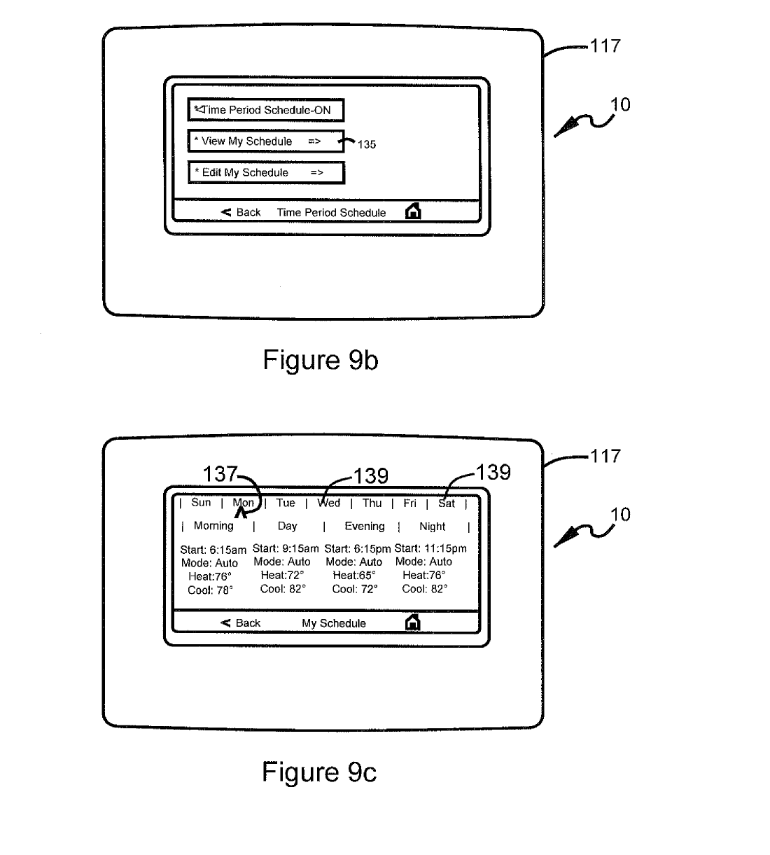

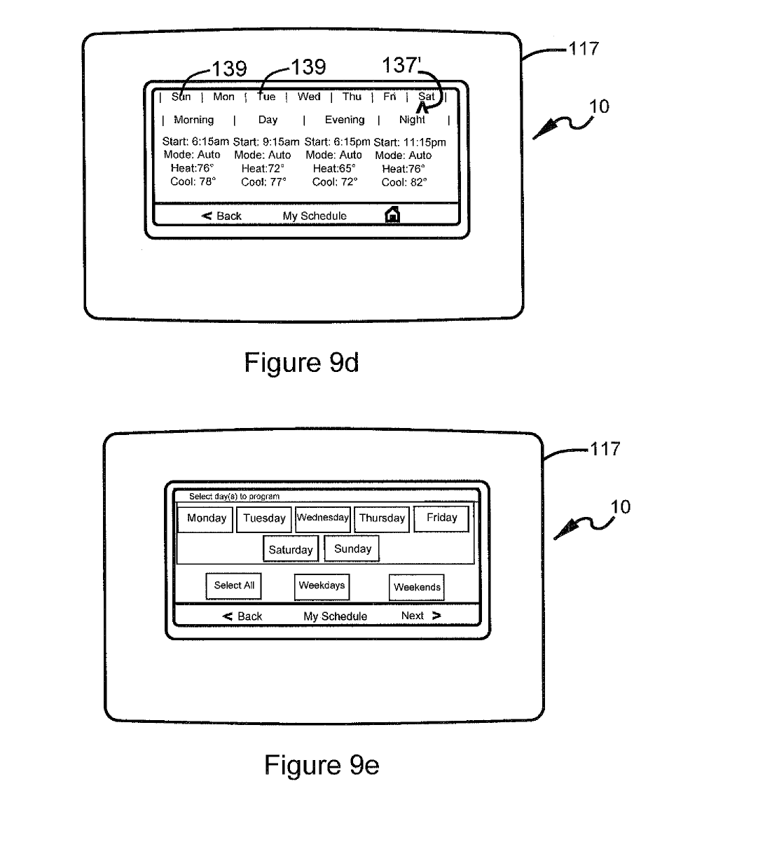

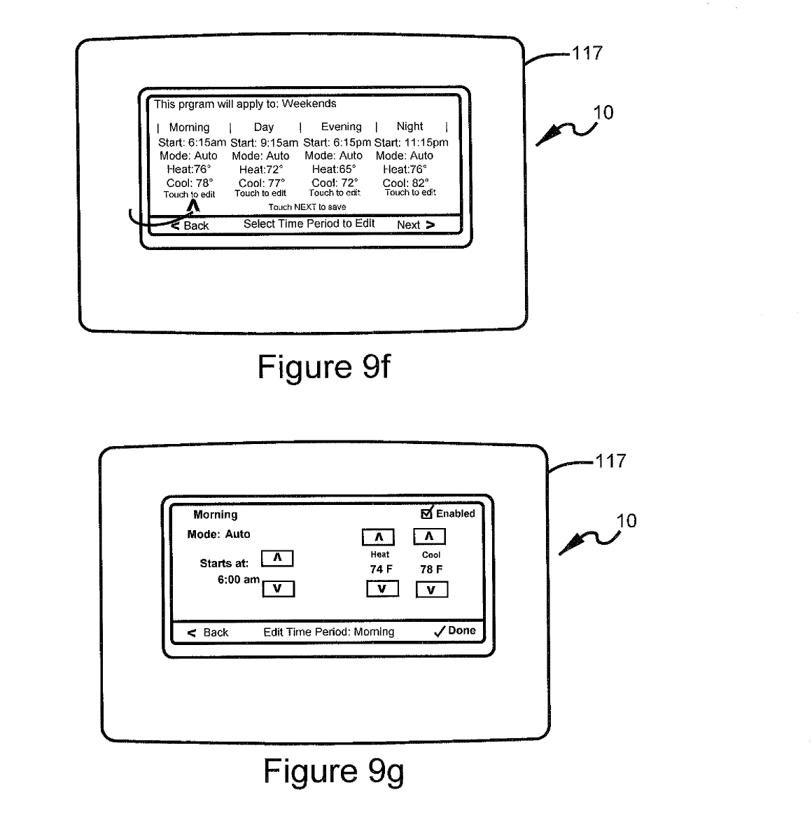

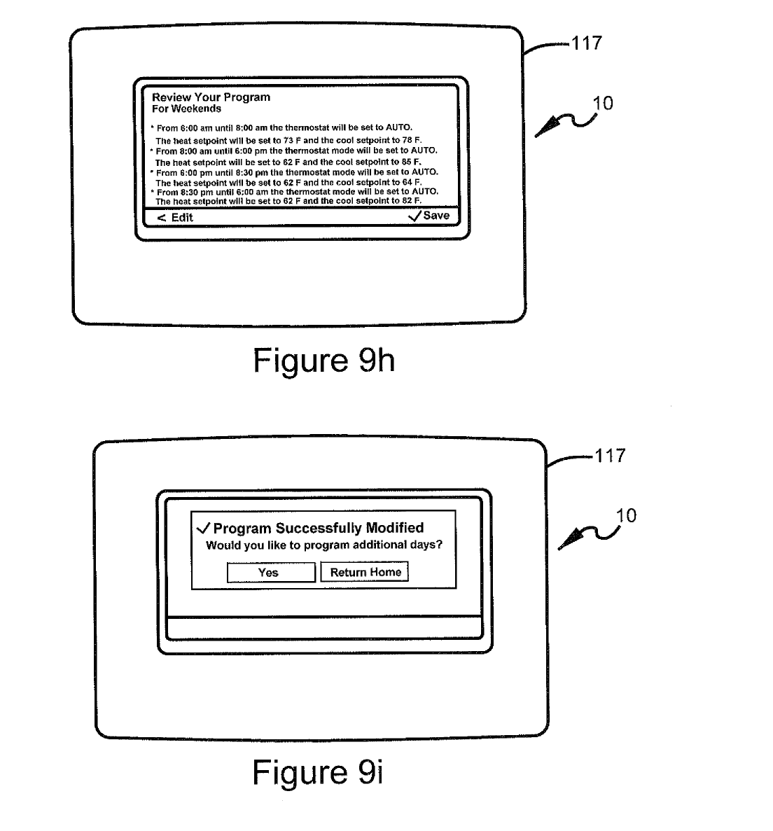

FIG. 8 provides a flow chart illustration of scheduling options which are explained further through screenshots of FIGS. 9a-9i. As illustrated in FIG. 9a, the preferred embodiment could display an overview of options relating to schedule such as a button which would allow a user to turn the programmed schedule on or off at the touch of a button labeled “Time Period Schedule—ON” or “Time Period Schedule—OFF.” Also included among the scheduling options of the invention may be a “View Schedule” virtual button 135, which, once touched as shown in FIG. 9b, would provide the user with an overview of the seven days of the week as well as various segments of each twenty four hour “day” such as morning, day, evening, and night shown in FIG. 9c for Monday and 9d for Saturday. The user could then view setpoints for the start time, the mode, the temperature to reach by heating, and the temperature to reach by cooling for morning, day, evening, and night segments for the seven days of the week. Ideally, the setpoint information for all segments of the day for all seven days of the week would not be displayed at once, but, rather, one would access such data by touching one day of the week at a time. Once a user touches the virtual button corresponding to a day of the week, the setpoints for each segment of the day may be displayed. By viewing one day of information at a time, the user may more easily view the scheduled setpoints and discern information being displayed to them.

From the “Schedule” sub-screen in FIG. 9b, in a preferred embodiment, the user may be able to touch a virtual button, “Edit My Schedule” to edit their schedule which would allow the user to make changes to the scheduled settings relating to the days of the week, the segments of the day, and options such as mode, the starting time, the temperature to heat to, and the temperature to cool to as shown in FIGS. 9e-9g. The ability to set programs for various days, FIG. 9e and times of days FIG. 9f, using the set point options shown in FIG. 9g may allow the user to lower energy costs by running their heating/cooling system less at times when it is not necessary to heat and cool an area such as on a weekend when no employees are in an office, during the week if no individuals are home, or even at specific times of the day such as heating an office in the winter as employees arrive. By programming the programmable environmental comfort controller 10, the user may achieve a more automated heating and cooling system and relieve them of the worry and trouble of manually changing the programmable environmental comfort controller 10 every time the user deems it appropriate to do so.

Ideally, after the user touches a virtual button such as “Edit My Schedule,” an interactive sub-screen would be displayed showing the individual days of the week, FIG. 9e, as well as options to select multiple days at once for editing purposes. The user, by touching a virtual button representing a day of the week, would be able to select that day for editing. The user may also touch one or more days of the week which they wish to select for editing. Furthermore, buttons may be displayed to allow selecting multiple days of the week for editing to be done with one push of one button for days typically with common temperature programs such as “Select All,” “Weekdays,” or “Weekends.”

Once the user selects the desired days for editing, the user may be led to a display screen, FIG. 9f, that may contain the morning, day, evening, and night segments of a typical day as virtual buttons. By touching one of these virtual buttons, the user may be brought to a screen, FIG. 9g, which displays various options for programming the programmable environmental comfort controller 10 for that time segment such as the mode, the starting time, the temperature to reach by heating and the temperature to reach by cooling. Furthermore, the user may be presented with an option to enable the schedule for the time segment being viewed by the user or to disable any scheduling setpoints for the time segment. Based on various settings, certain options may not be always available for instance, if only the heat mode is selected for the thermostat mode, the cooling options may be disabled or not visible since they would not be needed under a heat only mode. The user may then be able to review their programmed settings in an overview of their latest settings.

The “Review Your Program” screen, FIG. 9h, could display an overview of the latest setpoints such as start time, end time, the thermostat mode, the heat setpoint, and the cool setpoint for each day selected for editing allowing the user to review and/or evaluate this information. The user may then click an “EDIT” virtual button to return to the editing options or a “SAVE” virtual button which may confirm the program was successfully modified as shown in FIG. 9i or display an error. The confirmation page may provide additional virtual buttons to program additional days, for instance, if all of the weekdays were previously programmed and the user would like to program the weekend, or to return to home screen 218.

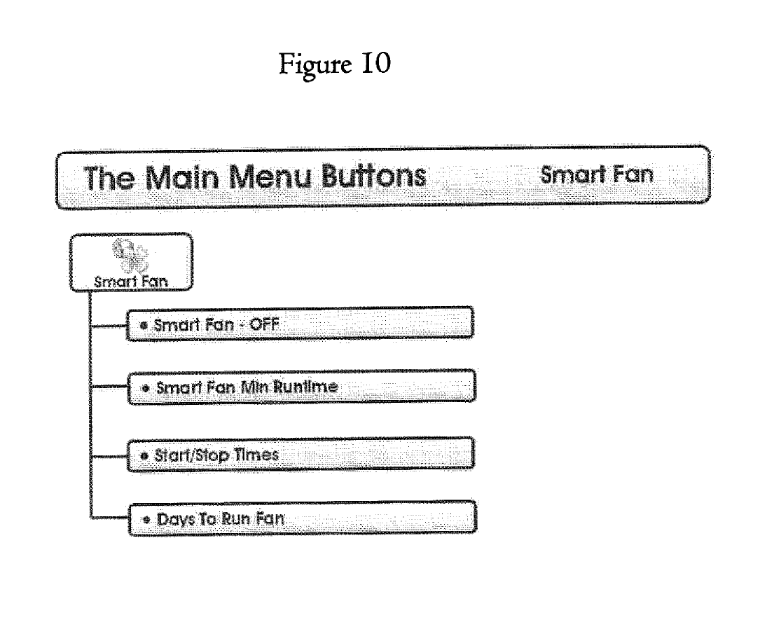

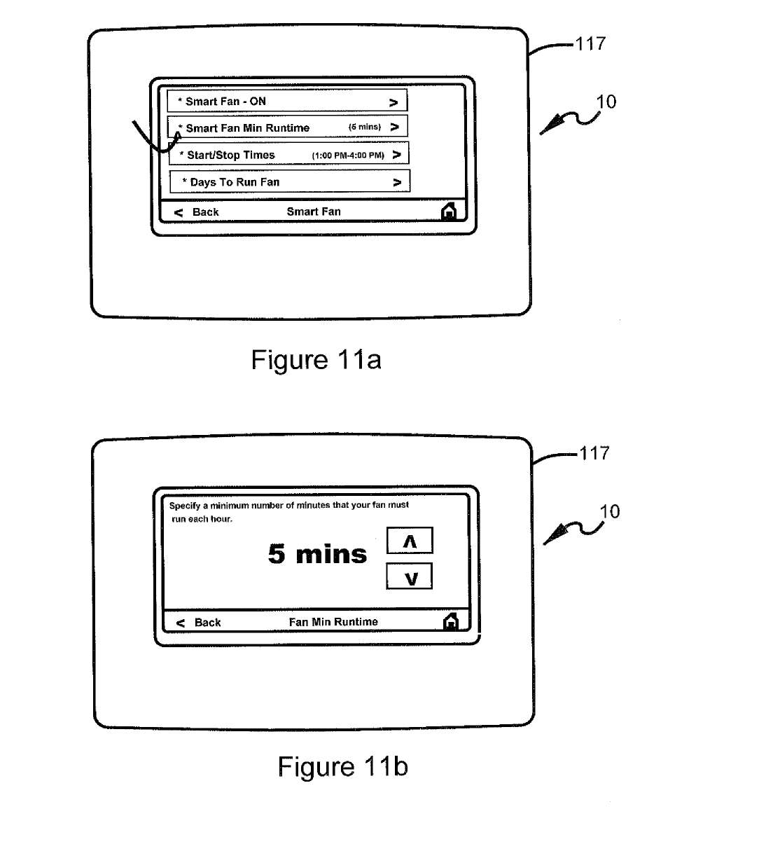

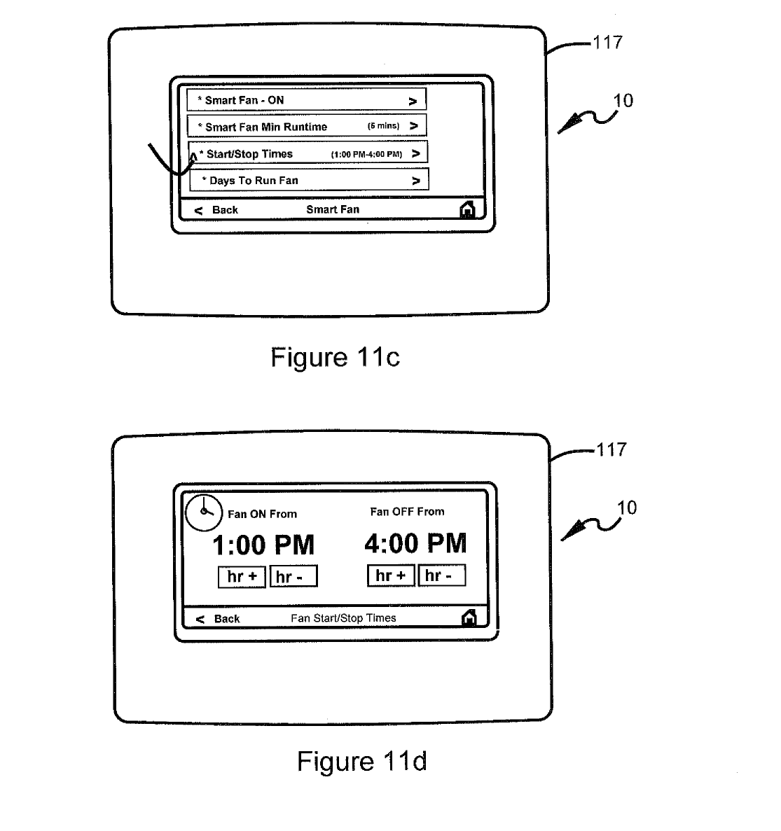

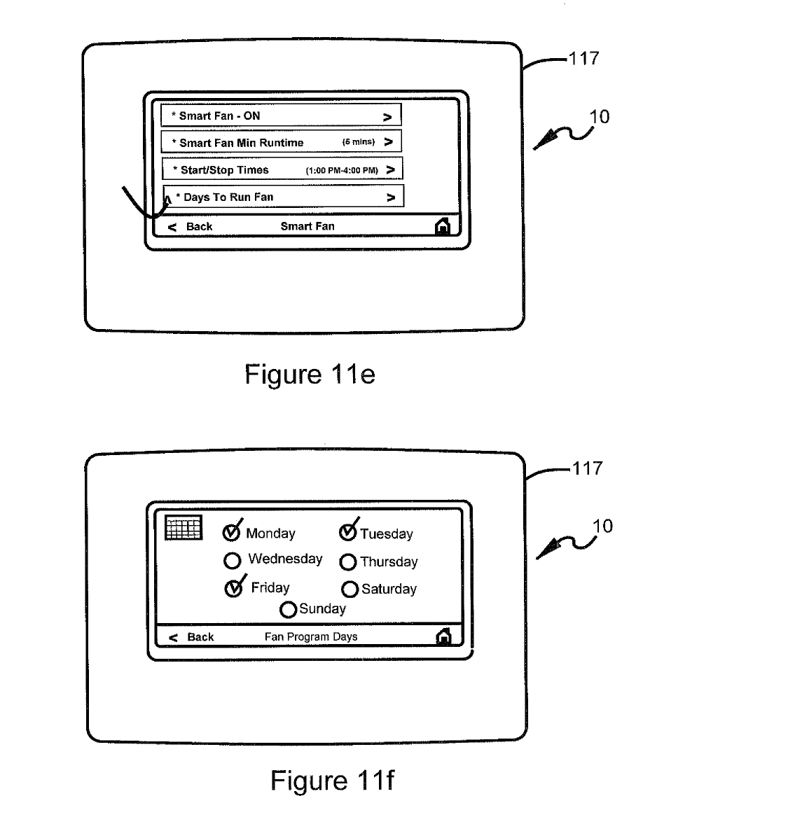

As stated above, in a preferred embodiment, the virtual buttons displayed after touching menu button 132 at step 230 and viewing the menu page at step 320 may include a button controlling fan operations such as Smart Fan button 412. A user, by touching Smart Fan 412 at step 322, may be brought to a screen of options shown in FIG. 11a relating to the scheduling functions of the fan or fans in operation and controlled by the programmable environmental comfort controller 10 as indicated by the flowchart of FIG. 10. Ideally, the user would be presented with various fan control options such as turning the programming related to the fan “ON or OFF,” viewing and/or editing the Smart Fan Runtime, viewing and/or editing the Start/Stop Times of the Smart Fan, and viewing and/or editing the Days to Run the Smart Fan.

As shown in FIG. 11a, a user may be able to control the programming of the Smart Fan with one touch of a virtual button such as that displayed which can turn all programming relating to the Smart Fan “ON” or “OFF.” The user may also be able to touch a virtual button labeled, for instance, “Smart Fan Min Runtime” which may also display the latest setpoint for the runtime of the fan. By touching this virtual button, the user may be brought a screen, FIG. 11b, where they can specify a minimum number of minutes the fan must run each hour by adjusting the setpoint time.

From the Smart Fan sub-screen, the user may be able to touch a virtual button such as that labeled “Start/Stop Times,” FIG. 11c, which may also display the latest setpoints for the start and stop times for the fan. By touching this virtual button, the user may be brought to a screen, FIG. 11d, where they can view the latest setpoint programmed for the fan to turn on and the latest setpoint programmed for the fan to turn off. If the user wishes to adjust either of these times, the user may input a time or increase or decrease the “ON” or “OFF” times with virtual buttons which may, for instance, be an “up” arrow and a “down” arrow or an “hr +” and an “hr −” virtual button for increasing the time or decreasing the time respectively in time increments, such as one hour, to the time the user desires to program.

From the Smart Fan sub-screen, as shown in FIG. 11e, the user may be able to touch a virtual button such as that labeled “Days to Run Fan.” By touching this virtual button, the user may be brought to a screen, FIG. 11f, which displays the days as virtual buttons for which the fan is programmed. If the user wishes to change the days the Fan Program is scheduled, the user may touch the day of the week to either enable the fan program to run on a previously disabled day or disable the fan program to run on a previously enabled day. For ease of use, ideally the user may make multiple changes on multiple days without having to switch screens or to save and resave the information if the user remains on one screen.

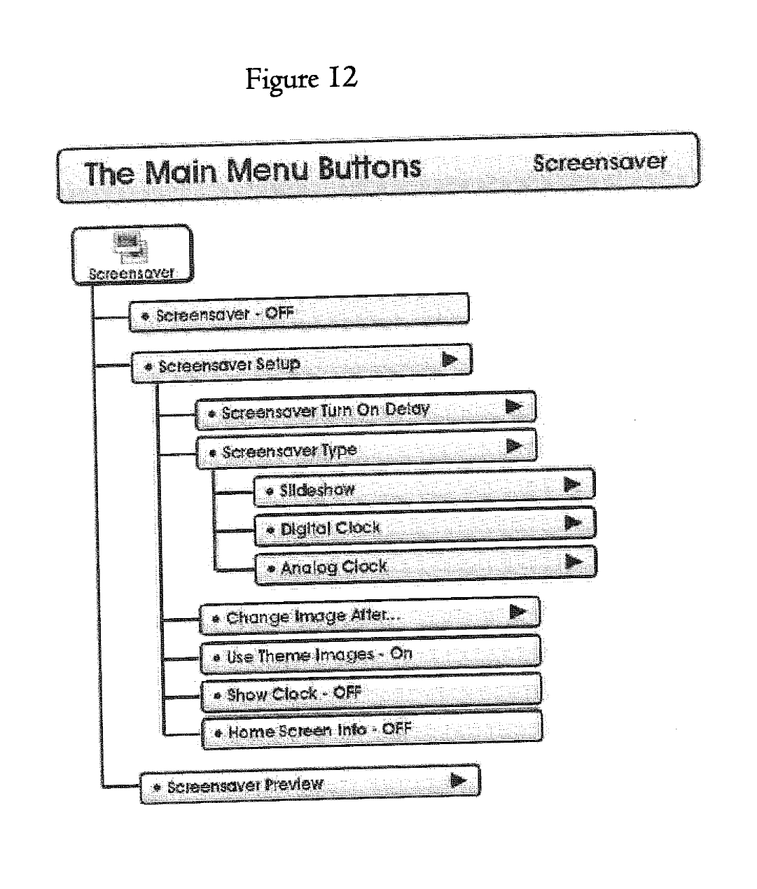

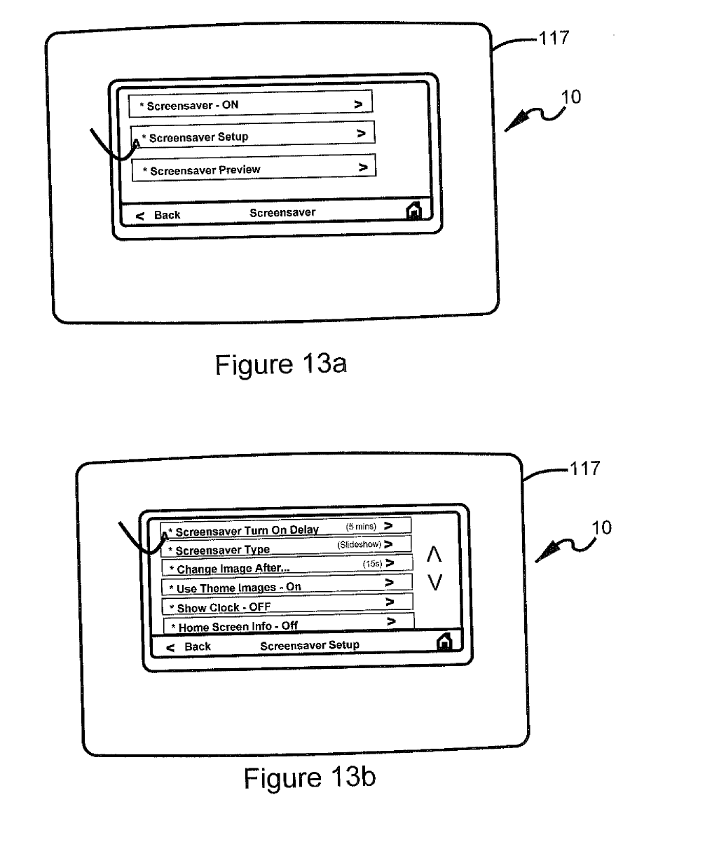

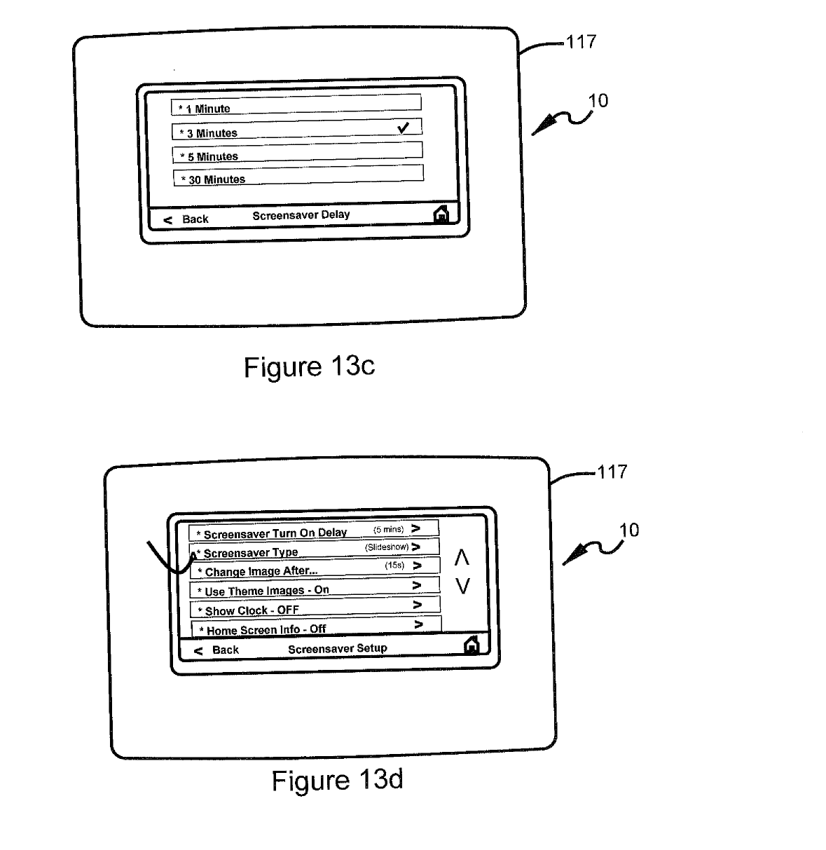

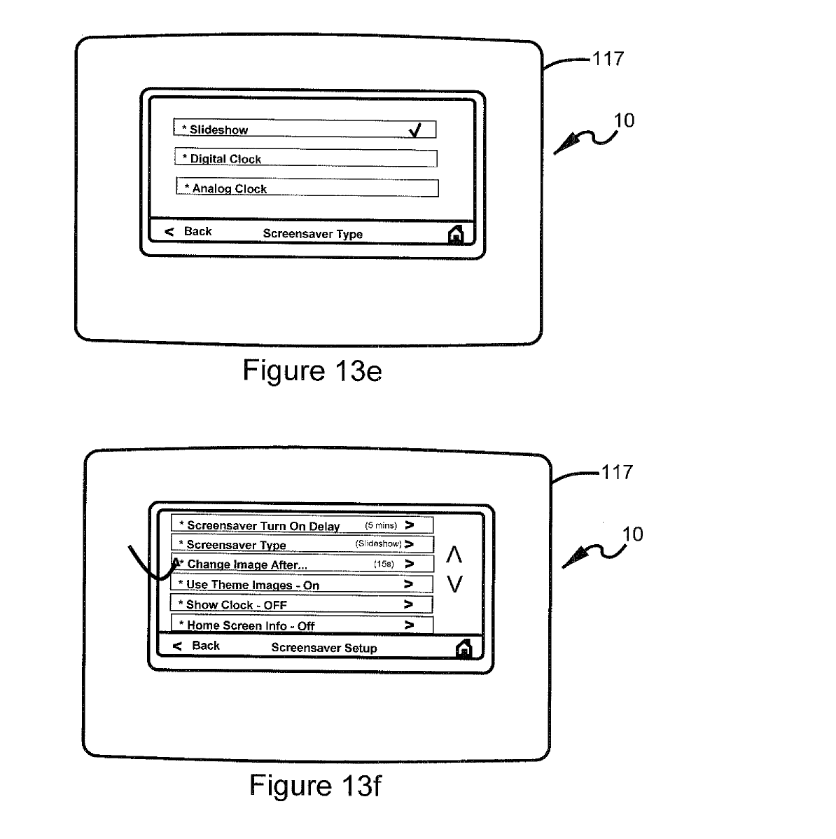

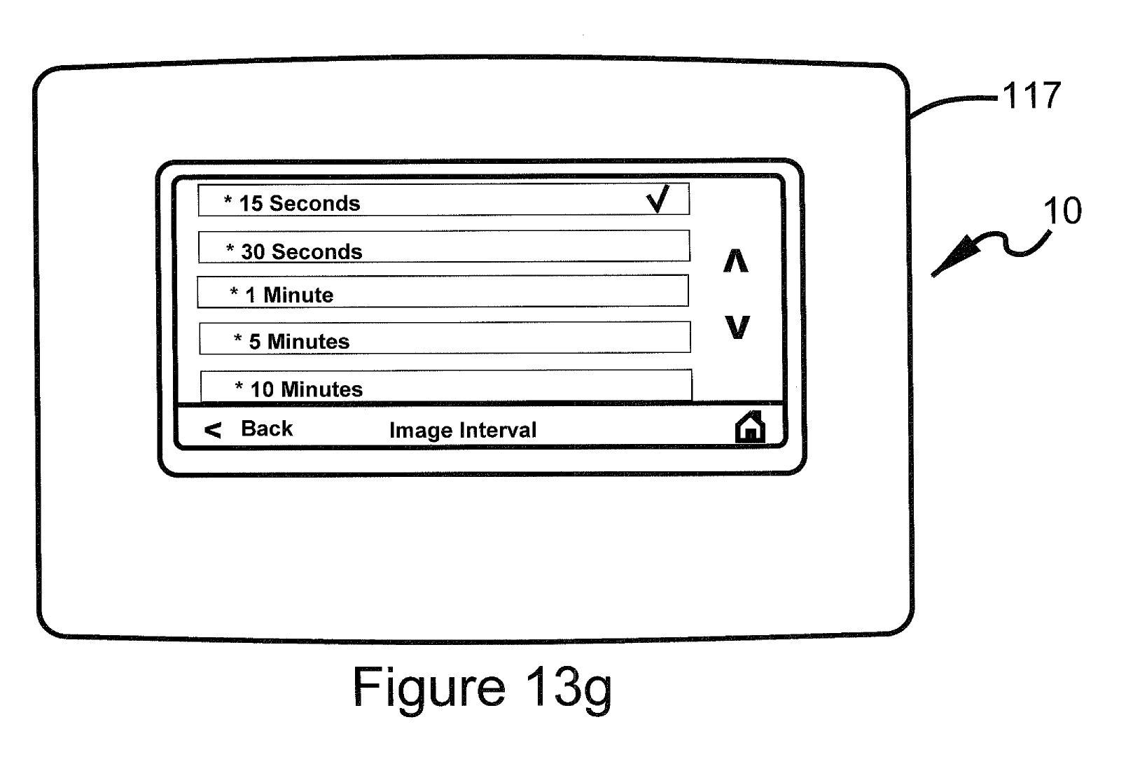

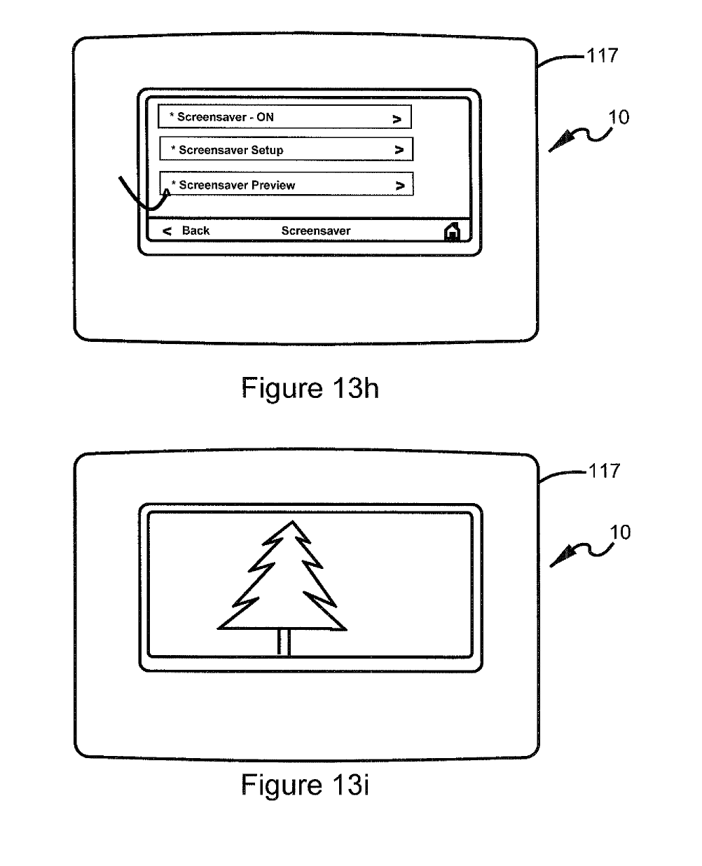

In a preferred embodiment, the virtual buttons displayed after touching menu button 132 at step 230 and viewing the menu page at step 320 may include a screensaver virtual button 414. A user, by touching screensaver 414 at step 324, may be brought to a screen of options relating to the programming of an optional screensaver to display on the programmable environmental comfort controller 10 as shown in FIGS. 12 and 13a-13i. Ideally, the user would be presented with various screensaver control options such as turning the programming related to the screensaver “ON or OFF,” and/or setting up the screensaver, and/or previewing the screensaver.

As illustrated in FIG. 13a, further options may allow the user to control the programming of the screensaver with one touch of a virtual button such as that displayed which can turn all programming relating to the screensaver “ON” or “OFF.” As shown in FIG. 13b, the user may be able to select a Screensaver Turn on Delay which allows them to control the delay in time increments between the time a user last interacted with the programmable environmental comfort controller 10 such as changing the temperature, and when the screensaver will be displayed as shown in FIG. 13c. The user may also be able to control the screensaver type by selecting Screensaver Type in FIG. 13d, such as choosing to display a slideshow or various clock options shown in FIG. 13e. If a slideshow is chosen as the preferred screensaver, the user may be presented in FIG. 13f with various time interval options which can be selected for the time interval an image would be displayed on screen before the image is changed to the next image within the slideshow shown in FIG. 13g. As shown in the other options in FIG. 13f, the user may be presented with options to use their own images which can be loaded into the programmable environmental comfort controller 10 or theme images already programmed into the programmable environmental comfort controller 10. Furthermore, a user may be able to choose whether a clock and/or information from the home screen, such as temperature, will be displayed during the period of time a screensaver is displayed. In FIG. 13h, the user may also be presented with the option to preview their screensaver choices at the touch of a virtual button. This enables the user to view their screensaver, FIG. 13i, without having to wait the amount of time set before the screensaver appears and, also, when the user is finished viewing the screensaver, the user is returned to a settings screen where they can exit or additional changes can be made to the settings.

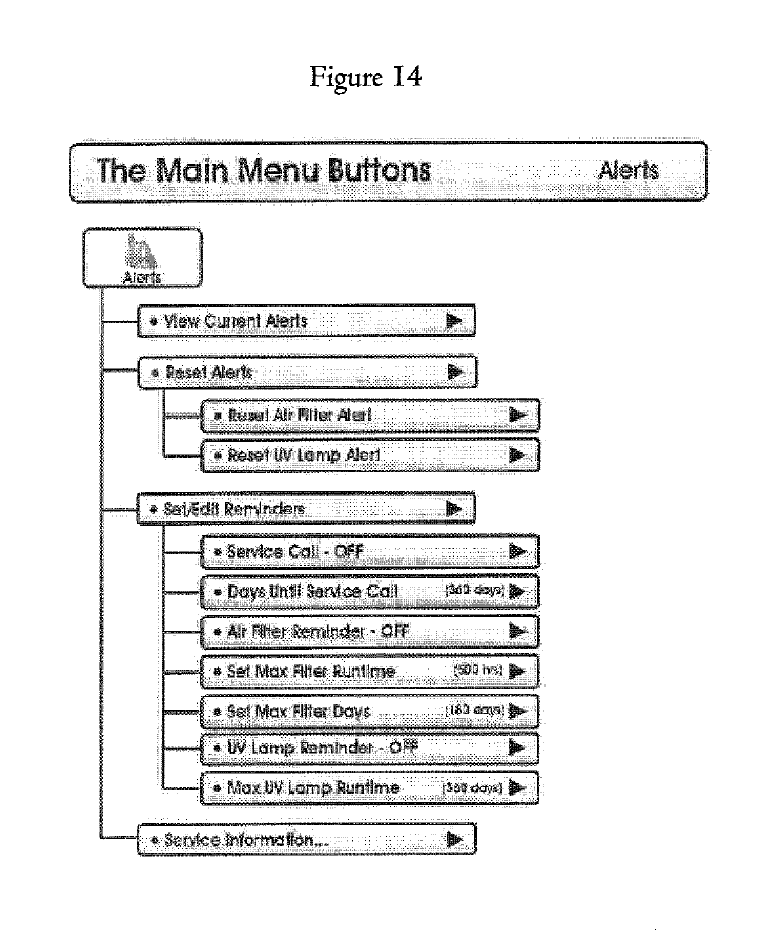

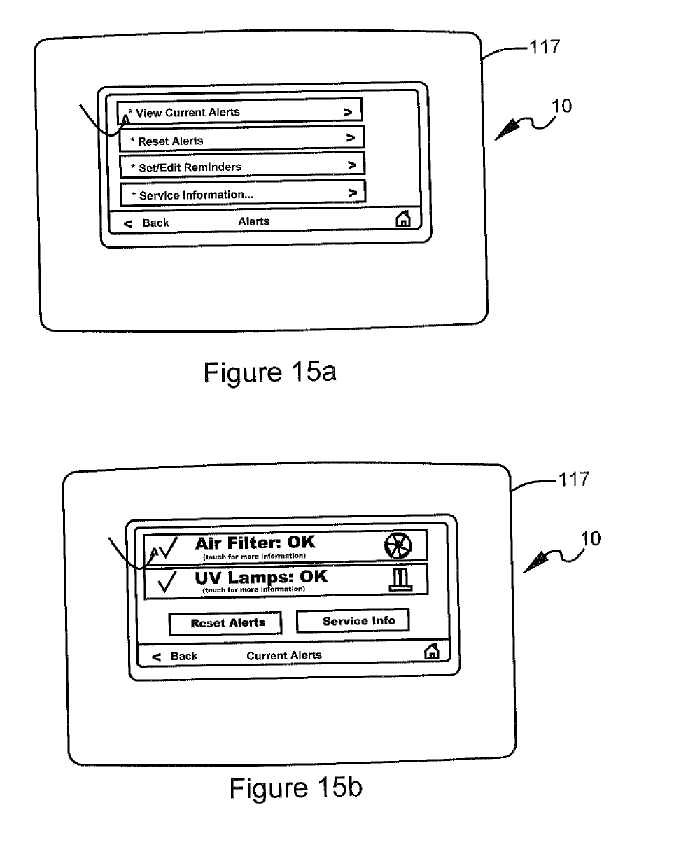

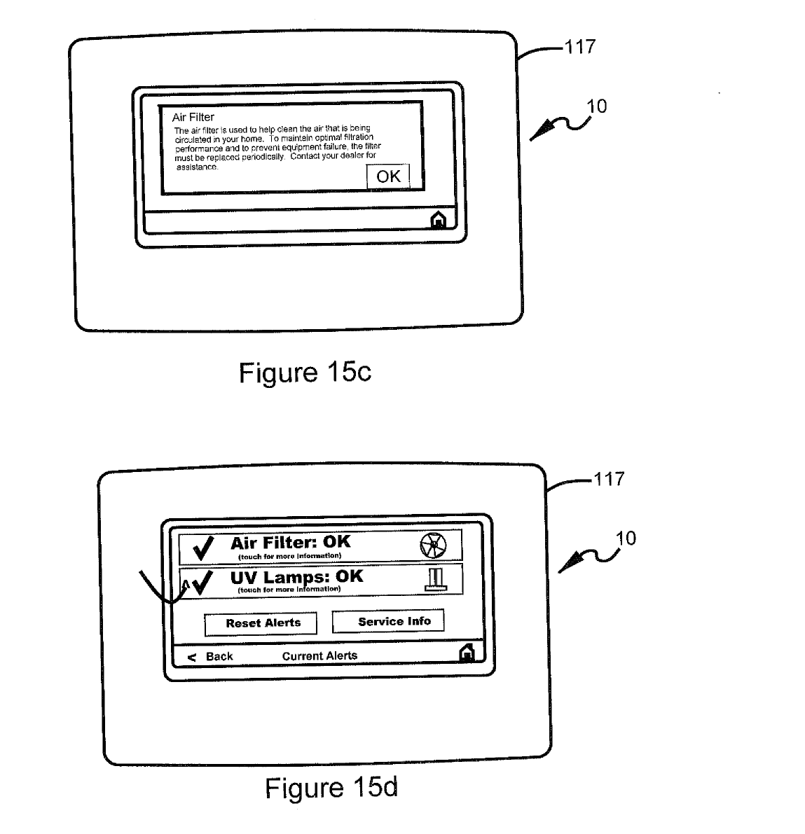

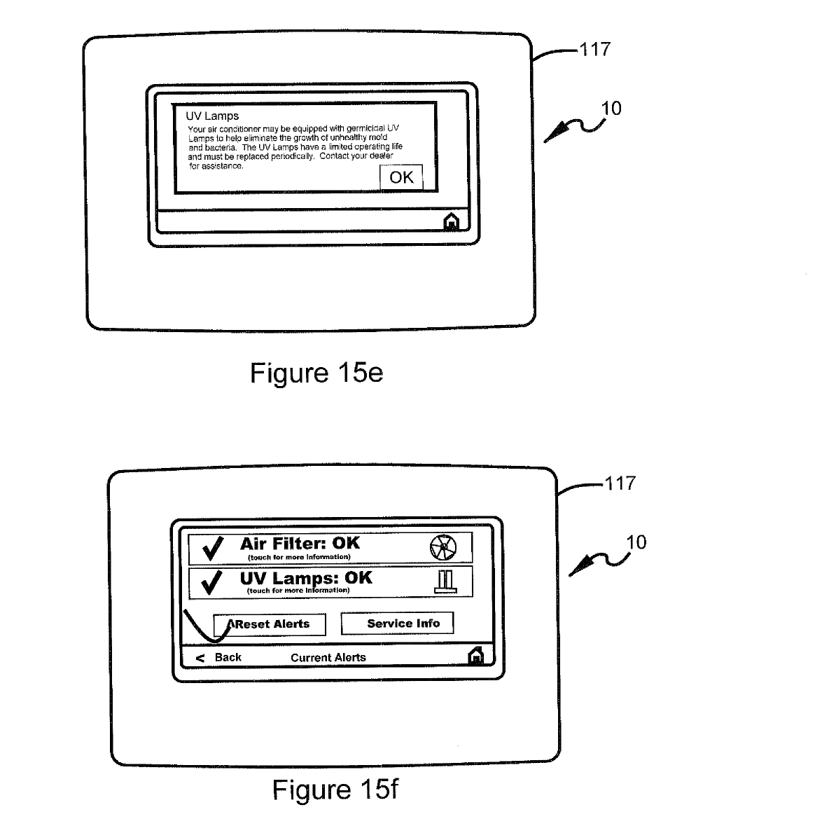

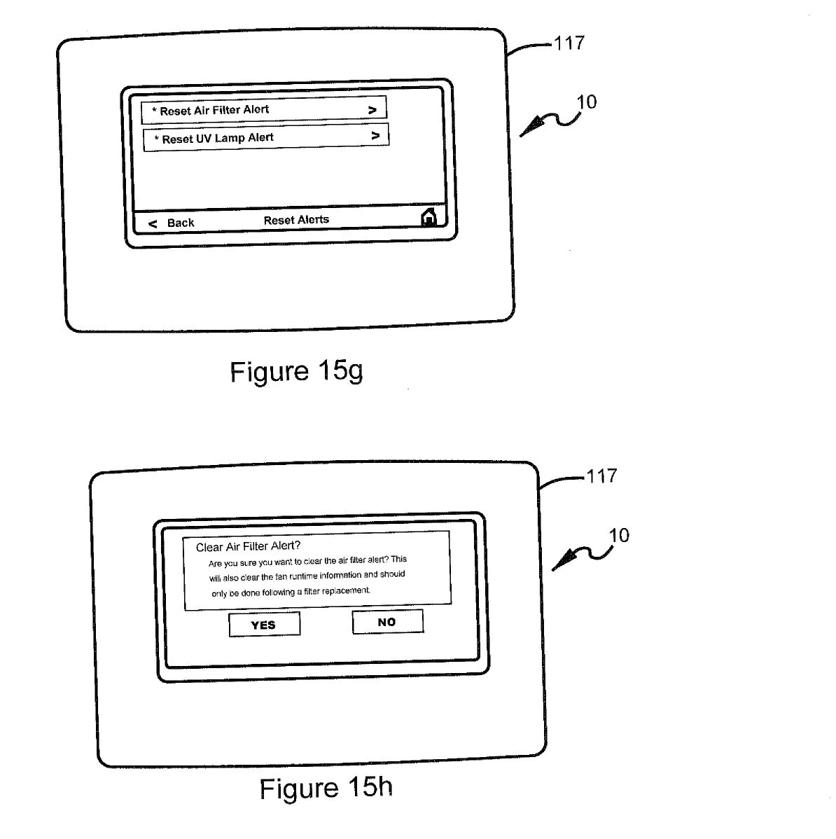

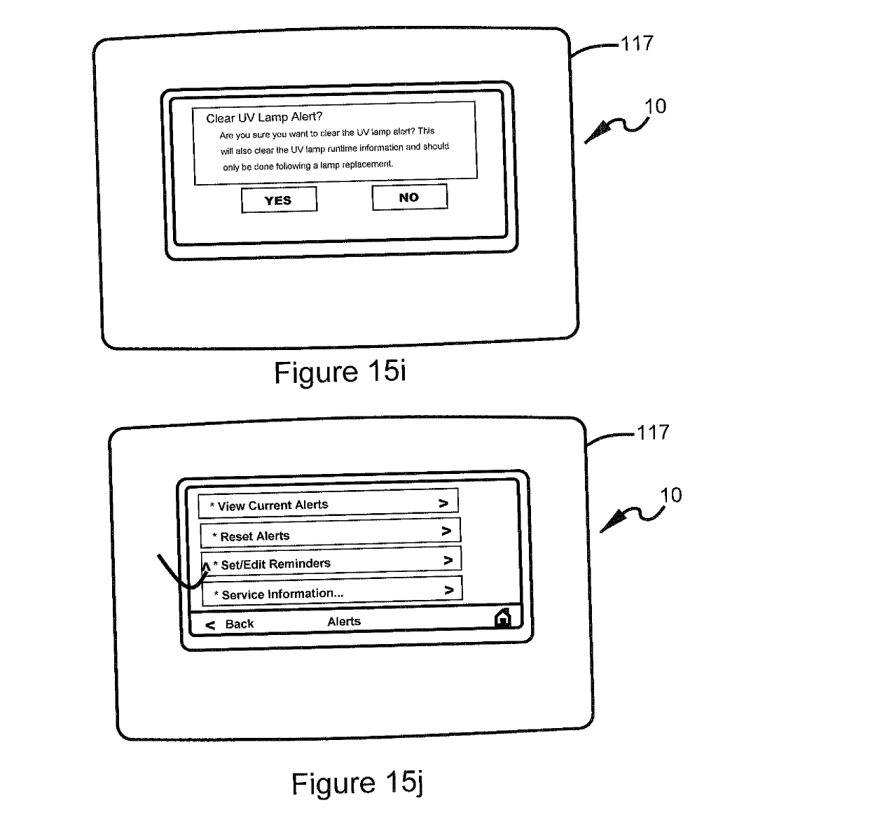

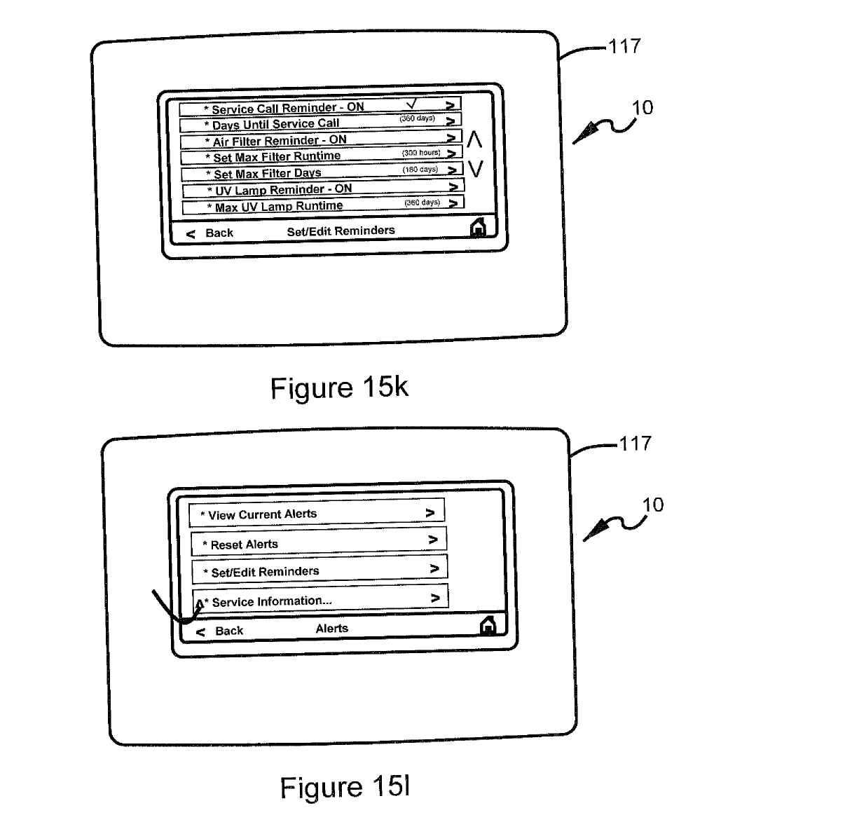

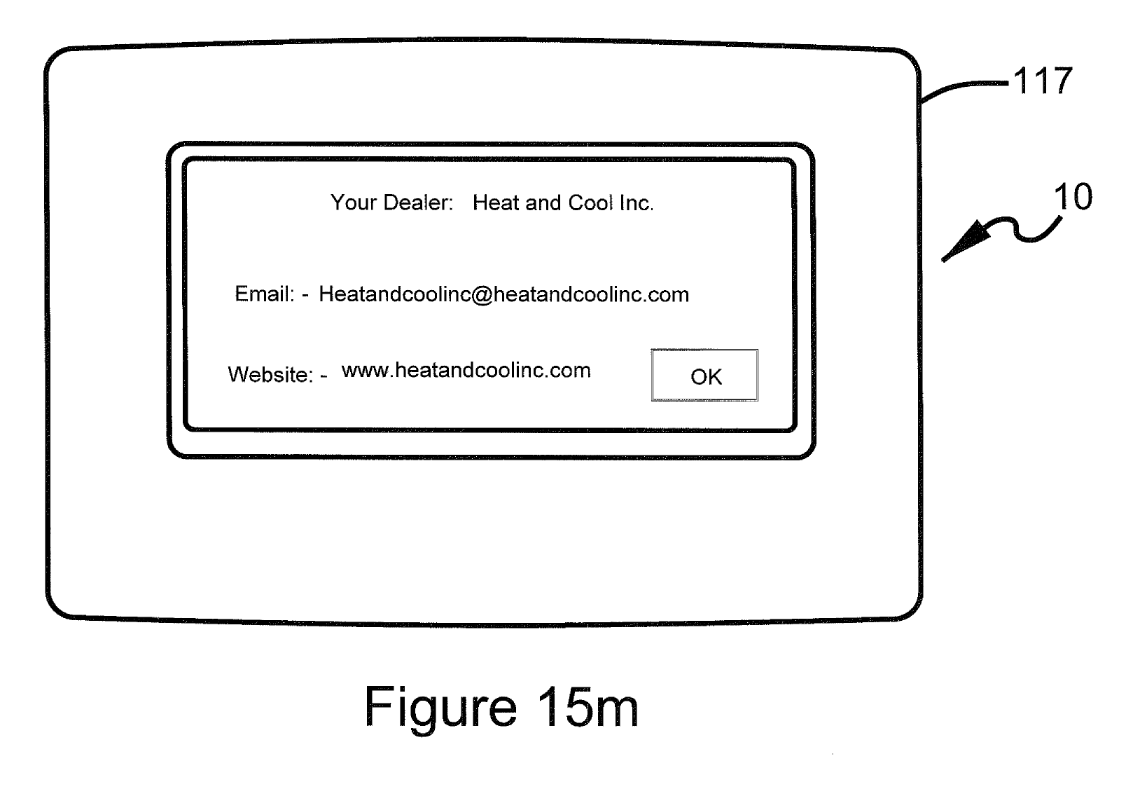

In a preferred embodiment, the virtual buttons displayed after touching menu button 132 at step 230 and viewing the menu page at step 320 may include an alerts virtual button 416. A user, by touching alerts 416 at step 316, may be brought to a screen of options, FIG. 15a and further explained in the flowchart of FIG. 14, relating to the programming of alerts such as those relating to the maintenance of components within the HVAC system. Alerts may be set for components such as air filters and ultraviolet (UV) lamps.

As illustrated in FIG. 15a, the user may select an option, “View Current Alerts” which would allow them to view previously set alerts and information relating thereto. For example, by viewing the Alerts, the user would be brought to a screen, FIG. 15b, which allows the user to view their Air Filter as well as UV Lamp alerts. By choosing to view more information relating to the air filter, the user may be brought to a screen such as that in FIG. 15c. If the user chose to view more information relating to their UV lamps in FIG. 15d, the user would be brought to a screen, 15e. Both screens displayed in FIG. 15c and FIG. 15e would provide the user with information about their air filters and lamps.

A user and/or dealer and/or technician may be able to set alerts for various components and/or edit alerts which were previously programmed by following the screens and the options presented therewith in FIGS. 15f-FIGS. 15i For instance, the user may be able to program a reminder alerting them to make a service call by setting a period of time to pass until the alert appears. Likewise, a user and/or dealer and/or technician may set a similar alert reminder for an air filter and/or for an ultraviolet lamp. Furthermore, a user and/or dealer and/or technician may be able to set a maximum time or a maximum amount of days an air filter or UV lamp may run as shown in FIGS. 15j and 15k after which an alert is activated notifying the user that maintenance may need to be performed such as replacing the air filter or ultraviolet lamp. A further option of resetting the alerts may also be presented which would allow a user and/or dealer, and/or technician to reset an alert either at their own discretion or, preferably, after a component has been replaced and the maintenance period begins anew.

Additionally, by selecting “service information” shown in FIG. 15l a user and/or dealer and/or technician may be able to program service information such as the name of the dealer, the email of the dealer, and/or the website of the dealer into the programmable environmental comfort controller 10 shown in FIG. 15m This feature would allow a user to quickly reference pertinent information for maintenance issues and questions, troubleshooting, or a source to look up features and information relating to their programmable environmental comfort controller 10 without having to keep a filed or written record of such information which may be difficult to find.

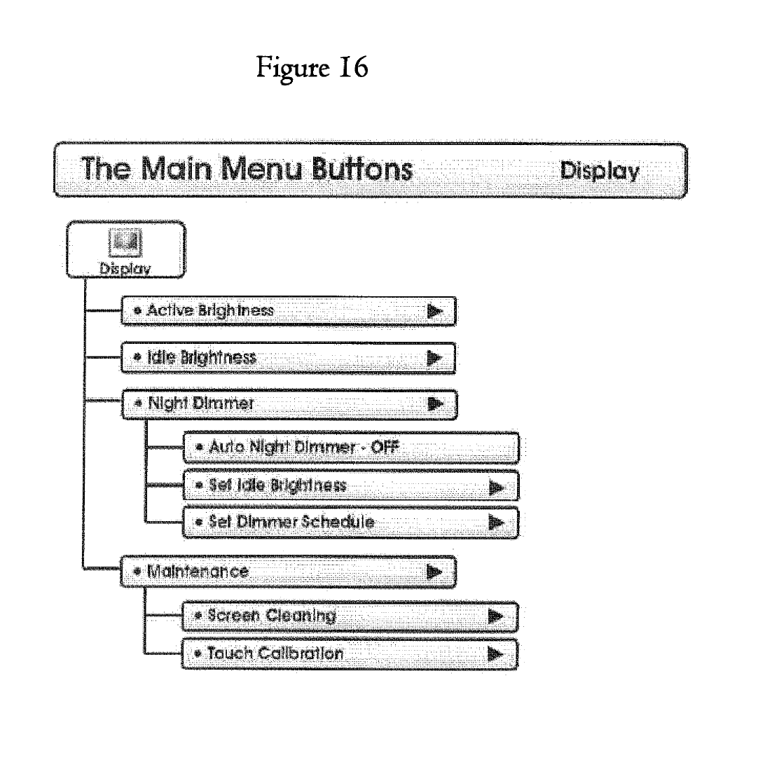

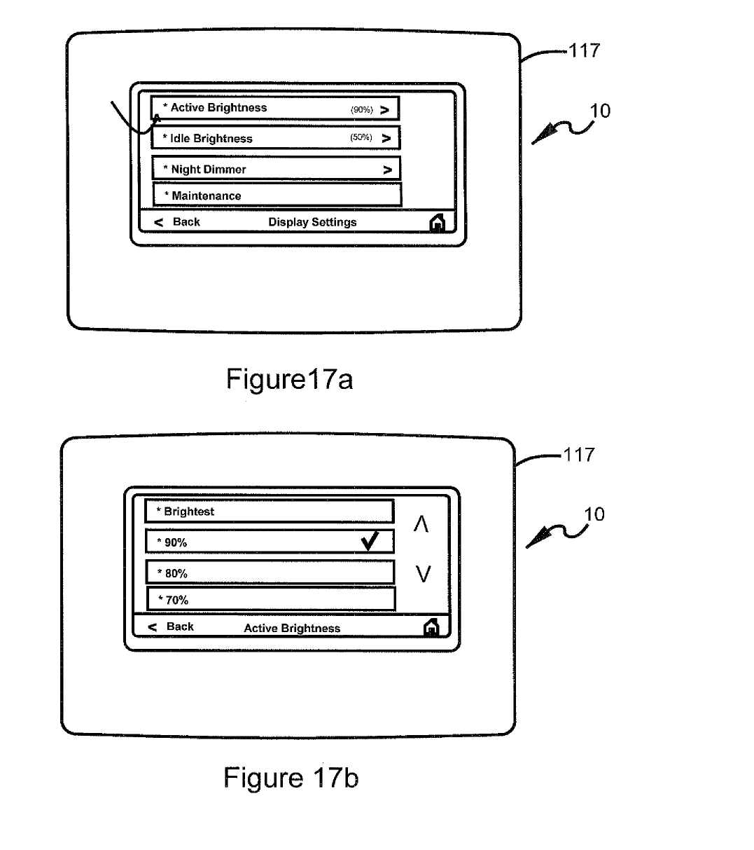

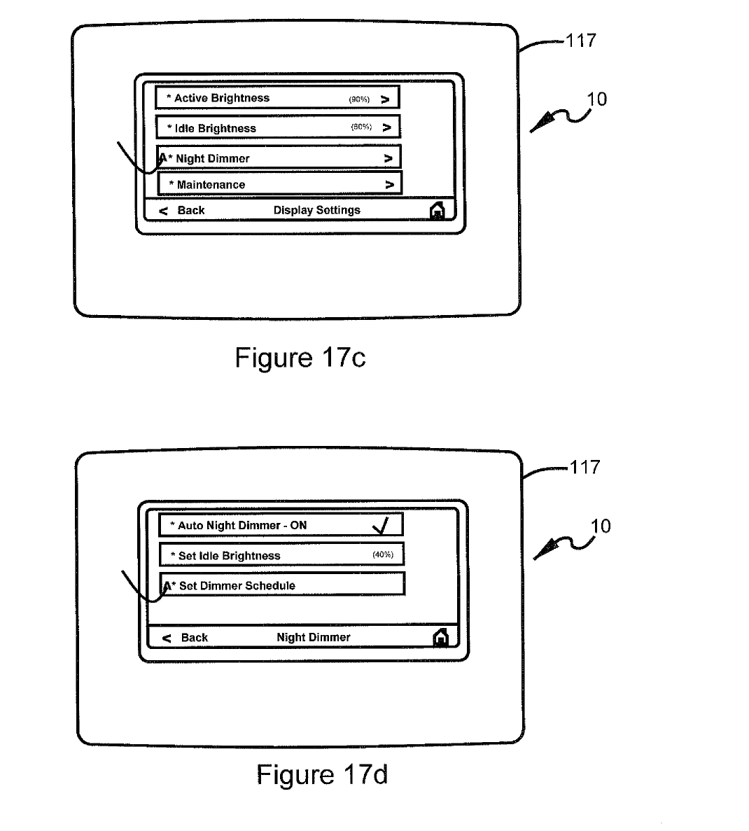

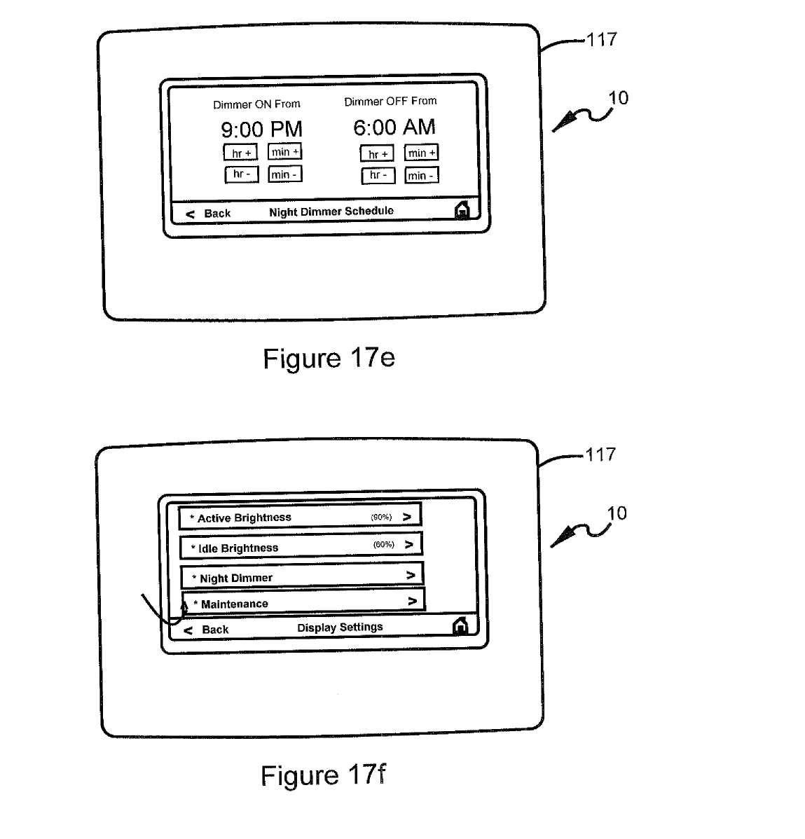

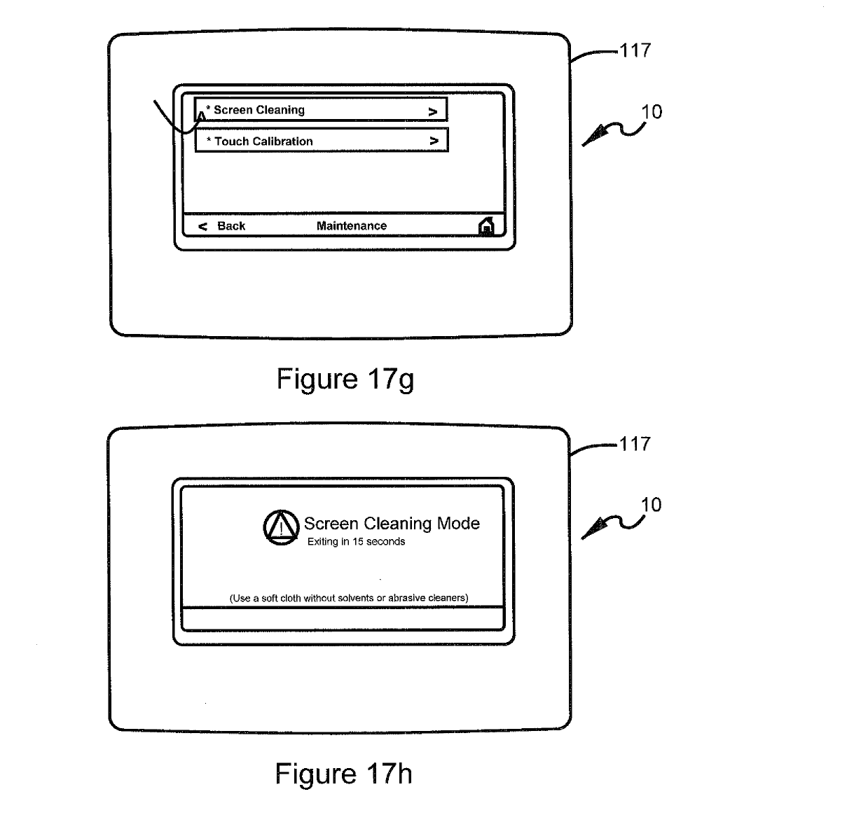

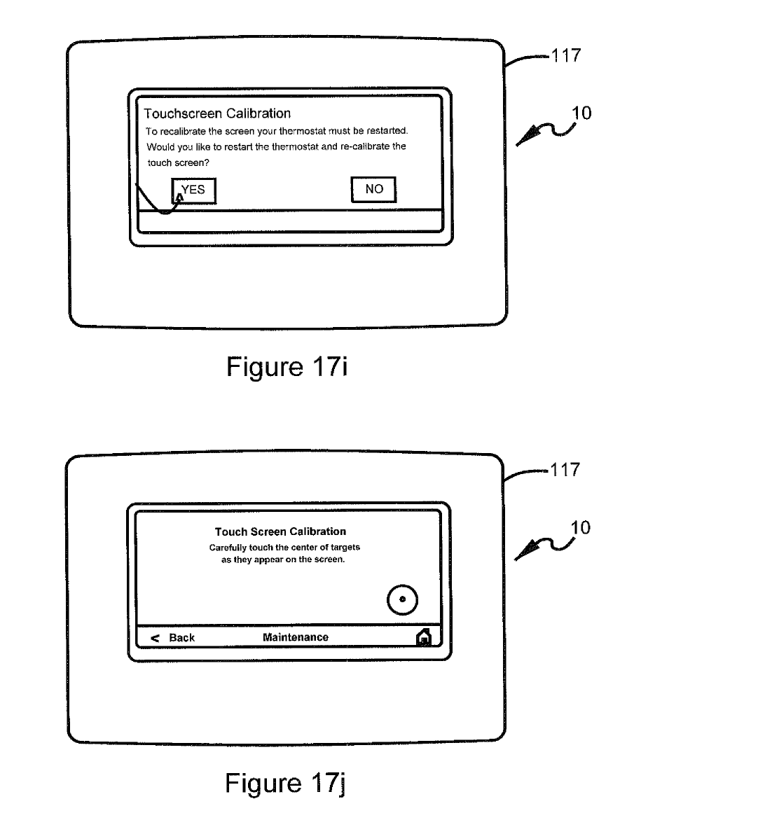

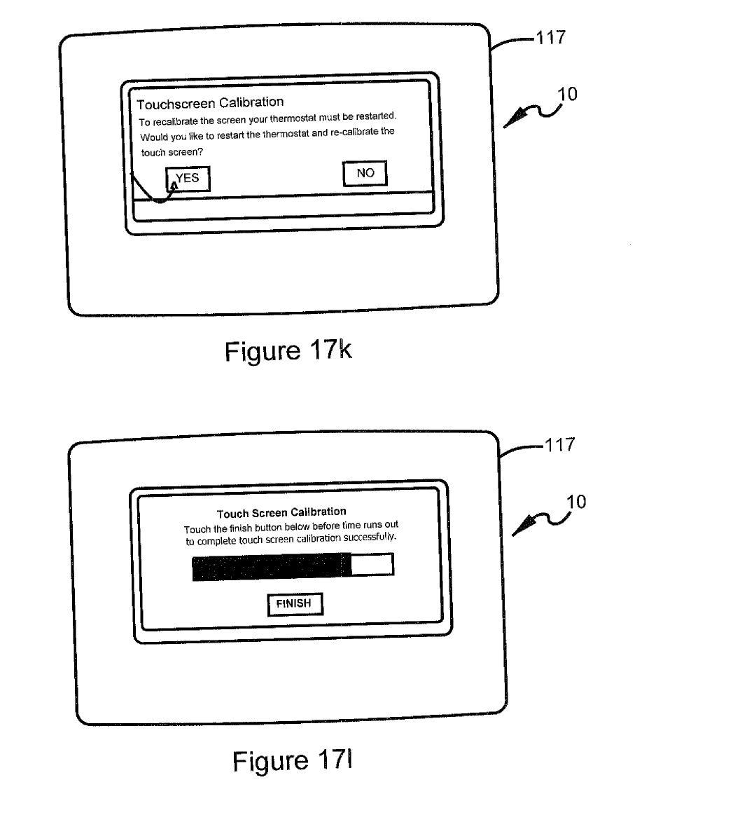

In a preferred embodiment, the virtual buttons displayed after touching menu button 132 at step 230 and viewing the menu page at step 320 may include a display virtual button 418. A user, by touching display 418 at step 314, may be brought to a screen of options shown in FIG. 17a and explained in the flowchart of FIG. 16 relating to the programming of display settings on the programmable environmental comfort controller 10.

Various options under display virtual button 418 are illustrated in FIGS. 17a-17l. For instance, a user may be able to change the brightness of the display by changing the amount of power to backlight LED's for displays of programmable environmental comfort controller 10 shown in FIG. 17a. In FIGS. 17b and 17c, the user may change the brightness for when the programmable environmental comfort controller 10 is active by the user interacting with the programmable environmental comfort controller 10 or to a reduced level when idle respectively. Typically, it is envisioned that the user may wish to make the “idle brightness” less than the brightness of when the display is being interacted with to create a dimming effect characteristic of many electrical devices such as a telephone or computer which would lower the brightness after a predetermined amount of time passes. The brightness which will backlight LED's will operate when the control program detects that a user has touched touch screen 28 within a predetermined time period. After said time period, a level of idle brightness will be imposed on the backlight LED's. This embodiment dramatically lengthens the life of the backlight LED's while imperceptibly reducing back light during non-interactive periods with the thermostat. As a user toggles through any of the subscreens of the menu, text is displayed on the screen to indicate the title of the current screen they are on.

Furthermore, a user may choose in FIG. 17d to program a dimmer schedule where the brightness of the display is reduced by an amount chosen by the user during a specific period of time. For instance, the user may choose to dim the display at night by activating a night dimmer with only a 20% display brightness from 10:00 pm through 8:00 am as shown in FIG. 17e. A user may choose this option if the programmable environmental comfort controller 10 is in their bedroom and they wish to eliminate excess light while leaving the programmable environmental comfort controller 10 visible. Contrarily, a user has the option of leaving the display bright or only dimming the display slightly if the user wishes to use the programmable environmental comfort controller 10 as a “nightlight” such as that in a child's room. Ideally, as a user touches various display brightness options in any one of the settings explained above, the display would exhibit the selected brightness to allow the user to easily compare and choose between different options by visually seeing a difference.

A user may also be able to control various options relating to the maintenance of the programmable environmental comfort controller 10 itself shown in FIG. 17f. For instance, a user may have a “screen cleaning” option, FIG. 17g, where the screen may display a pre-programmed screen, FIG. 17h, allowing the user to clean the touch screen without changing settings for a set period of time which is displayed to the user. This option allows the user to clean the screen for a short period of time. A user may press the screen cleaning option which activates a fifteen second period of time where the user may use a cloth to clean the screen and at the expiration of such time, the user is returned to the menu where they can either select additional screen cleaning time or other options. Additionally, the user may be able to calibrate the programmable environmental comfort controller touch screen by selecting a touch calibration button. The recalibration may involve restarting the programmable environmental comfort controller 10 as shown in FIG. 17i and/or presenting targets or symbols to the user for the user to touch, FIG. 17j-17l, to calibrate the touch screen with the programmable environmental comfort controller and ensure appropriate registration of commands “touched” on the screen with various touch zones and virtual buttons which is well known in the art of touch screens.

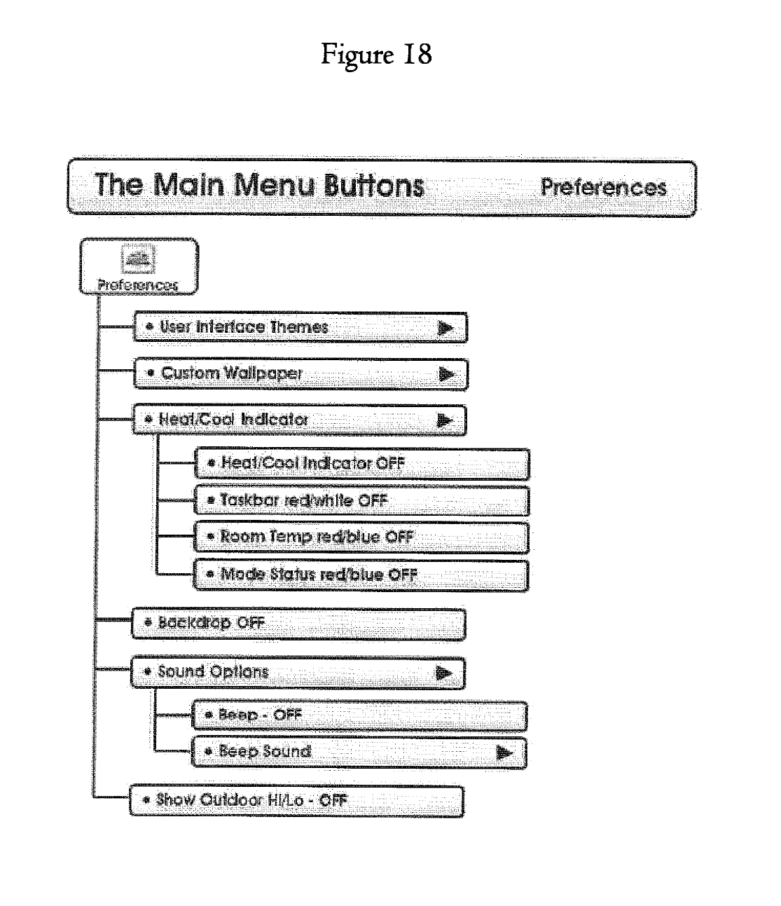

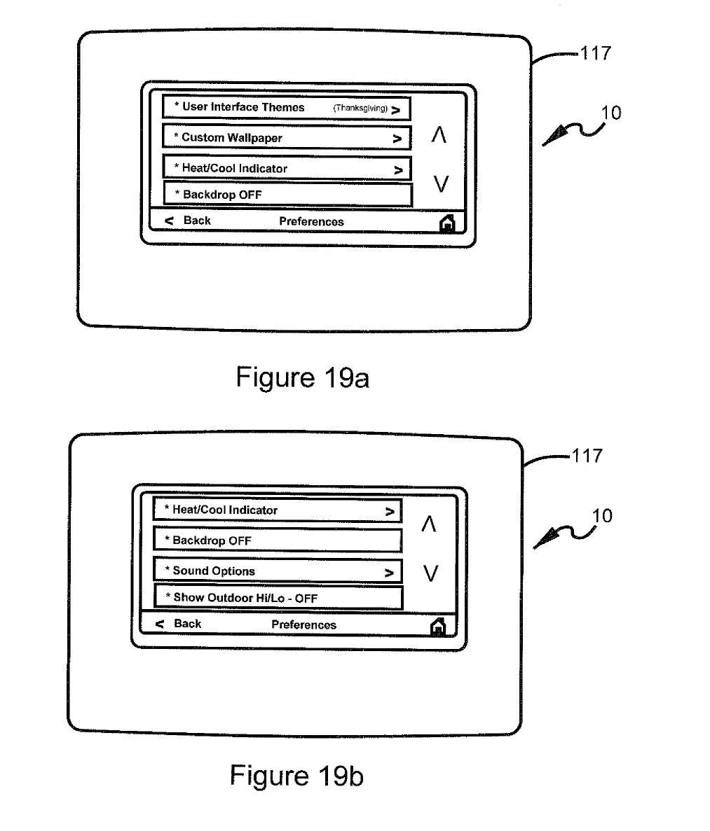

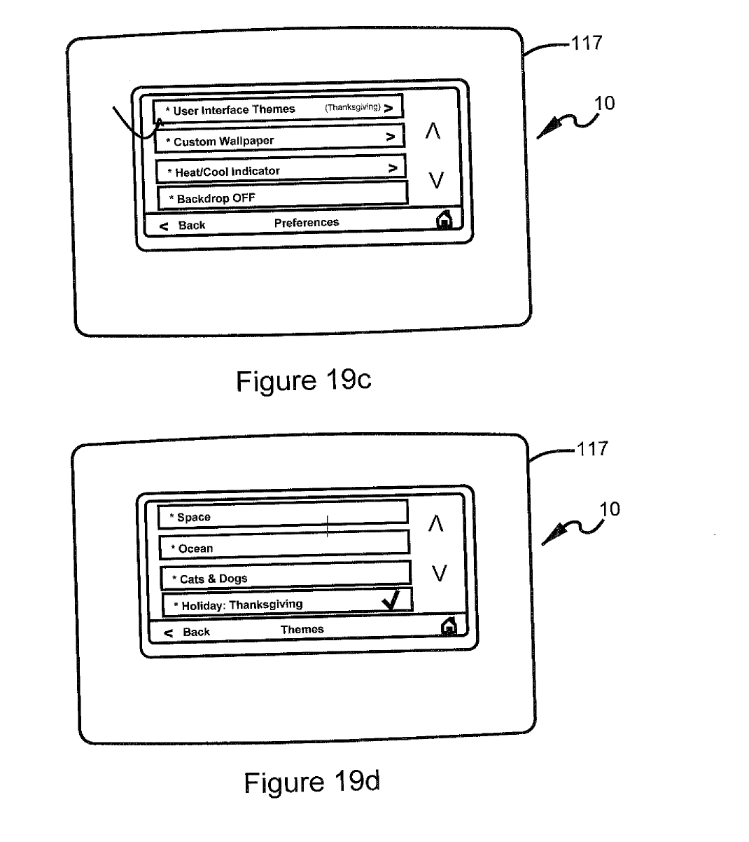

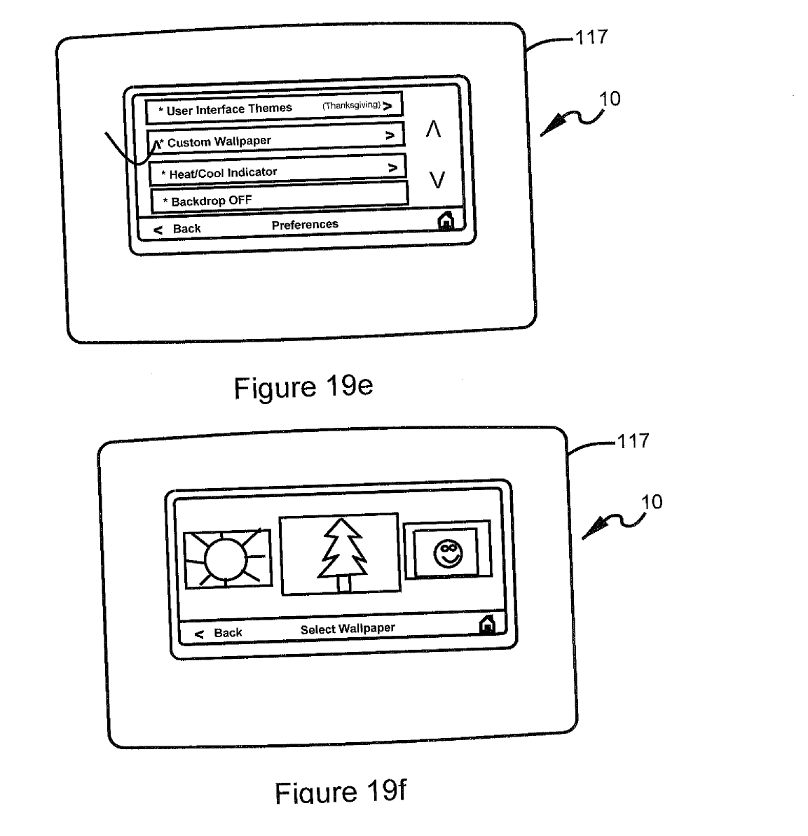

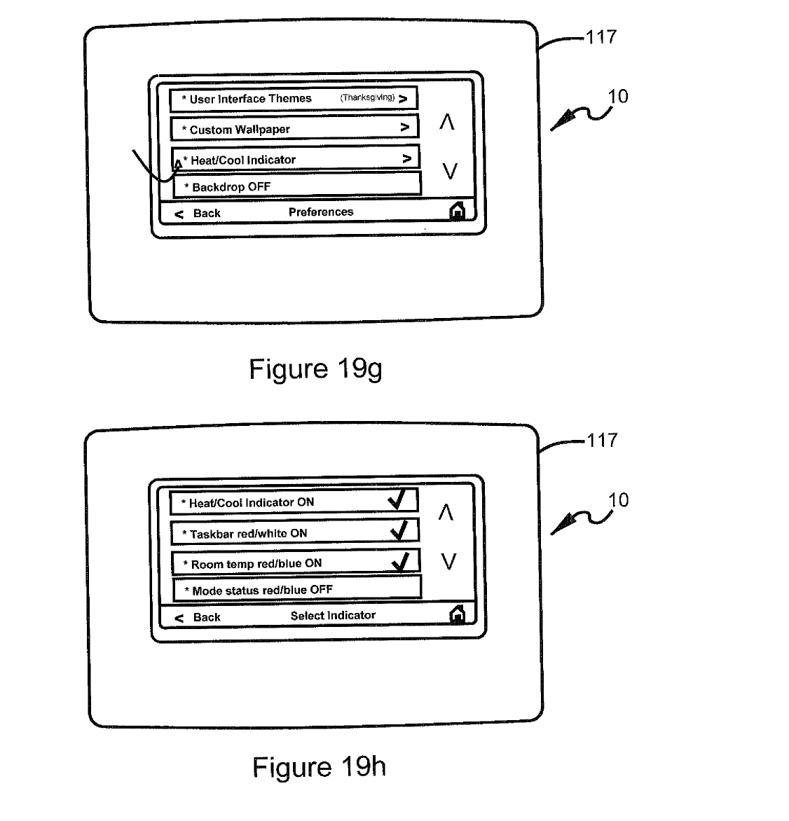

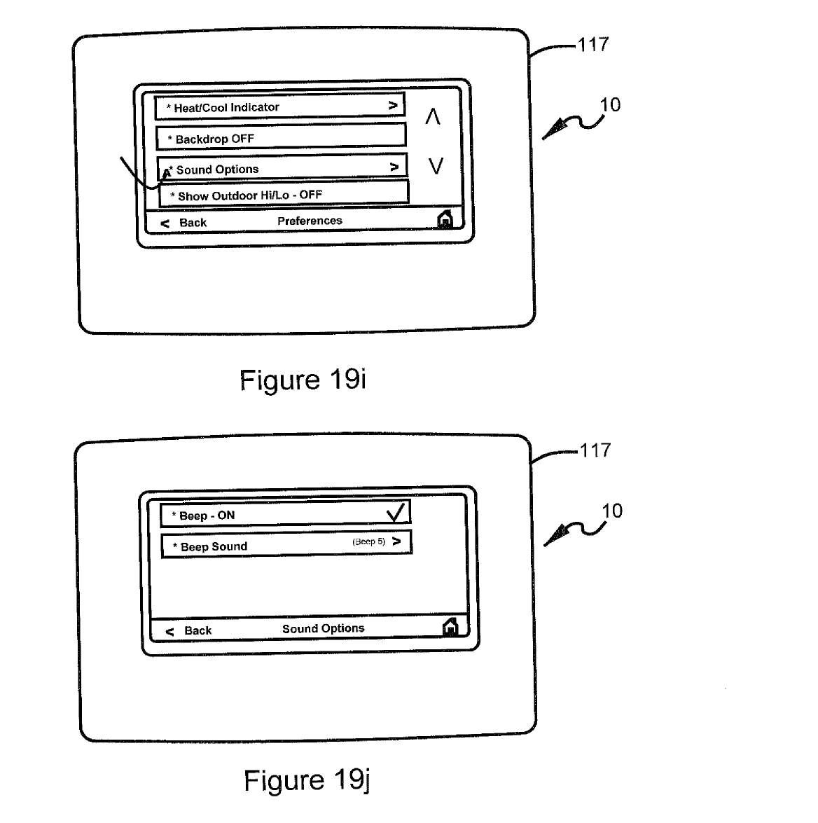

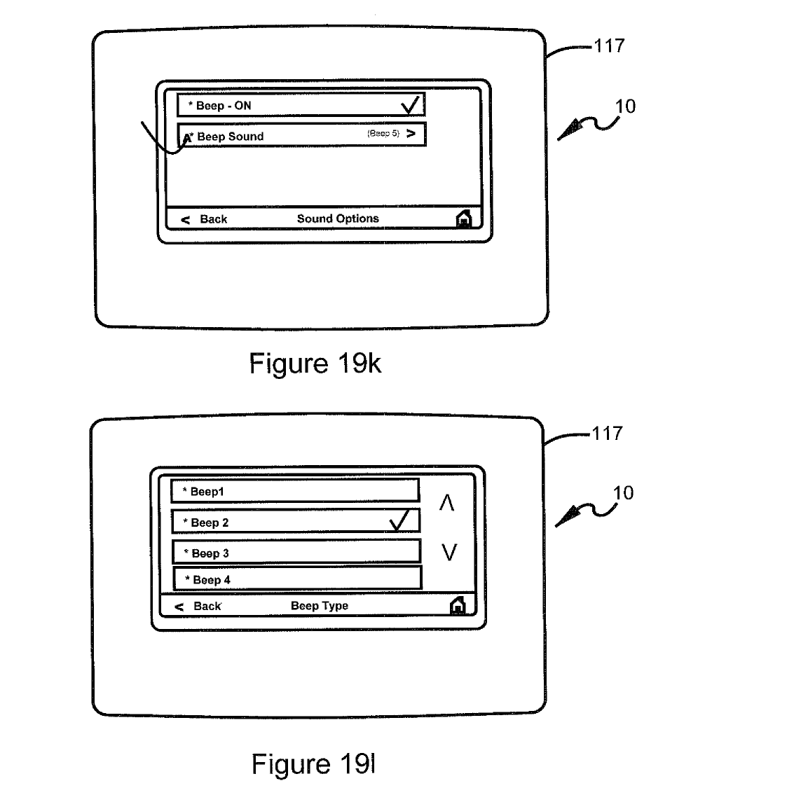

In a preferred embodiment, the virtual buttons displayed after touching menu button 132 at step 230 and viewing the menu page at step 320 may include a preferences virtual button 420. A user, by touching preferences virtual button 420 at step 328, may be brought to a screen of options, FIGS. 19a and 19b which are moved between by the up and down arrows off to the side of the options further explained in FIG. 18, relating to visual and auditory preferences on the programmable environmental comfort controller 10.

Various options are shown in FIGS. 19a-19l For instance, a user may be able to change the user interface themes (the home screen wallpaper) to preset options ranging from landscape scenes to holiday themed screens by selecting “user interface themes” in FIG. 19c and their desired image selection as shown in FIG. 19d. The user may also choose to upload images to the programmable environmental comfort controller to set as custom home screen wallpaper by selecting “custom wallpaper” in FIGS. 19e-19f.

As shown in FIGS. 19g and 19h, the user may choose to activate various indicators such as color indicators which would provide an additional or quick reference to the user for various information such as whether the heating or cooling system is on by changing the color of the taskbar, the room temp, and the mode status. For example, a “Heat/Cool” indicator may be displayed on the home screen in various fashions using color in the following ways: when the heating system is being utilized, the task bar may be red, when the air conditioner is being utilized, the bar may be white, and when neither system is being utilized, the bar may be black. Furthermore, the room temperature display and the mode status display may turn red when the heating system is being used, blue when the air conditioner is being used, or white when neither is being used.

A user may wish to display a backdrop behind the information on the home screen to set the information apart from the home screen wallpaper or make it more easily read by turning a backdrop option ON or OFF as shown in FIG. 19i. This option may create a backdrop behind the information on the home screen in the form of a semi-translucent rectangle which darkens the area in front of which information such as temperature and mode are displayed without completely covering the wallpaper image behind such information.

In FIG. 19i-9j, the user may also be presented with options to have the programmable environmental comfort controller 10 emit a sound, such as a beep, when a virtual button is selected or the option to have no sound. Furthermore, the user may be able to change the sound, sound tone, and/or sound volume by selecting various options which suits their needs or tastes shown in FIGS. 19k-19l.

In a preferred embodiment, a user may view the virtual buttons displayed after touching menu button 132 at step 230 and viewing the menu page at step 320, may touch a down arrow at step 326 allowing the user to view a second menu page at step 334. From the second menu page, a button displayed may include a set time & date virtual button 422.

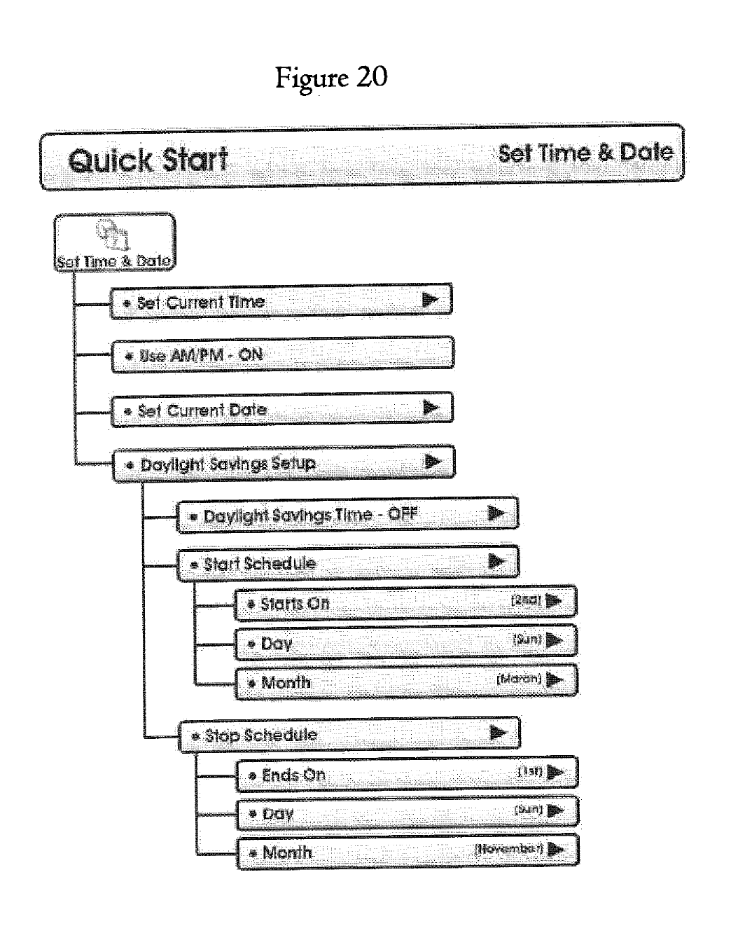

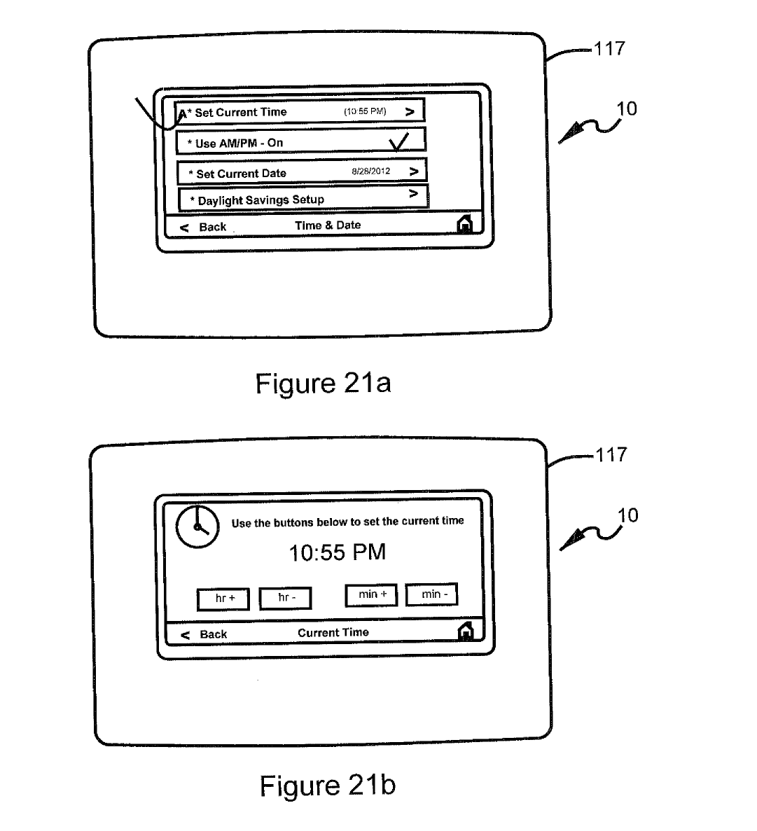

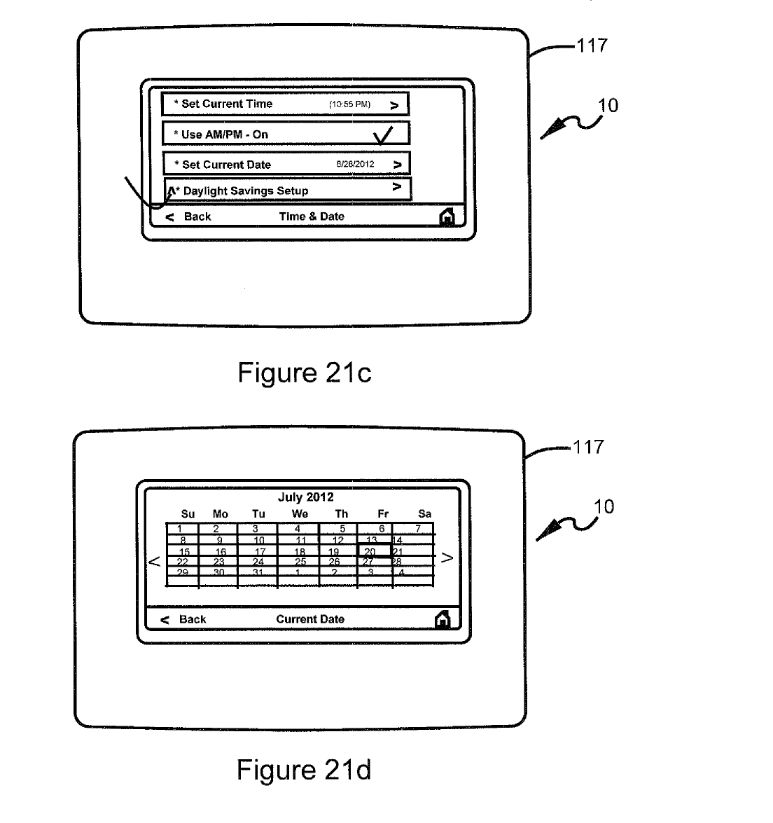

A user, by touching a set time & date virtual button at step 332, may be brought to a screen of options, FIG. 21a, relating to time and date options programmed into and visible on the programmable environmental comfort controller and further explained by the flowchart of FIG. 20. For instance, by making the selection shown in FIGS. 21a and 21b, a user can change the current time displayed on the programmable environmental comfort controller as well as whether they would like this time to be displayed in a different format such as AM/PM form or a 24-hour form (military time). The user may also set the current date in FIG. 21c by choosing the month, date, and year shown in FIG. 21d. Furthermore, the user may choose to activate daylight savings time options by programming when daylight savings time would start and when it would end enabling the programmable environmental comfort controller to automatically adjust the time to the correct time when the time changes without the user having to reprogram the time and/or remember to change the time on the programmable environmental comfort controller 10.

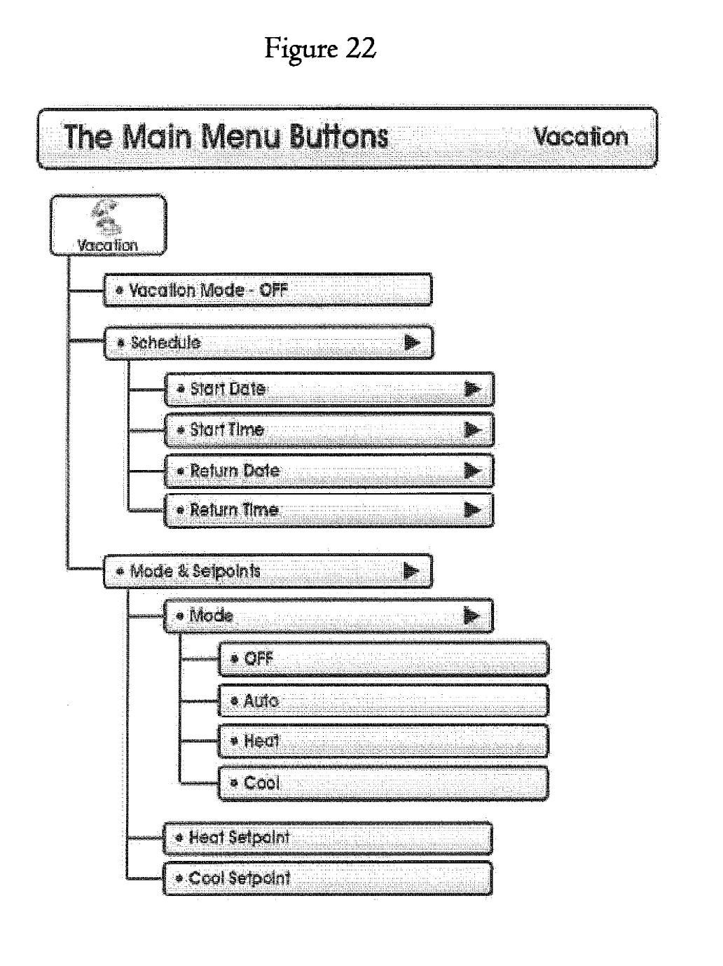

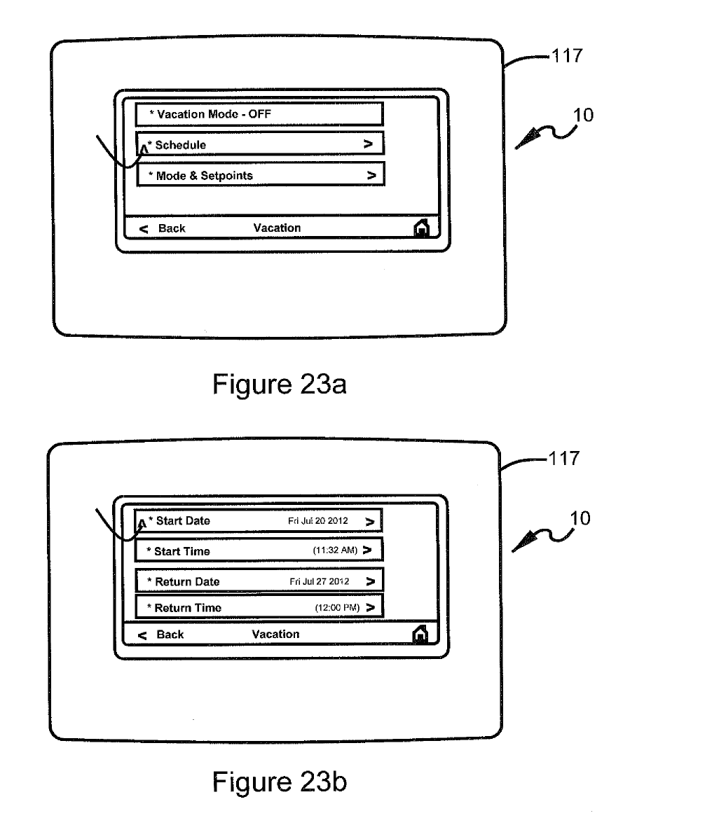

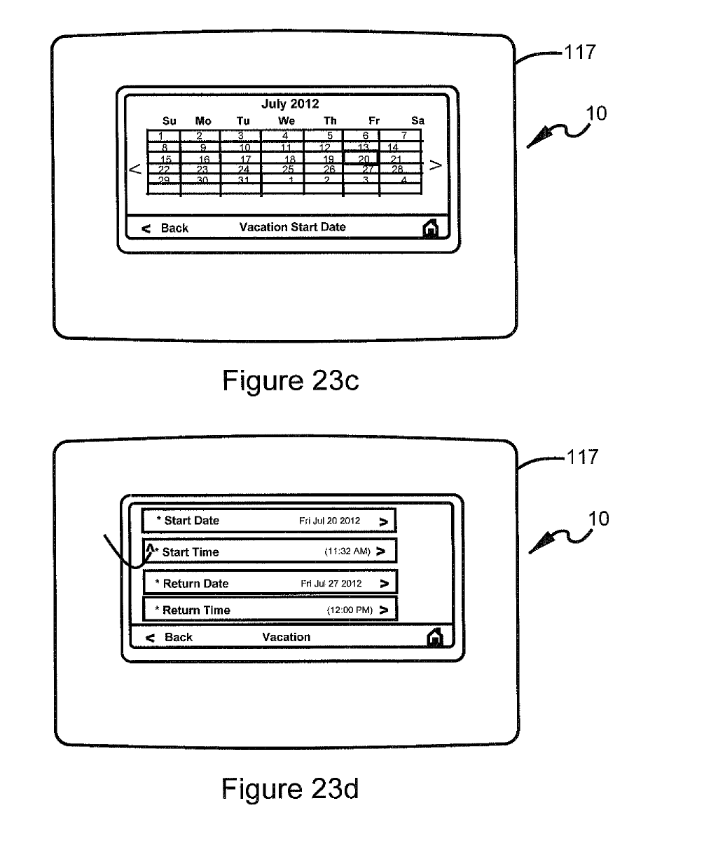

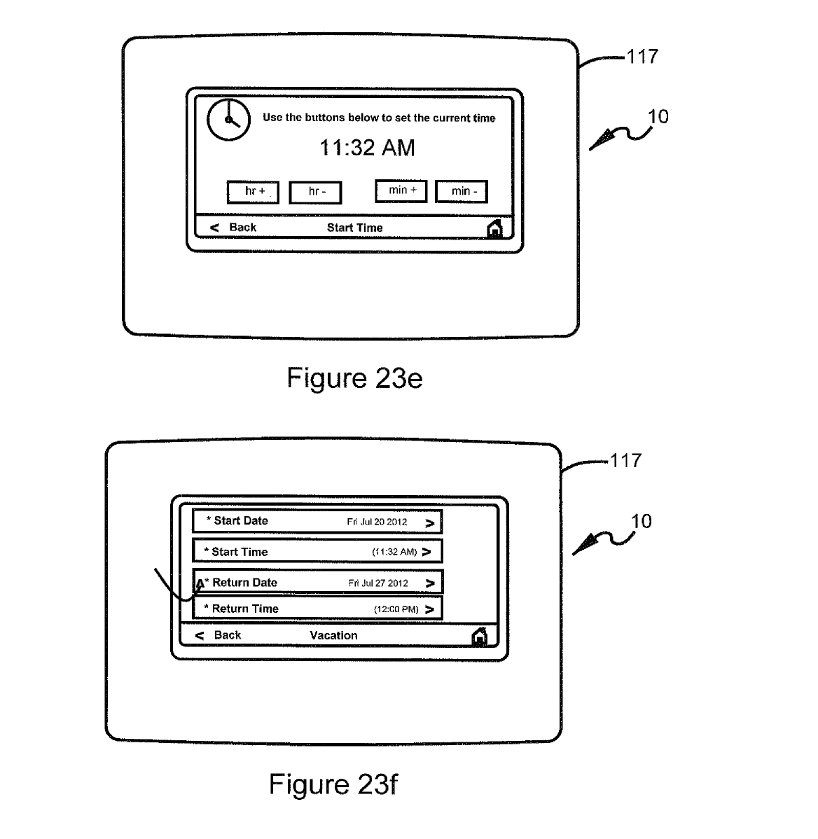

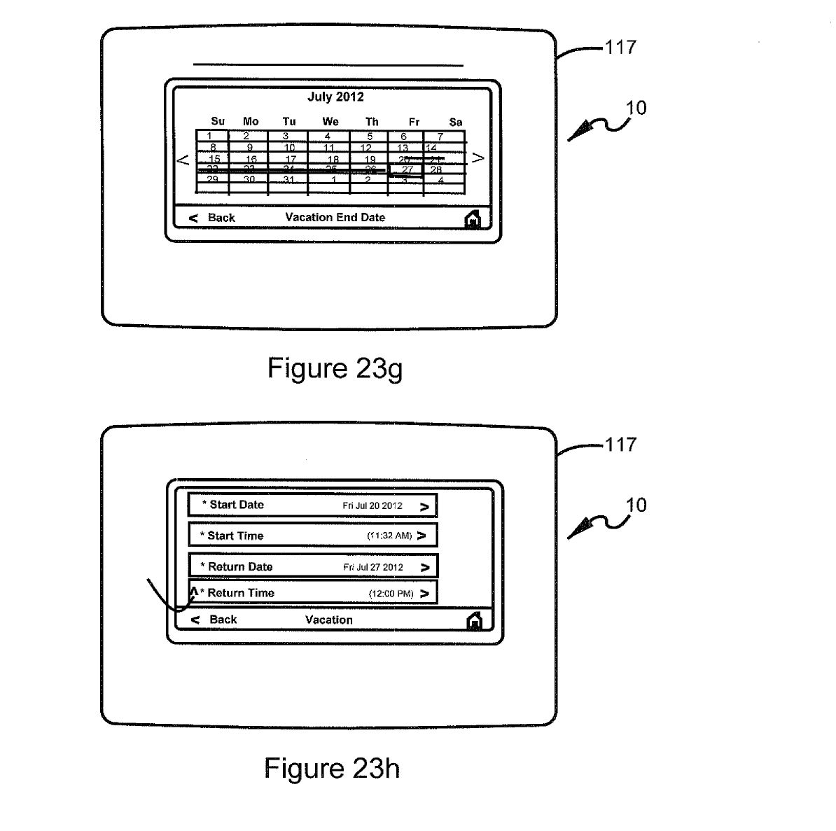

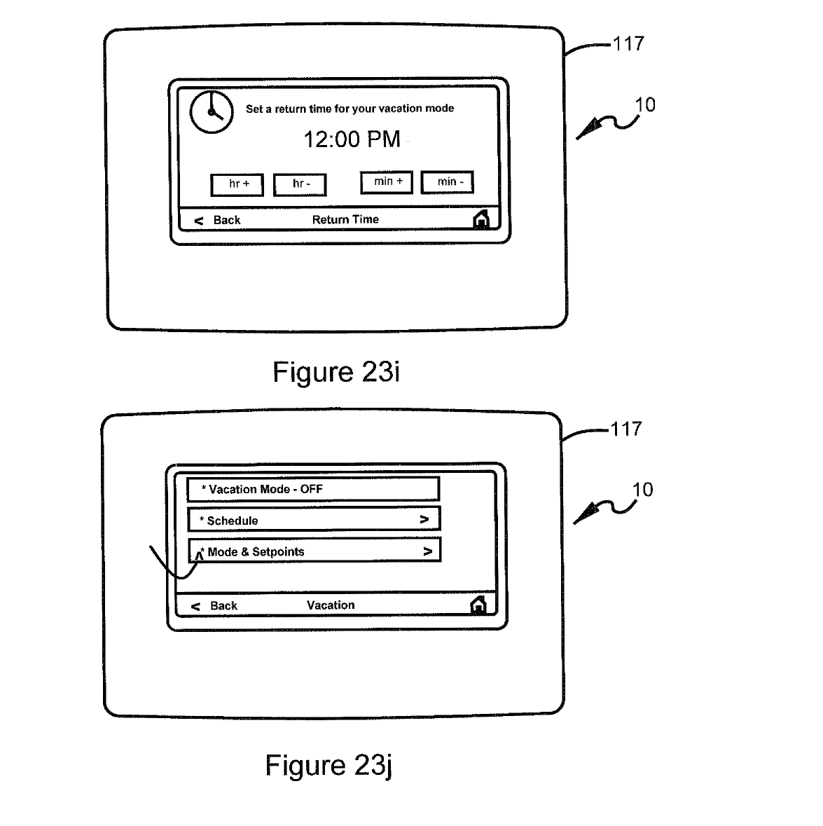

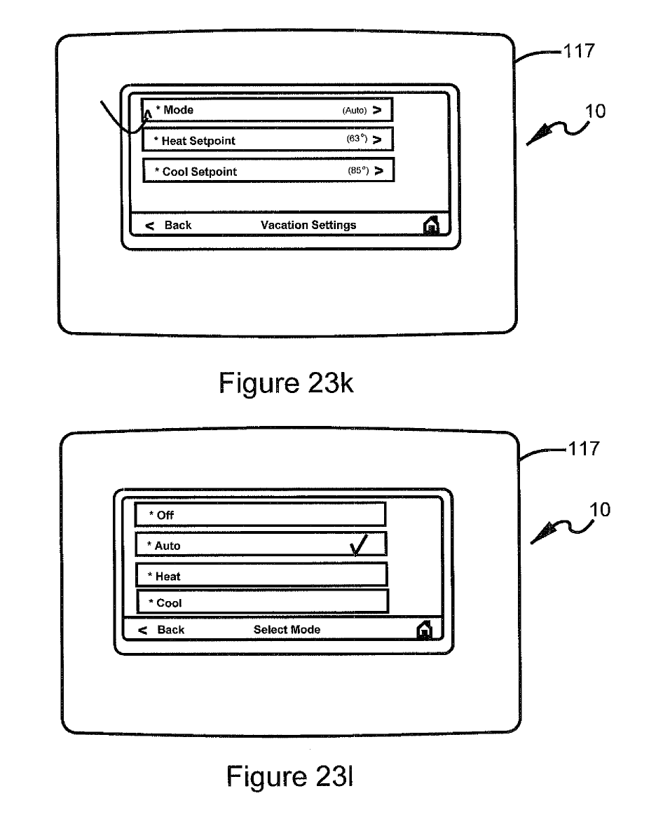

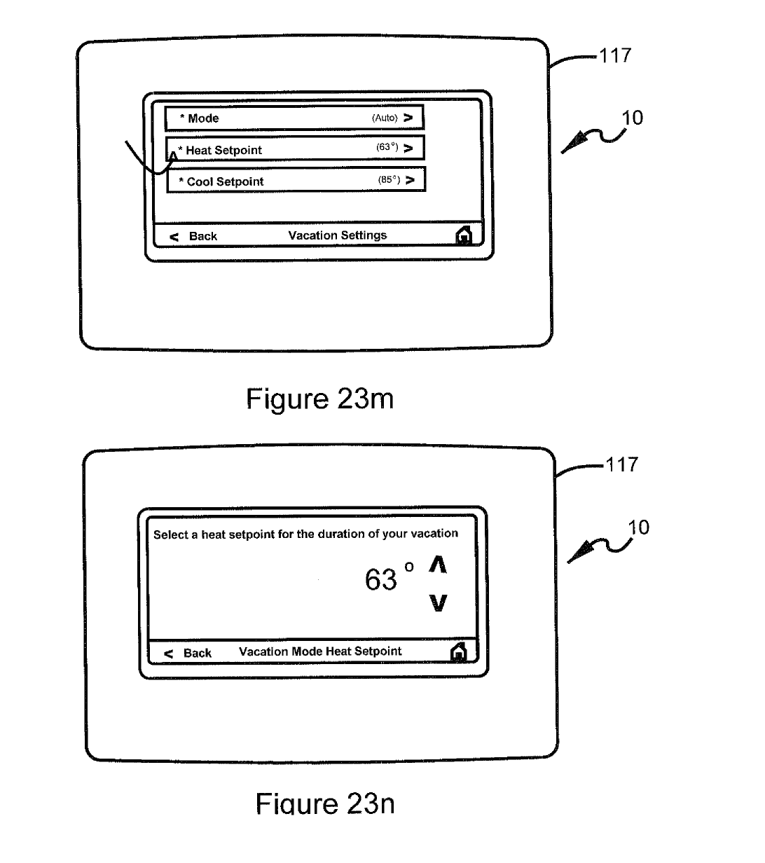

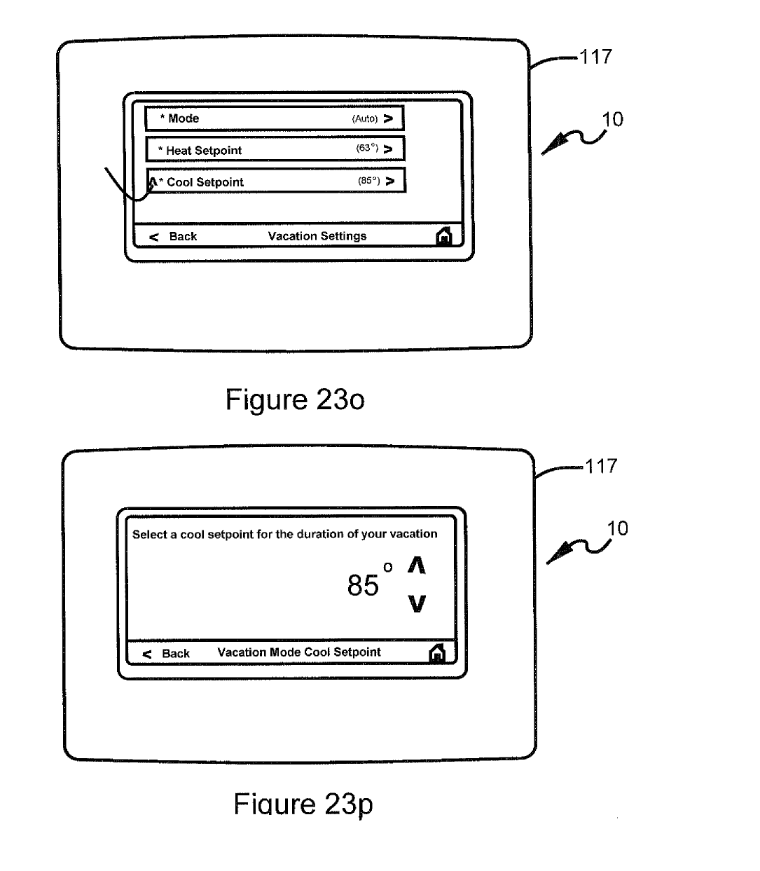

In a preferred embodiment, the virtual buttons displayed after touching menu button 132 at step 230, viewing said menu at step 320, moving to the second page of said menu at step 326 may include a vacation virtual button 424. A user, by touching vacation virtual button 424 at step 336, may be brought to a screen of options, FIG. 23a, relating to the scheduling of settings for while the user wishes to utilize vacation mode as displayed in FIGS. 23a-23f and the flow chart of FIG. 22. For instance, a user may be able to schedule a start date and time for when they wish vacation mode to begin and a return date or time for when they wish vacation mode to end shown in FIG. 23b-23j. Ideally the user is presented with various modes and setpoint options by selecting modes and setpoints shown in FIGS. 23k and 23l, to set the mode they wish the programmable environmental comfort controller 10 to remain in throughout vacation mode such as heat, cool, auto, or off. The user may also be presented with a heat setpoint and/or a cool setpoint, FIGS. 23m-23p, which would set the heating and cooling temperature for the duration of the user's programmed vacation.

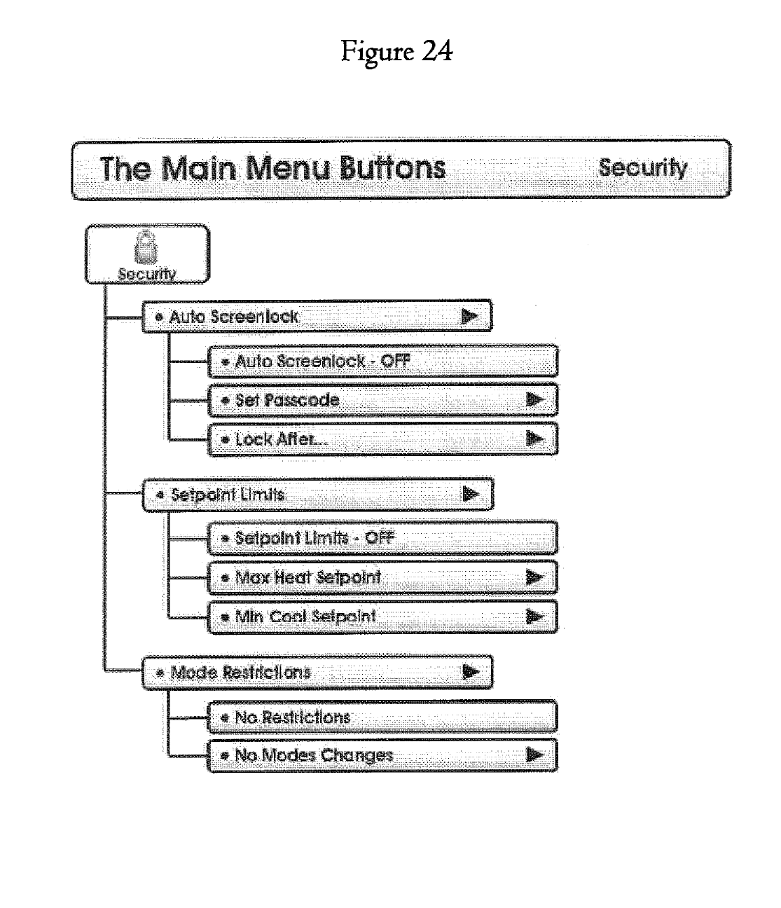

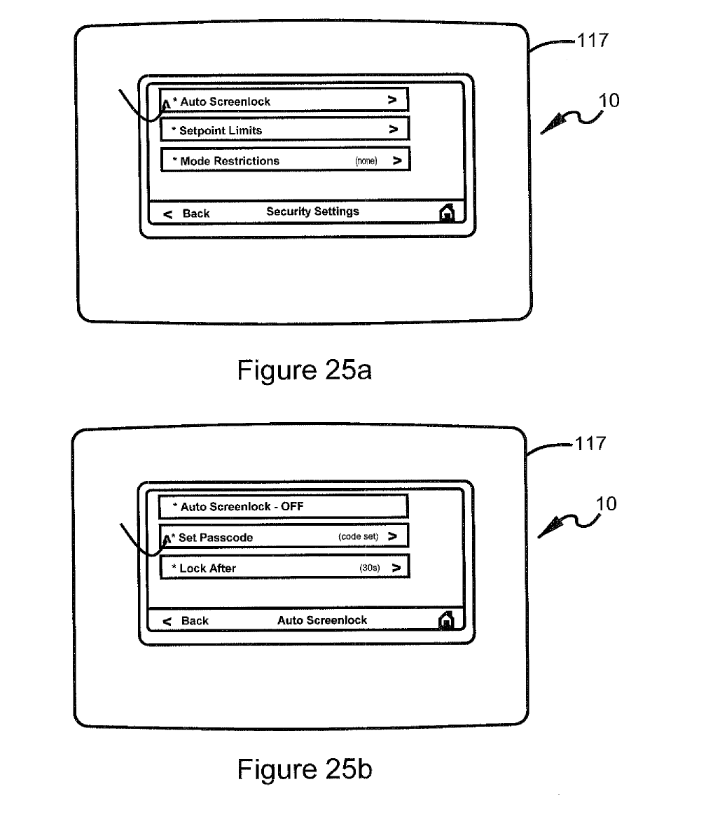

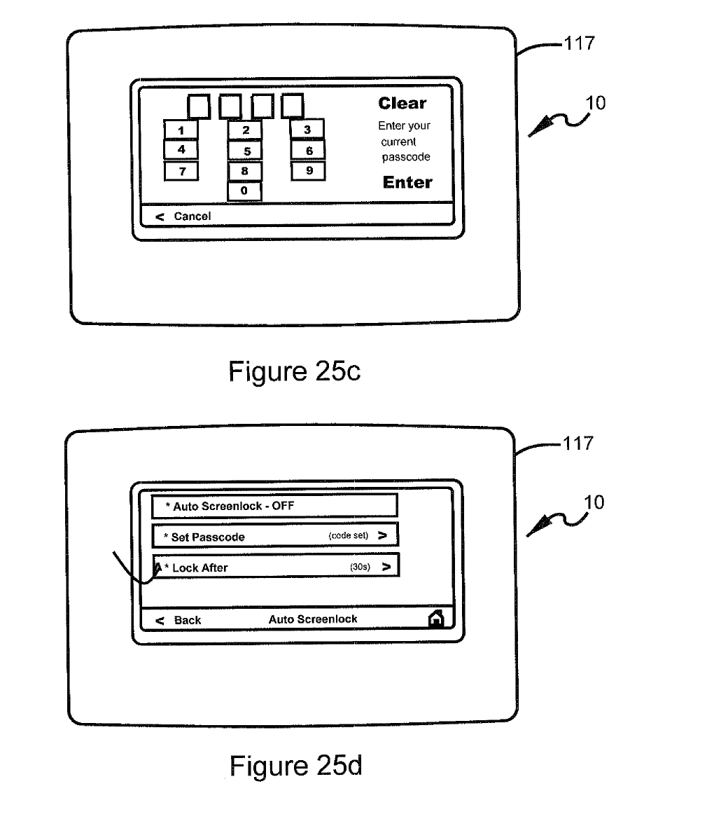

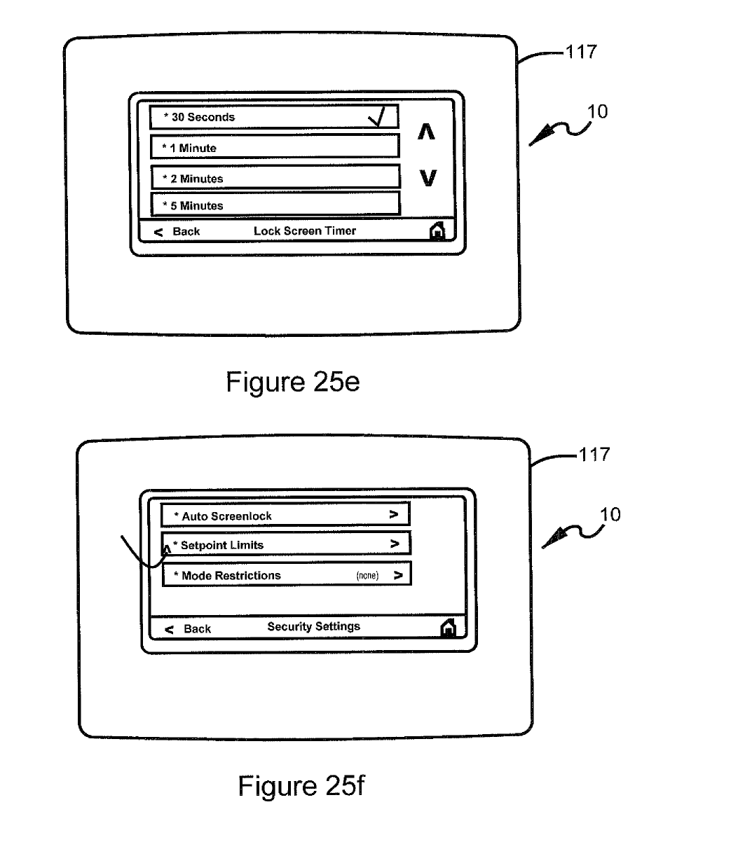

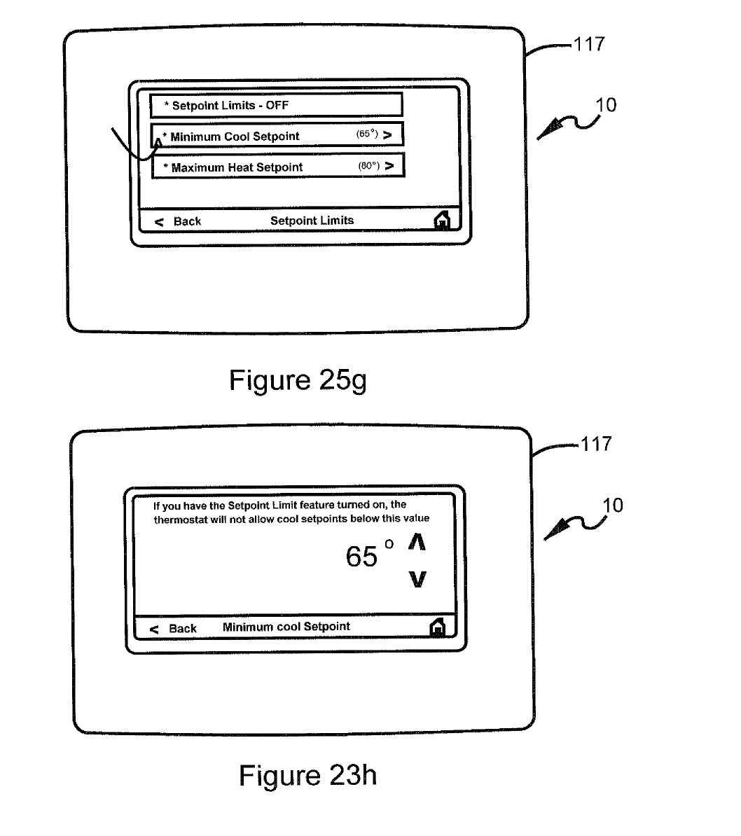

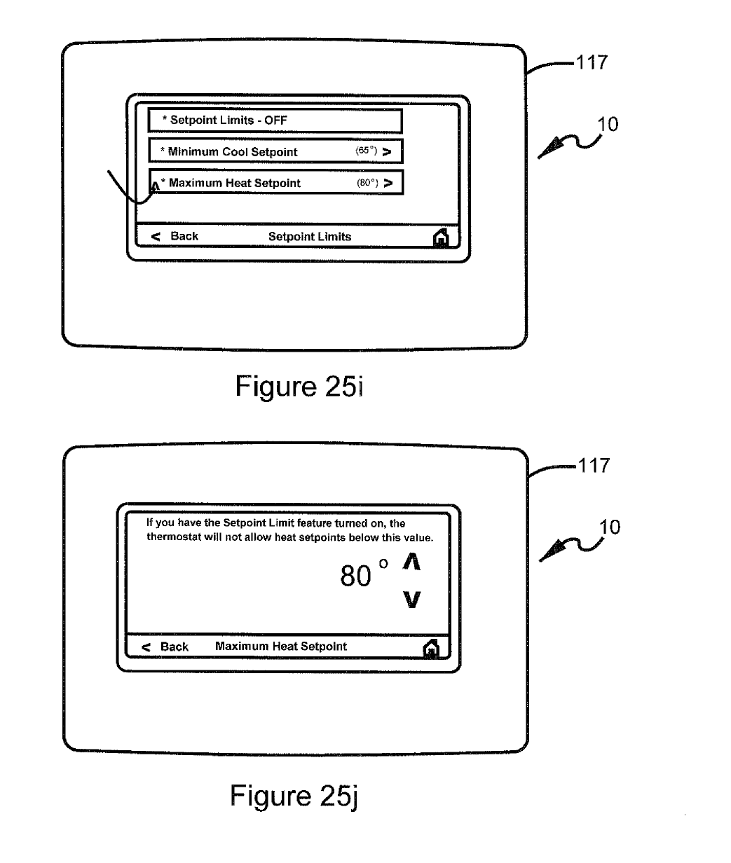

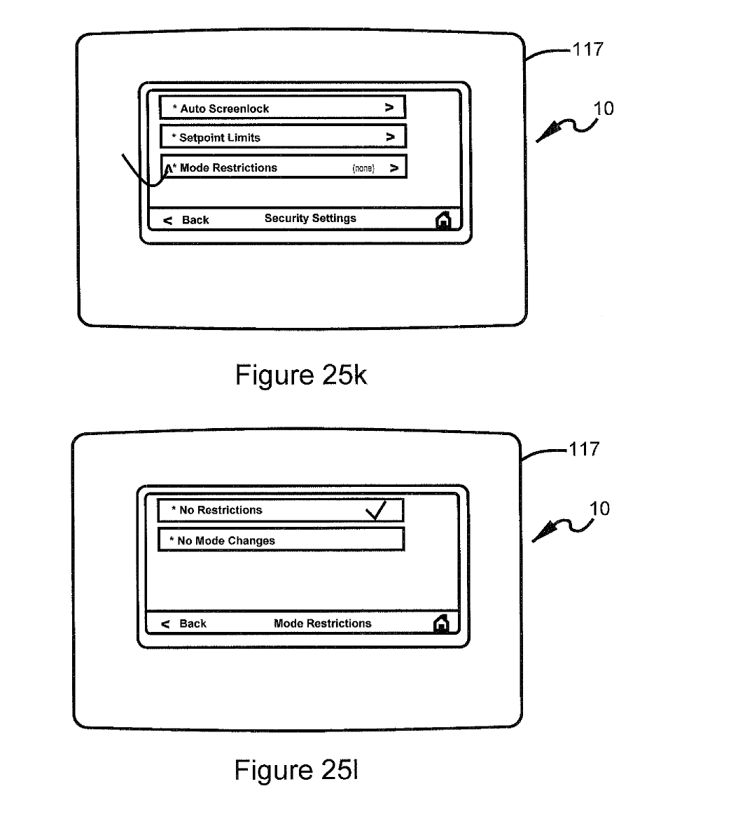

In a preferred embodiment, when the user is viewing the second menu page at step 334, virtual buttons displayed may include a security virtual button 426. A user, by touching security virtual button 426 at step 338, may be brought to a screen, FIG. 25a of options relating to various safety options and security features of the programmable environmental comfort controller 10 explained by the flowchart of FIG. 24. One such option may include a screenlock feature which would allow the user to set a period of time after which the screen would “lock.” Ideally, when the screen locks, the user may still view the information on the home screen such as the room temperature and the settings the programmable environmental comfort controller is programmed to reach; however, the user would not be able to leave this screen until the screen is unlocked. The user may also set a passcode or password by making the selection shown in FIG. 25b-25c, which would unlock the screen. The user may also choose an automatic screen lock as shown in FIGS. 25d and 25e which would allow a user to pick a certain period of time after which the thermostat screen would be locked. After a programmable environmental comfort controller is not interacted with for a period of time, the screenlock function would activate and the screen would be locked. A user may then touch the screen or an unlock button which would then prompt the user to enter the passcode, ideally displayed in the form of asterisks or other symbols to prevent others from knowing the passcode, to unlock the screen and allow the user to interact with the programmable environmental comfort controller once more. The screenlock function is ideal in situations where the user wishes to prevent children, guests, or others (such as in a community space within an office) from making changes to the programmable environmental comfort controller.

The user may also be presented with options to set a minimum cool setpoint and/or a maximum heat setpoint by making the selection in 25f-25j. By setting these points, a user would prevent the system from cooling below the chosen cool set point or heating above the heat set point as a safeguard. The user may also choose to activate a no mode changes option by making the selection in FIG. 25k which would not allow users to change the mode such as cool, heat, auto, or off or to enable users to do so by activating no restrictions shown in FIG. 251.

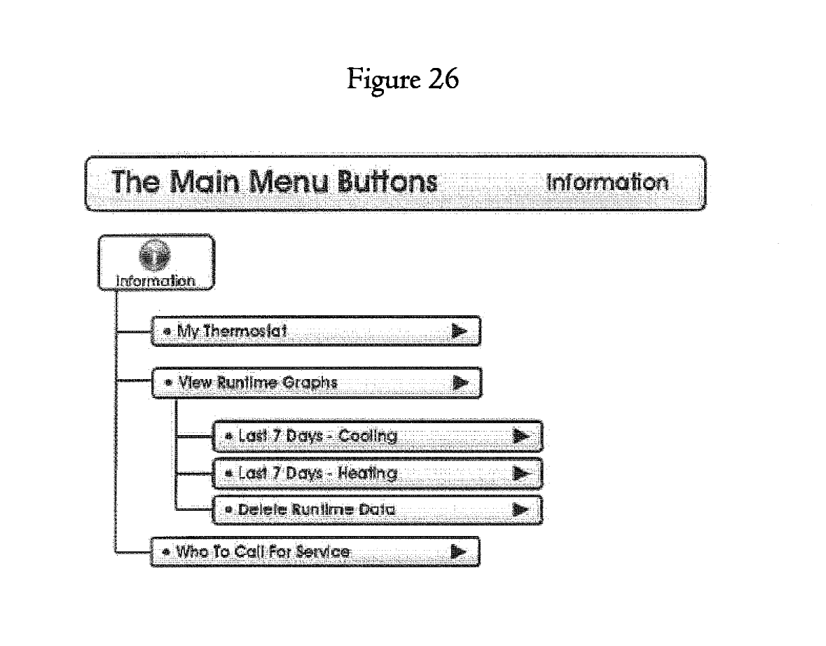

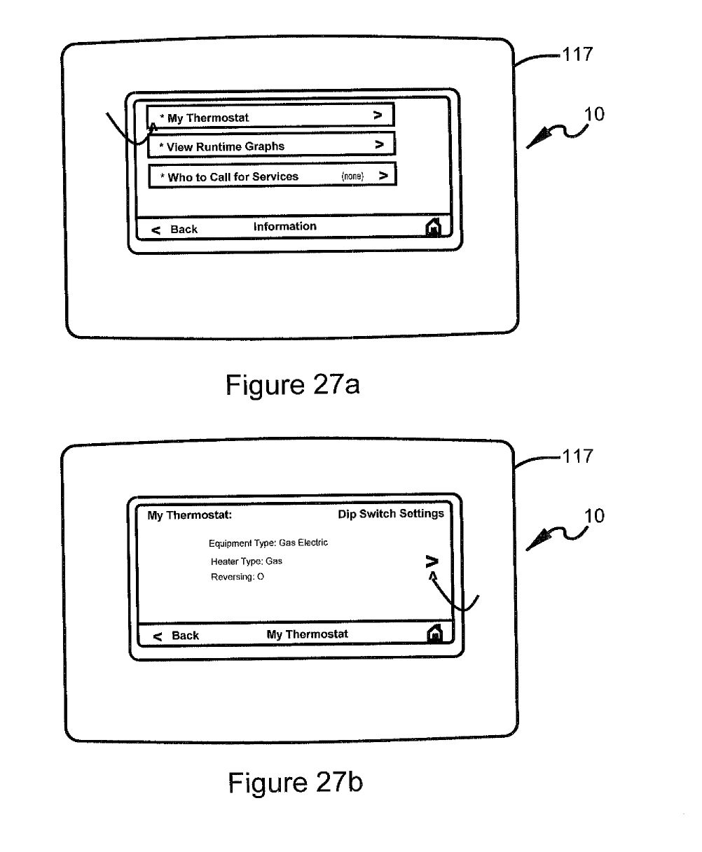

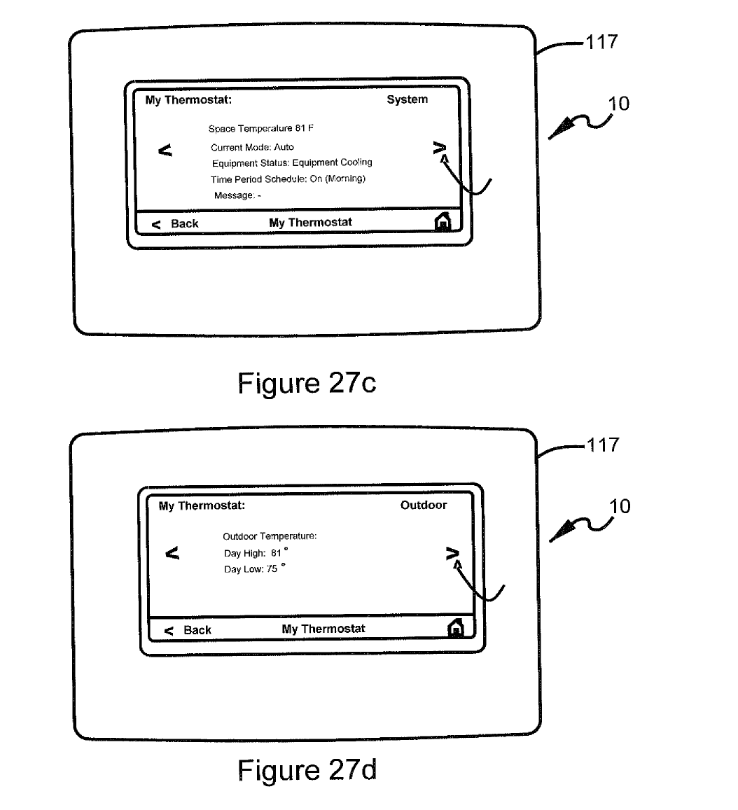

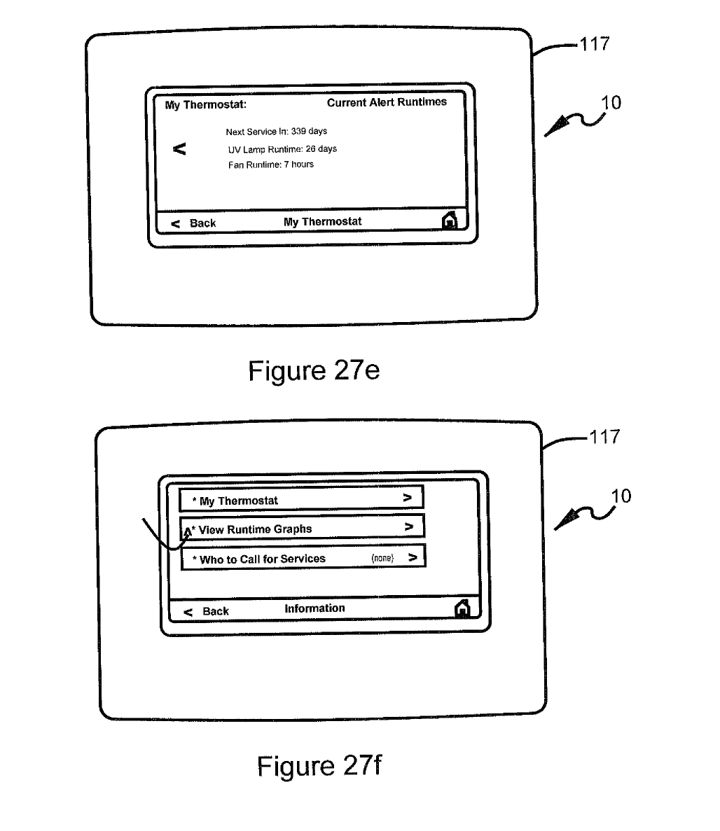

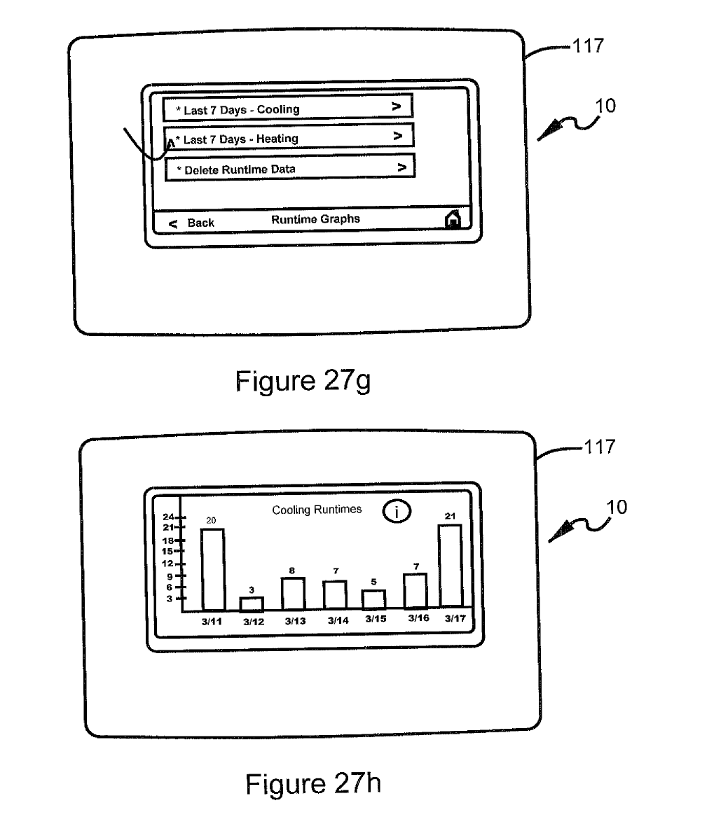

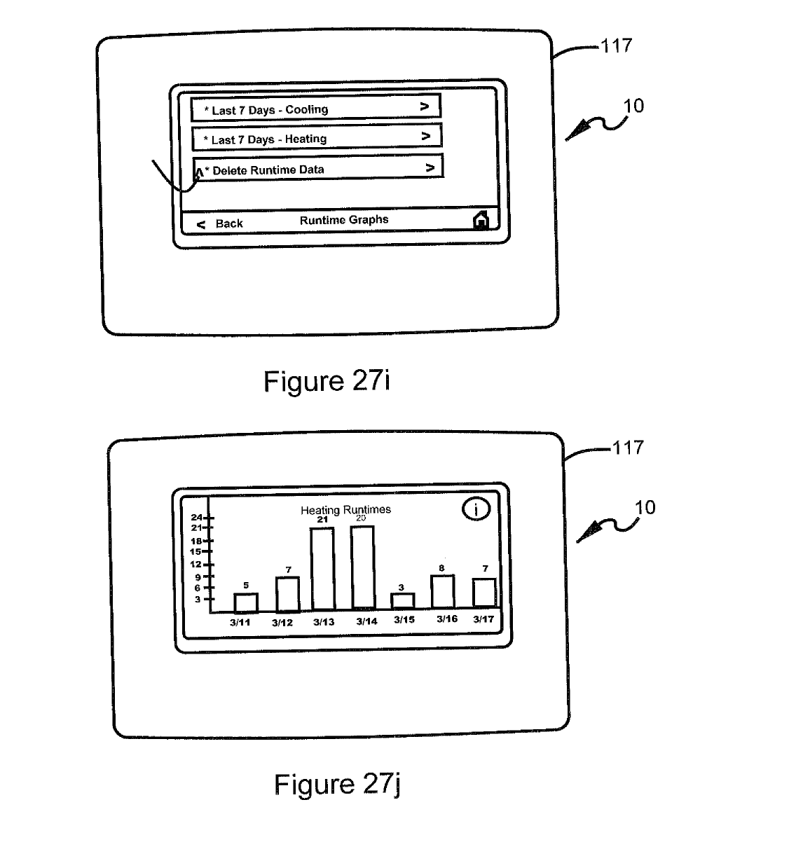

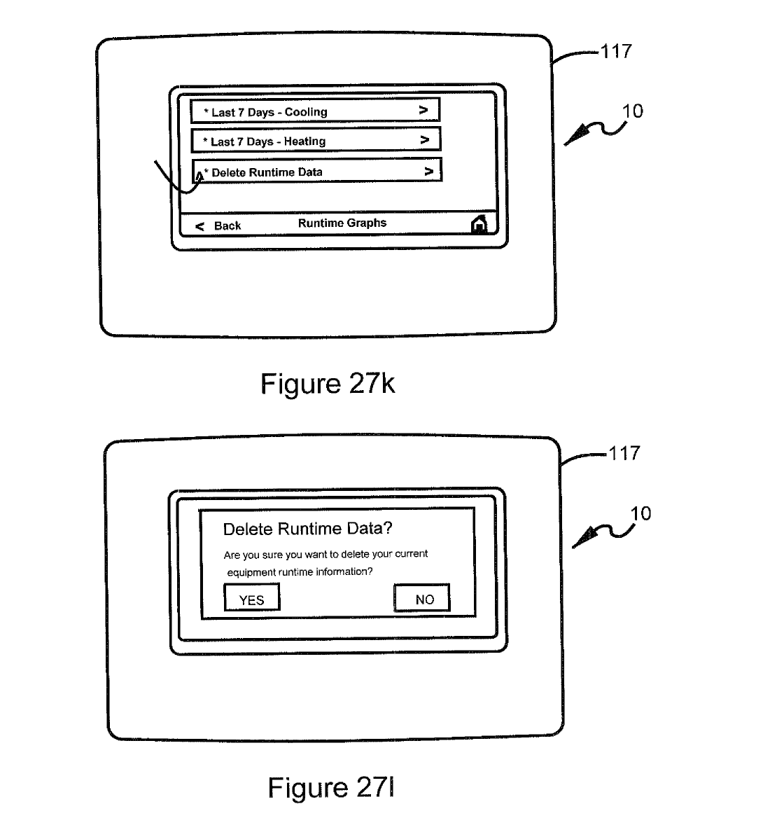

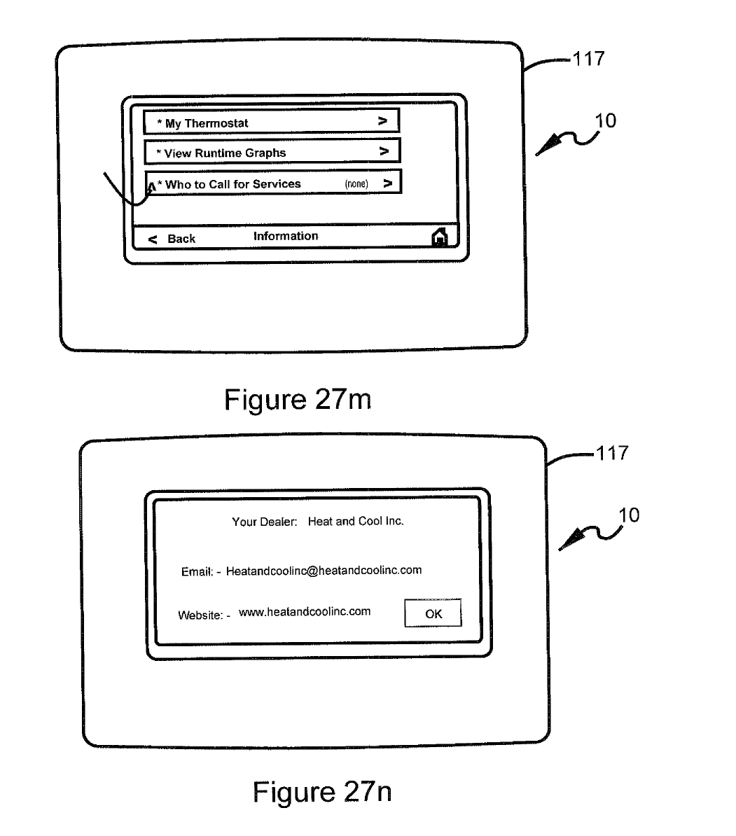

In a preferred embodiment, when the user is viewing the second menu page at step 334, virtual buttons displayed may include an information virtual button 428. A user, by touching information virtual button 428 at step 342 may be brought to a screen of options, FIG. 27a, relating to information about the programmable environmental comfort controller, the runtime of the HVAC system, and service contact information further explained by the flowchart of FIG. 26. By using the indicated arrows shown in FIGS. 27b-27e, the user, for instance, may choose to view information about their programmable environmental comfort controller and equipment such as the equipment type, the heater type, the reversing valve, the space temperature, the current mode, the equipment status, the time period schedule, messages, the outdoor temperature information, the next service period, the UV lamp runtime, and the fan runtime. As shown in FIG. 27f, the user may choose to view information relating to cooling system, FIGS. 27g and 27h, or heating system runtime, FIGS. 27i and 27j, which can be presented to the user in graphical format such as a bar graph with an x-axis and y-axis with the dates along the x-axis and the run time on the y-axis. The user may be able to view runtimes for 1st, 2nd, 3rd, and 4th stage heating and cooling systems if their system is equipped with such additional stages. The graph could allow the user to view data for a number of days, weeks, or months and to compare such data in side by side comparisons. Furthermore, the user may be able to note a large increase or decrease in the system runtime which may indicate a problem for which maintenance should be performed. The user may also be able to delete this data in FIGS. 27k and 27l. A user may decide upon operation of the environmental control equipment through turning it on or off or by changing control setpoints. The display may show that a user can cause the screen display to show energy usage by heating equipment (separated further for stages of heating), cooling equipment (separated further by stages of cooling), where excessive energy usage beyond a predetermined level is sometimes indicative of equipment failure. The invention is capable of controlling 4 heating and 2 cooling stages by selection of such equipment by user touch of the virtual buttons represented in the screen display.

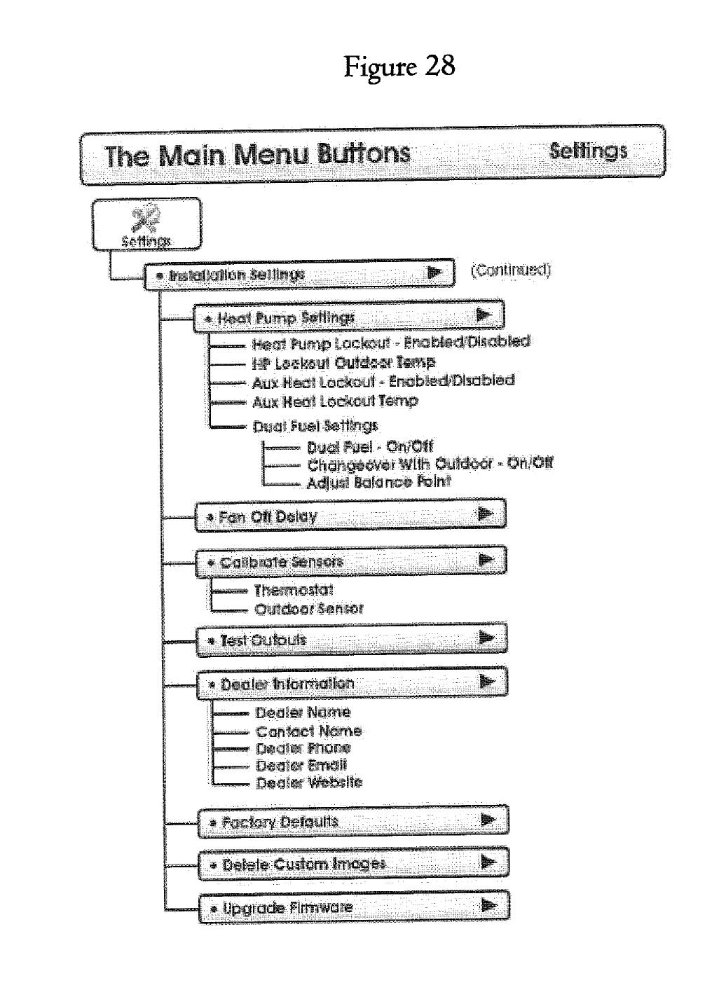

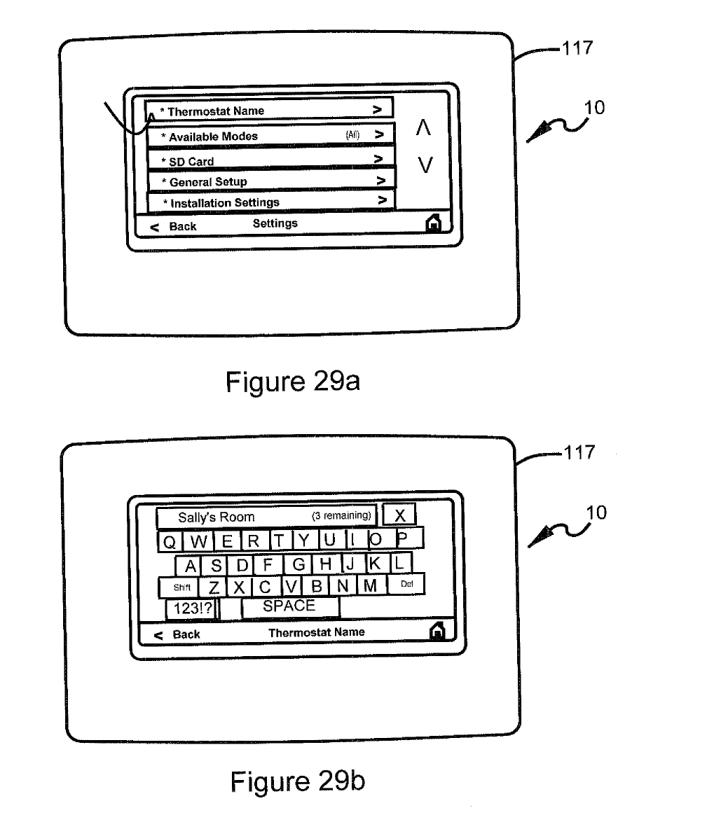

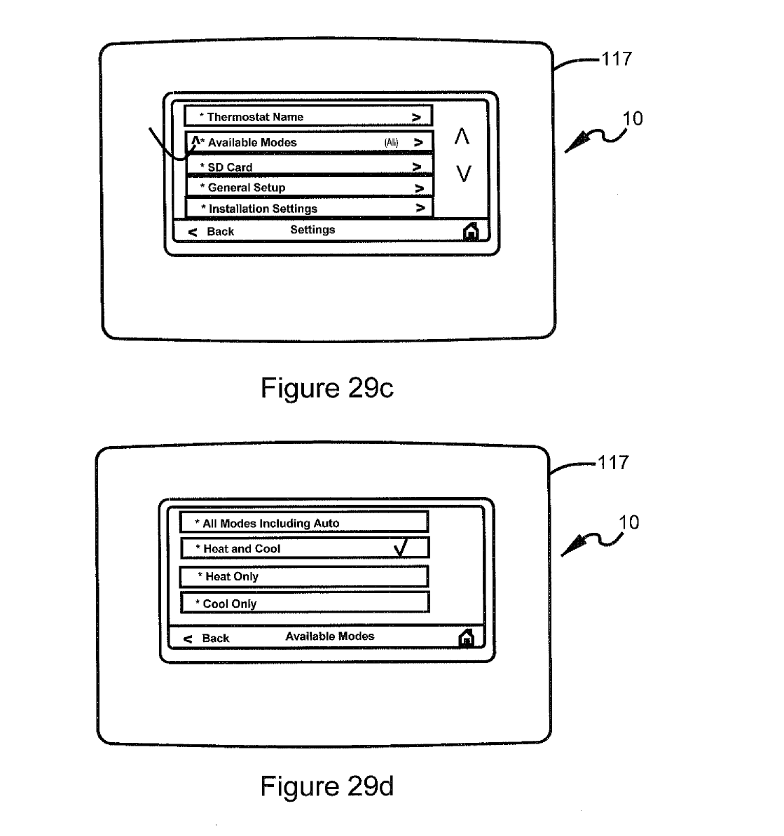

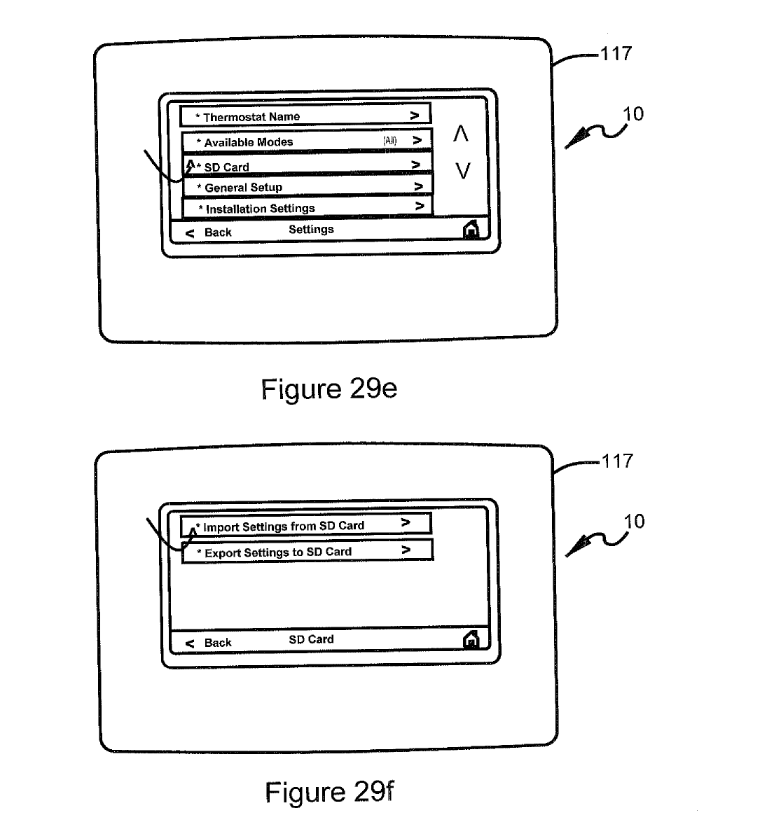

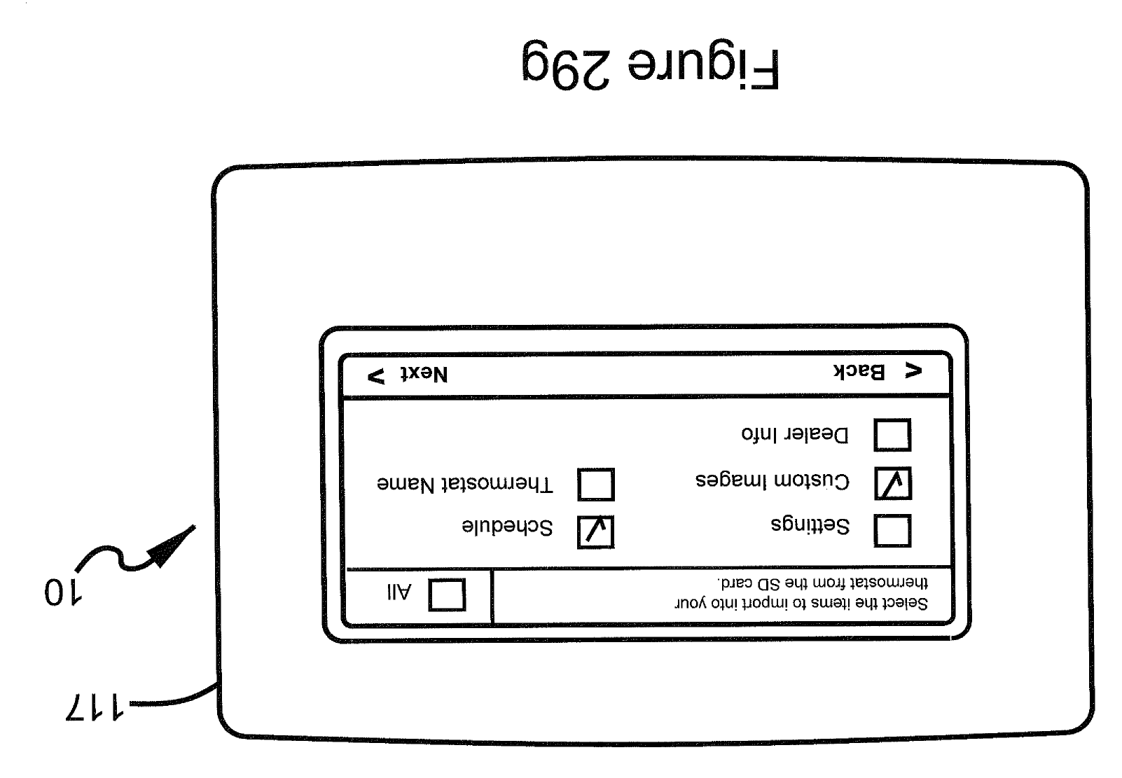

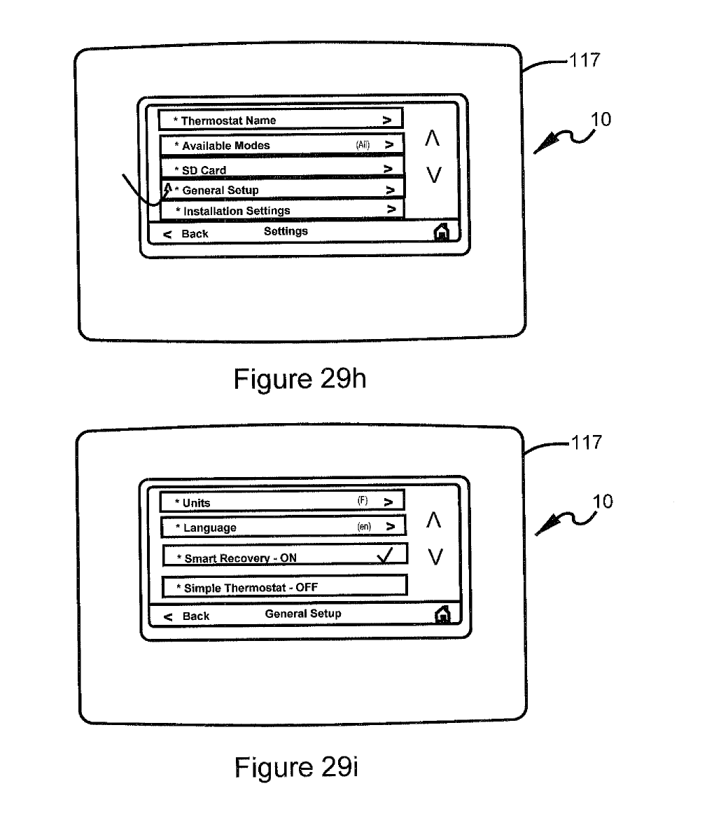

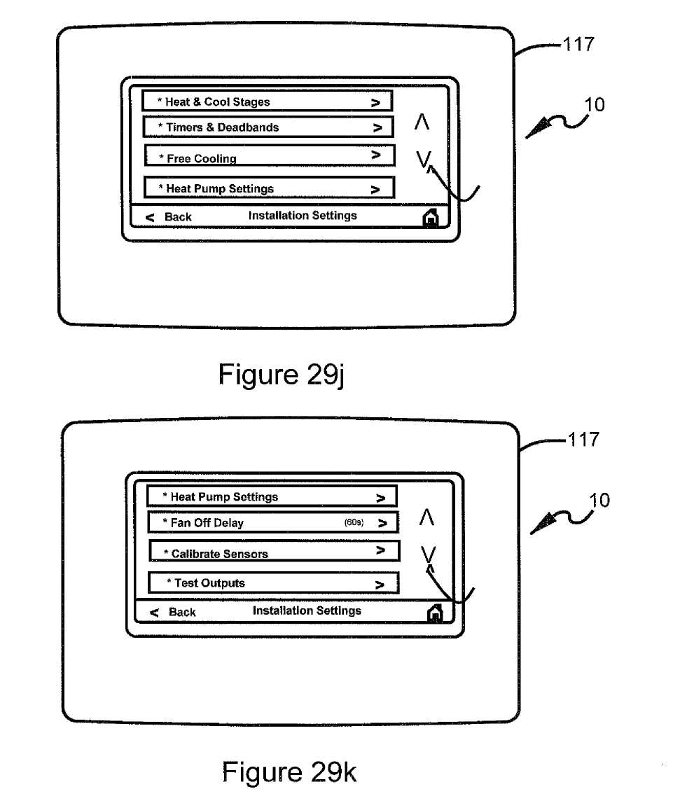

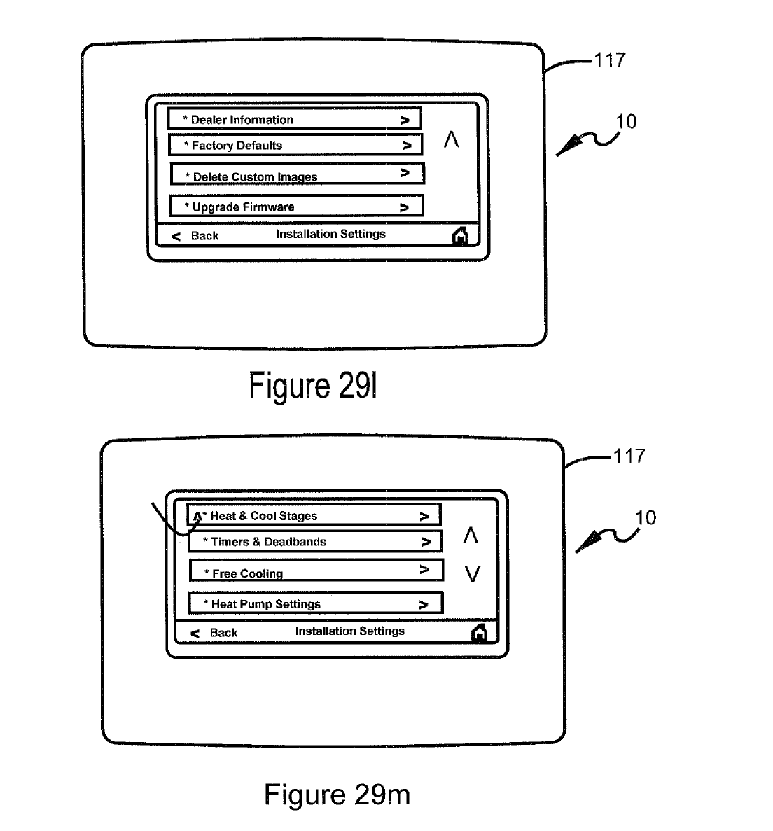

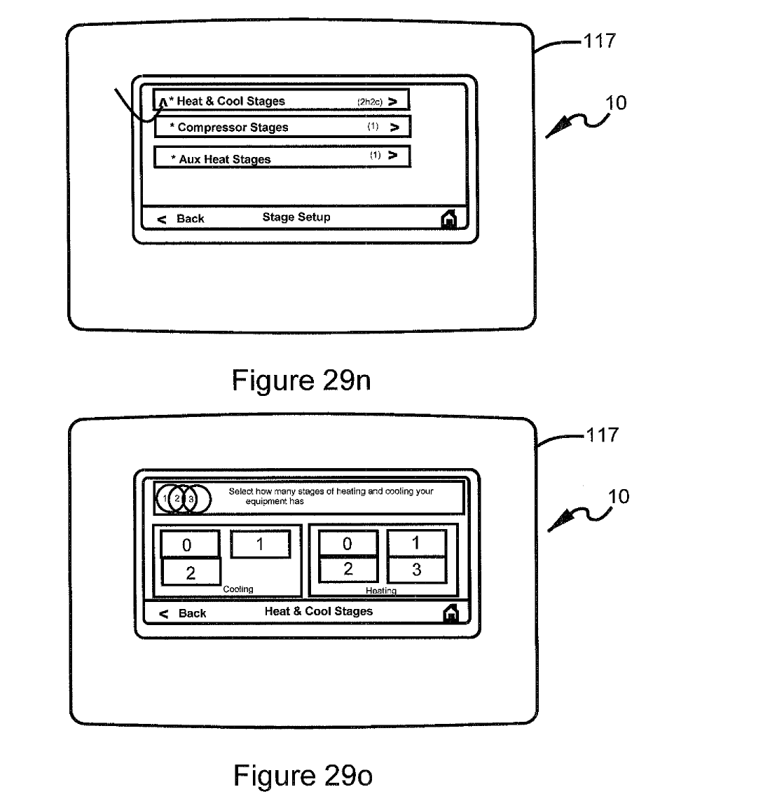

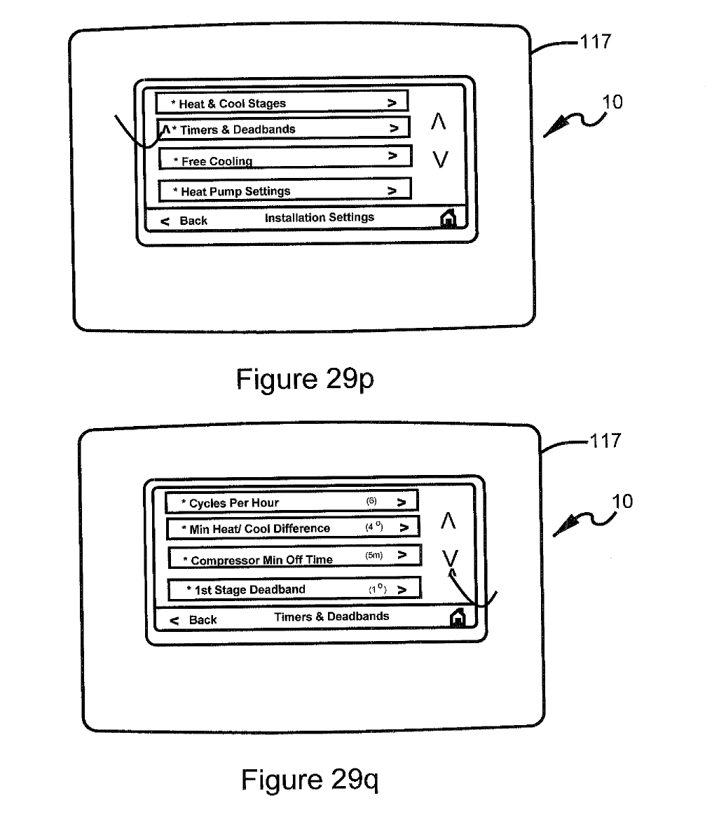

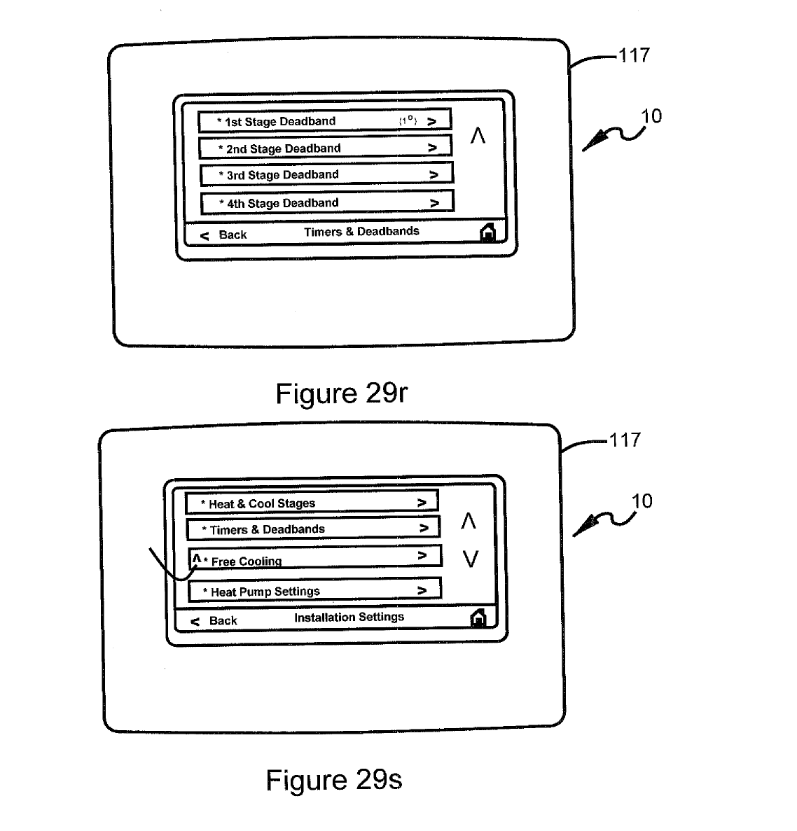

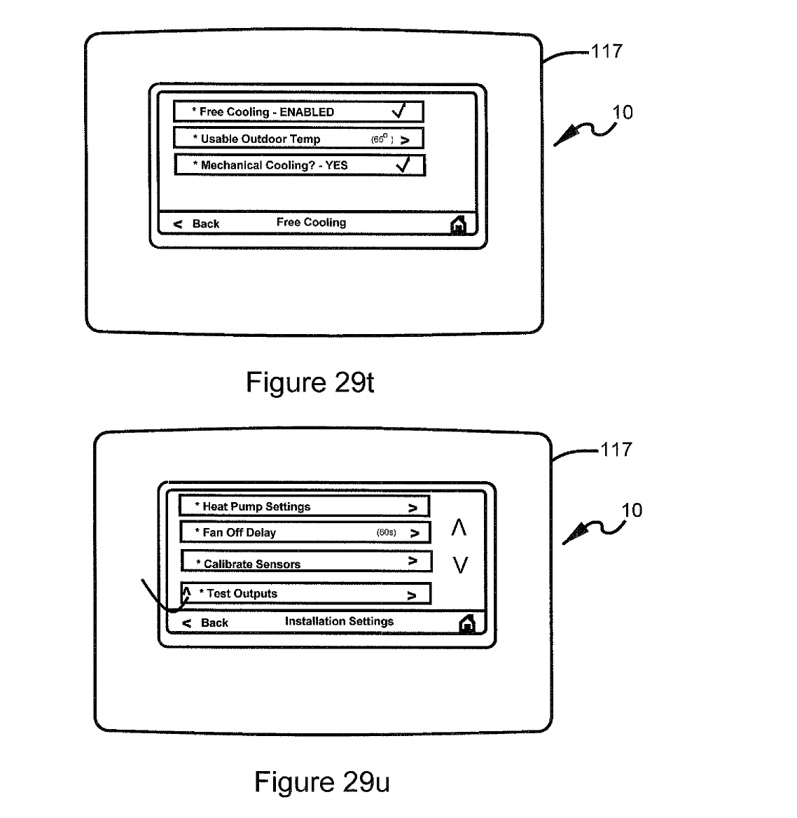

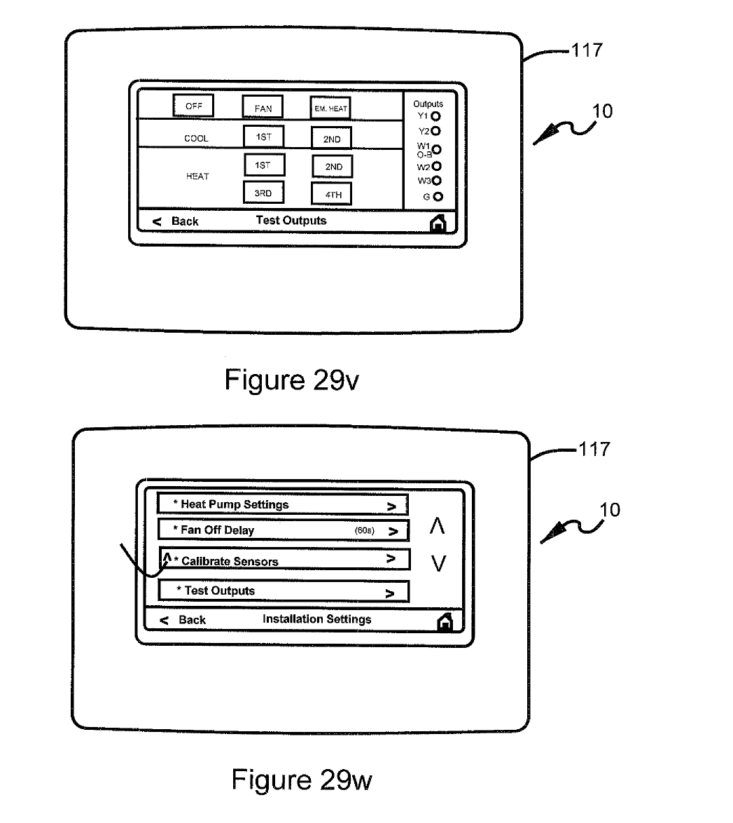

Additionally, the user and/or dealer and/or technician may be able to program, in FIG. 27m, service information such as the name, email, website, or other contract information of the dealer into a maintenance section in the information section shown in FIG. 27n. In a preferred embodiment, when the user is viewing the second menu page at step 334, virtual buttons displayed may include a settings virtual button 430. A user, by touching settings virtual button 430 at step 340 may be brought to a screen of options, FIG. 29a, relating to adjustable settings of the programmable environmental comfort controller such as programmable environmental comfort controller name, available modes, the SD card, the general setup, and/or installation settings also explained by the flowchart of FIG. 28. As shown in the selection made in FIG. 29a resulting in screen 29b, the user may, for instance, prefer to designate a name for the programmable environmental comfort controller to allow for tracking maintenance or for programming multiple programmable environmental comfort controllers at once. A user may also be able to choose which modes they would like available on the programmable environmental comfort controller such as heat only, cool only, heat and cool, and/or all modes including auto as shown in FIGS. 29c and 29d.

The user may also choose to import settings from an SD card or export settings to an SD card shown in FIGS. 29e-29g. A feature such as this would allow a user to develop a program for the programmable environmental comfort controller on a different source such as a computer and import the created program onto the programmable environmental comfort controller using compatible software such as that offered by Venstar for the ColorTouch™ Assistant as illustrated in FIG. 3. This would allow the user to create such a program on a preferred larger screen or a location away from the programmable environmental comfort controller 10. On the other hand, a user may choose to make changes to the programmable environmental comfort controller 10 by using the touch screen on the programmable environmental comfort controller 10 and save these settings to an SD card which can then be uploaded onto a device such as a computer using compatible software allowing a synchronization of updated information between the programmable environmental comfort controller 10 and the computer.

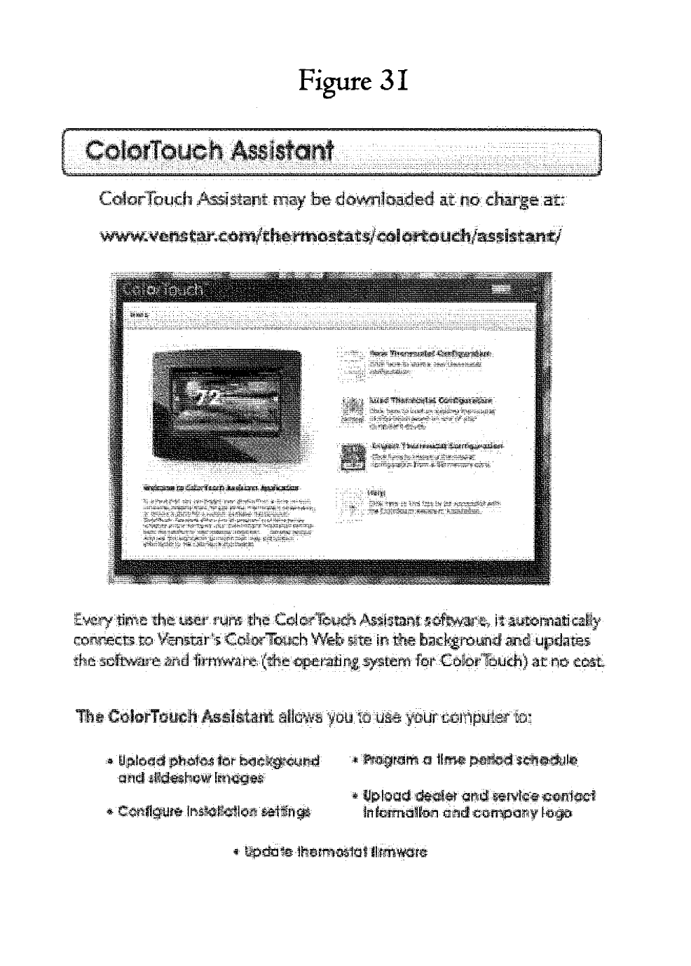

ColorTouch™ Assistant software as illustrated in FIG. 31 is capable of directly (by wired or wireless connection) or indirectly (by download to a memory card connectable with the invention programmable thermostat (via wired and wireless external communication means)) communicating with the invention programmable invention thermostat to accomplish certain objects of the invention, which include delivery of photos, graphic files, and schedule embodiment settings. With the inventive ColorTouch™ Assistant software, a user can import and edit photos from a drive on a local computer, prepare them for use as the programmable thermostat's screen saver, or choose a photo for a custom wallpaper background. the software allows a user to configure the schedule embodiments inputs described above for direct or indirect transfer, transmission and/or download to override any current settings for said schedule embodiment residing in or stored in the programmable environmental comfort controller. A contractor user can use the software to import their logo as a graphic and/or text file with contract information to the programmable environmental comfort controller. Each time software is opened upon the local personal computer, the software initiates a communications session with a remote website by Internet link to determine if application updates and/or the latest thermostat firmware have been downloaded to that local computer, where after the software directs such updates and/or firmware to be transferred directly or indirectly to the invention programmable environmental comfort controller. The updates and/or firmware, when transferred, overwrite previous versions and/or provide corrections as needed to the prior programmed settings.

By using the software, a user may more easily configure installation settings for the invention instead of using the touch screen interface of the programmable thermostat. The user may view the schedule embodiment screens described above for the programmable thermostat, where the same views and functions are available to the local user of the software for storing and delivery to the invention. A user may also view results of a communication with a remote website where storage of updates, enhancements, and new features for program correction, control algorithms, display screen changes, and the like developed by the manufacture of the invention occur. It will be appreciated from the above description that the functions of the invention may be duplicated upon a local personal computer, whereby interaction of a user with the software results in stored data, settings, and/or software programs which are transferable to the invention by direct or indirect transfer to improve or change its operation and/or ease of use.

Furthermore, the user may be able to adjust various programmable environmental comfort controller general settings by selecting general setup in FIG. 29h and displaying the screen in 29i. Some of these preferences could include the ability to adjust the language the programmable environmental comfort controller 10 is displayed in such as English, French, or Spanish. The user may also choose to display the units the temperature is measured in to units such as Fahrenheit or Celsius. If the user preferred such as the language the programmable environmental comfort controller 10 is displayed or the units the temperature is measured in such as Fahrenheit or Celsius. The user may also choose to either turn on or off a smart recovery option for the thermostat. Furthermore, the user may also choose to activate a simple programmable environmental comfort controller 10 mode by selecting the option displayed in 29i resulting in the embodiment shown in 3c which displays fewer options typically allowing a user to view limited information such as the temperature and heating and cooling options. This option may be preferred for ease of use as well as for users who may wish to eliminate complex option choices. A smart recovery option may be provided which, if programmed “ON,” allows the programmable environmental comfort controller 10 to automatically recover if an error or malfunction occurs.

A user may be presented with various options relating to the HVAC systems and setpoints in 29j-l which can be viewed using the arrows off to the side of the options presented. For example, in FIGS. 29m-29o, a user may choose the number of heating and cooling stages their equipment has, the number of compressor stages, and/or the number of auxiliary heat stages. The user may also be able to specify the maximum number of cycles per hour the equipment will be allowed to run or to allow the equipment to run without any maximum limit in FIGS. 29p and 29q. The user may also choose to set the minimum gap between the heat and cool set points in auto mode. By choosing to set a minimum temperature gap such as five degrees, the user can ensure that the system will not fluctuate between heating and cooling systems more than is necessary by, yet will maintain a comfortable temperature range for the user activating each system as is necessary. Furthermore, this allows the user to program an interval, which, when the user raises or lowers the temperature on the programmable environmental comfort controller 10 to their preferred setting, automatically raises or lowers the other temperature. For example, if an interval was set for five degrees and the programmable environmental comfort controller 10 was programmed to “cool to” 75 degrees and “heat to” 70 degrees, if the user raised the “cool to” setting to 78 degrees, the “heat to” setting would automatically change to 73 degrees.

The user may also be presented with an option to choose a minimum number of minutes the compressor should stay off before turning back on again by making the selection shown in FIG. 29q. Additionally, a user may be able to select how many degrees a temperature can register past a setpoint before the equipment turns on for each deadband within the system, FIG. 29r. Settings controlling cooling settings such as free cooling, mechanical cooling, or cooling by enabling free cooling if an outdoor temperature is below a specific value may be provided by making the selection in FIGS. 29s and 29t. Similar settings may be presented for the heat pump. A user may also be able to choose to activate a fan delay which would enable to the user to select a period of time for which the fan will run after the cooling turns off.

Various embodiments of programmable environmental comfort controller 10 may include a cycle limits embodiment. In a cycle limits embodiment, an option of the programmable environmental comfort controller 10 is a limit on cycle times per period of time to reduce undue wear on environmental control equipment. In another embodiment, a free cooling embodiment, environmental control equipment includes a duct to external air which is open or closeable by duct damper and connected with the ventilation intake to draw in cool outdoor air to a cooling system for conditioned space. The intake of cooler outdoor air is controlled by the programmable thermostat as a second stage of cooling.

Further settings may be provided such as calibrating the programmable environmental comfort controller 10 and the outdoor sensor which may prompt the user to specify a degree offset to calibrate the indoor temperature readings on the programmable environmental comfort controller 10 based on the outdoor sensor. The user may also choose to specify a degree offset to calibrate their outdoor temperature readings on the programmable environmental comfort controller by. The user may also choose to test the outputs, shown in FIGS. 29u and 29v, based on the heating and cooling systems, fans, stages, and outputs to ensure their programmable environmental comfort controller 10 is running to their preferences and registering the correct information. A user and/or dealer and/or technician may also be able to view and/or edit the settings related to servicing contact information such as a dealer name, contact name, dealer phone, dealer email, and/or the dealer website for quick reference when needed.

The user may be presented with an option to restore all factory defaults which would delete all previously programmed settings of the user(s) and/or an option to delete all custom images the user has imported into the programmable environmental comfort controller 10. Additionally, a user may also choose to upgrade the firmware using an SD.

In a preferred embodiment, if the user is viewing the second menu page at step 334, the user may touch the “up arrow” at step 330 to view the first menu page at step 320. If additional menu pages are included, the user should be able to move between the various menu pages by using such virtual buttons as arrow or “up” and “down” virtual buttons. Furthermore, at any time a sub-screen is displayed to a user, the sub-screen may contain a “back” feature allowing the user to return the previous page they had last been presented with. Likewise sub-screens may contain a “next” feature which would allow the user to proceed to the next sub-screen and/or a virtual button indicating the user is “finished” or “done.” Ideally, as the user moves from one sub-screen to the next, the user's preferences as indicated by various prompts and options displayed to the user, should be saved automatically by the user proceeding to the next subpage, returning to the home screen, or returning to a previously viewed subpage. If a large amount of changes are made or changes that affect the major portions of the programmable environmental comfort controller 10, the user may be prompted with a sub-screen with virtual buttons confirming the user's desire to save the changes otherwise not saving said changes.

The user may also be presented with the opportunity to return to the home screen either by touching a “back” virtual button such as that from the first menu page at step 312 or that from the second menu page at step 344 or by clicking a virtual button representing “home” which may include an icon of a house. Ideally either by touching a portion of the touch screen not currently active or by allowing a set amount of time to pass, such as 15 seconds, the user would be returned to the home screen automatically.

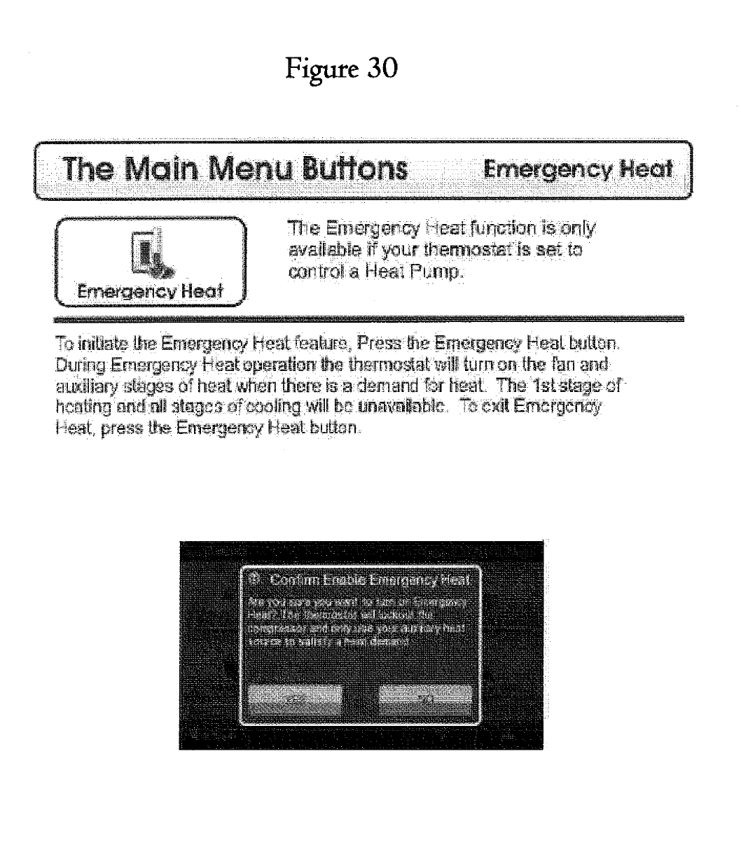

As illustrated in FIG. 30, in situations where a user has a programmable environmental controller 10 which controls programmable environmental comfort control system 1 and programmable environmental comfort control system 1 includes a heat pump, emergency heat pump options may be offered to the user. The emergency heat pump options, which would allow the user to quickly supply a demand for heat, may be presented to the user in the form of a virtual button in menu 132 for ease of access by the user.

In accordance with the present invention, it is contemplated that the touchscreen input to the system may be located on a separate device, such as a remote control or a smartphone. More particularly, some or all of the above described programming functions may be included in an application, such as an Android, Apple IOS or other application. In accordance with the invention, this application runs on a smartphone, whose touchscreen may be used as an input device. In such an embodiment, the smartphone may communicate through the Internet with a website dedicated to remote thermostat control. Such website, in turn, communicates through the Internet to, for example, a wireless network router, located in the facility whose environment is being controlled, to the thermostat of the user. Accordingly, instead of inputting commands through a touchscreen located on the thermostat device, the user uses the touchscreen on the smartphone to input programming and control information.

In a particularly preferred embodiment, a smartphone is used as an input device communicating with a user's thermostat of simplified and relatively inexpensive design through the Internet. Such simplified and relatively inexpensive design is achieved by using a segmented display instead of a dot matrix touchscreen. In accordance with the invention, the segmented display may be a touchscreen or a simple display. The segmented display may also incorporate pictographic elements, such as a fan blade indicator (which may or may not be animated), segmented numerical or alphanumerical displays (such as seven, fourteen or sixteen element segmented displays), words (such as “sleep” or “weekend”), and control elements such as up and down arrows for adjusting temperature and time for setpoints, bar graph displays for adjusting setpoints, and so forth). Because of the lower cost of such displays as compared to dotmatrix touchscreens, such a relatively inexpensive design results in substantial savings in manufacturing cost. Accordingly, most or all graphic user interface functionality may be provided through the touchscreen interface, an item already owned by many consumers, allowing the advantages of a full functioning touchscreen device without the attendant touchscreen costs.

In accordance with the invention, all functionality may be resident on the server of the website providing control functions to the relatively inexpensive thermostat. However, in accordance with a preferred embodiment of the invention, functionality, programmed setpoints (or at least default setpoints) are resident in the thermostat, so that the thermostat may operate satisfactorily without the intervention of the website server, in the event of a failure of Internet communications.

In accordance with the invention, all programming may be performed through the touchscreen interface of a smart phone, but in accordance with a preferred embodiment of the invention, at least basic programming controls may be provided on the thermostat, allowing local hands-on setpoint adjustment, even in the event of an Internet communications failure.

Finally, in accordance with a most preferred embodiment of the invention, switching of the HVAC equipment is done using solid-state devices, and not relays. Accordingly, no relays are required, and it is not necessary to provide batteries to power the relays.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. An HVAC controller system, comprising:
(a) a controller providing control signals to one or more HVAC components, said controller operating in accordance with an algorithm;
(b) a memory storing one or more set point, each of said set points associated with a time and a temperature; and
(c) a touch screen dot matrix interface device for displaying information received from said controller and presenting virtual buttons, said virtual buttons being responsive to touch inputs to generate programming inputs, said programming inputs being coupled to the controller, the controller being configured to cause said dot matrix interface device to display a first screen with a first plurality of virtual buttons and a first plurality of information items, the controller being further configured, in response to a touch input from one of said virtual buttons to present:
(i) a second screen with a second plurality of virtual buttons and a second plurality of information items, and/or
(ii) to adjust one or more of said set points; and an interface circuit board controlling the operation of said HVAC components in accordance with said set points.

2. An HVAC controller system as in claim 1, wherein longevity of the screen is improved by i) dimming the display brightness after a period of time after the controller system has been programmed, adjusted or otherwise been actuated, adjusted or otherwise interacted with by the user, and/or ii) shutting off the display after a period of time, such as sixty seconds after the controller system has been programmed, adjusted or otherwise been actuated or adjusted by the user.

3. An HVAC controller system as in claim 1, wherein information about current conditions and operations is displayed at the left of the display and information and virtual buttons for changing setpoints and other controller features is positioned at the right of the display.

4. An HVAC controller system as in claim 1, wherein the right side of the display is divided, with setpoint(s) displayed at a leftmost area of the right side and virtual button(s) for changing setpoints(s) in a rightmost area of the right side.

5. An HVAC controller system as in claim 1, further comprising a card slot, said card slot being coupled to said controller to receive program update information from a card located in said card slot.

4. An HVAC controller system as in claim 1, wherein the controller is connected to a router and programmed to display text messages, pictures or text in response to an input from a smartphone.

5. An HVAC controller system as in claim 1, wherein a screensaver mode is entered into in accordance with an algorithm responsive to the cessation of user input.

6. An HVAC controller system as in claim 5, wherein the controller is configured as a thermostat, said thermostat being of relatively thin configuration.

7. An HVAC controller system as in claim 1, wherein said thermostat has a length and a thickness less than 20% of the sum of its length and width.

8. An HVAC controller system as in claim 1, wherein available thermostat informational and control display elements may be removed in response to user input.

9. An HVAC controller system as in claim 1, wherein the algorithm enables the controller to operate under parameters only within limits set by the owner, thus preventing the air conditioning system from running at too low a temperature and the heating system from running at too high a temperature.

10. An HVAC controller system as in claim 1, wherein said algorithm incorporates picture editing software.

11. An HVAC controller system as in claim 1, wherein the touch screen dot matrix interface device is separate from a thermostat housing controller.

12. An HVAC controller system as in claim 11, wherein the touch screen dot matrix interface device is a smart phone coupled to the controller via a network.

13. An HVAC controller system as in claim 12, wherein sat points are stored in a memory hardwired to said controller, whereby setpoints are locally available and not dependent upon network functionality for operation of said HVAC controller system.

14. An HVAC controller system as in claim 13, wherein a second interface device located on said housing allows programming of setpoints and displays of information.

15. An HVAC controller system as in claim 14, wherein said second interface is not a dot matrix display.

16. An HVAC controller system as in claim 14, wherein said second interface comprises a segmented display and touch actuatable elements for programming said thermostat.
